(19) United States
(12) Patent Application Publication
(10) Pub. No.: US 2004/0067853 A1
(43) Pub. Date: Apr. 8, 2004

(54) Sulfonamide derivative-containing agricultural and horticultural composition

(76) Inventors: Masaharu Nakayama, Ibaraki-shi (JP); Muneki Yamada, Ookawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/466,245

(22) PCT Filed: Jan. 15, 2002
(86) PCT No.: PCT/JP02/00168

(30) Foreign Application Priority Data
Jan. 16, 2001 (JP) 2001-007864

(51) Int. Cl. A01N 25/26; A01N 25/04; A01N 25/16

(52) U.S. Cl. 504/364

(57) ABSTRACT

There is provided an agricultural and horticultural composition for applying a compound represented by the formula (I):

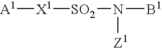

wherein A¹ is aryl group or heterocyclic group, X¹ is a chemical bond, methylene or vinylene, B¹ is 5-membered heterocyclic group, etc., and Z¹ is hydrocarbon group, acyl group, formyl, amino, —N═CR¹R² wherein R¹ and R² each is hydrogen atom or hydrocarbon group, —OR³ wherein R³ is hydrogen atom, hydrocarbon group, etc., —S(O)ₙR⁴ wherein n is an integer of 0 to 2, and R⁴ is hydrogen atom or hydrocarbon group, or a salt thereof; in combination with a different agricultural chemical active ingredient. The composition comprising the sulfonamide derivative which produces only a small effect on humans and animals, natural enemies and environment so as to be safe, and has superior control effect even on microorganisms having drug resistance. A method for reinforcing the microbiocidal or insecticide activity of the sulfonamide derivative or the different agricultural chemical active ingredient is also provided.

### FIELD OF THE INVENTION

The present invention relates to an agricultural and horticultural composition, wherein a sulfonamide derivative or a salt thereof that is useful as a microbiocidal agent for agriculture and horticulture is applied in combination with a different agricultural chemical active ingredient. The present invention also relates to a method for reinforcing microbiocidal effect or insecticidal effect of the sulfonamide derivative or the different agricultural chemical active ingredient.

### DESCRIPTION OF THE RELATED ART

Hitherto, a large number of compounds having microbiocidal activity have been synthesized, and used as microbiocidal agents for agriculture and horticulture to contribute to stable supply of farm products. It is however well known that restricted compounds are used and thus microorganisms having drug resistance break out, resulting in problems. Since safety of chemical substances and smaller effect thereof on environment are increasingly demanded, it is desired to develop safer microbiocidal agents for agriculture and horticulture. Thus, compounds having new microbiocidal activity have been searched and investigated. About sulfonamide derivatives, attention is paid to their biological or chemical properties, and many compounds thereof have been synthesized up to now. However, almost all thereof are compounds or reagents synthesized for synthesis intermediates, medical supplies, and investigation of chemical reactions.

Sulfonamide derivatives related to microbiocidal agents are reported in JP-A-61-286366, JP-A-62-190104, JPA-63-239264, JP-A-63-238006, JP-A-63-307851, JP-A-1-156952, J. Med. Chem. 1983, 26, 1741, DE19725447, U.S. Pat. No. 4,906,650 and so on.

However, safe sulfonamide derivatives which produces only a small effect on humans and animals, natural enemies and environment, and has a superior control effect even on organisms having drug resistance have not yet been developed.

In light of such situations, the present inventors have been intensively researched for a long time to find out microbiocidal agents for agriculture and horticulture which have superior microbiocidal activity. As a result, the present inventors already found out that surprisingly, compounds represented by the formula (I⁰):

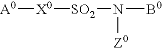

wherein A⁰ represents (1) an aryl group which may be substituted or (2) a heterocyclic group which may be substituted, X⁰ represents (1) a chemical bond, (2) a methylene group which may be substituted, (3) a vinylene group which may be substituted, B⁰ represents a heterocyclic group which may be substituted, or an aryl group which may be substituted, and Z⁰ represents (1) a hydrocarbon which may be substituted, (2) an acyl group which may be substituted, (3) a formyl group, (4) an amino group which may be substituted, (5) —N═CR¹R² wherein R¹ and R² each independently represents a hydrogen atom, or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group, or an alkylsulfonyl group which may be substituted, or (8) a group represented by —S(O)ₙR⁴ wherein n is an integer of 0 to 2, and R⁴ represents a hydrogen atom, or a hydrocarbon group which may be substituted (hereinafter, sometimes, referred to as compounds (I⁰)) or salts thereof, particularly compounds (I) to (V) described hereinafter or salts thereof, have a very intense microbiocidal action and a low toxicity against humans and animals, fishes, and natural enemies, and filed a Japanese patent application (JP 2001-26506A).

### OBJECTS OF THE INVENTION

An object of the present invention is to provide an agricultural and horticultural composition comprising a sulfonamide derivative which produces only a small effect on humans and animals, natural enemies and environment so as to be safe, and has a superior control effect even on microorganisms having drug resistance; and a method for reinforcing the superior microbiocidal activity of the sulfonamide derivative still more.

This object as well as other objects and advantages of the present invention will be apparent to those skilled in the art from the following description.

### SUMMARY OF THE INVENTION

As described above, it was found out that surprisingly, compounds represented by the formula (I⁰) or salts thereof, particularly compounds (I) to (VI) described hereinafter or salts thereof, have a very intense microbiocidal action and a low toxicity against humans and animals, fishes, and natural enemies. On the basis of this finding, the present inventors repeatedly made further intensive investigations. As a result, it has been found out that by combining any one of these compounds with a different agricultural chemical active ingredient, the microbiocidal effect of any one of the compounds represented by the formula (I⁰) or a salt thereof is reinforced. Thus, the present invention has been completed.

That is, the present invention provides:

[1] an agricultural and horticultural composition which is used for applying compound represented by the formula (I):

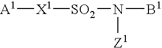

wherein A¹ represents (1) an aryl group which may be substituted or (2) a heterocyclic group which may be substituted,

X¹ represents (1) a chemical bond, (2) a methylene group which may be substituted, or (3) a vinylene group which may be substituted,

B¹ represents a 5-membered heterocyclic group other than isoxazolyl group which may be substituted, or a condensed heterocyclic group which may be substituted, and

Z¹ represents (1) a hydrocarbon group which may be substituted, (2) an acyl group which may be substituted, (3) a formyl group, (4) an amino group which may be substituted, (5) a group represented by —N═CR¹R² wherein each of R¹ and R² independently represents a hydrogen atom or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group, or an alkylsulfonyl group which may be substituted, or (8) a group represented by —S(O)ₙR⁴ wherein n is an integer of 0 to 2, and R⁴ represents a hydrogen atom or a hydrocarbon group which may be substituted, or a salt thereof in combination with a different agricultural chemical active ingredient;

[2] the agricultural and horticultural composition according to the above [1] which comprises the compound represented by the formula (I) or the salt thereof, and the different agricultural chemical active ingredient;

[3] the agricultural and horticultural composition according to the above [1] which is a combination of a composition comprising the compound represented by the formula (I) or the salt thereof, and a composition comprising the different agricultural chemical active ingredient;

[4] the agricultural and horticultural composition according to any one of the above [1] to [3], wherein B¹ is a 5-membered heterocyclic group, which may be substituted, whose ring-constituting atom other than carbon atoms is selected from nitrogen and sulfur atoms, or a condensed heterocyclic group which may be substituted;

[5] the agricultural and horticultural composition according to any one of the above [1] to [3], wherein A¹ represents (1) a C₆₋₁₄ aryl group which may be substituted with 1-5 substituents selected from the substituent group (T) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkyl-carbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxy-carbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula:

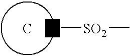

wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthio-thiocarbonyl group, (xxviii) a carbamoyl group, (xxix) a mono- or di-C₁₋₄ alkylcarbamoyl group, (xxx) a group represented by the formula:

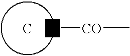

wherein the ring C represents a 3- to 6-membered nitrogen-containing heterocyclic group, (xxxi) a thiocarbamoyl group, (xxxii) mono- or di-C₁₋₄ alkyl-thiocarbamoyl group, (xxxiii) a group represented by the formula:

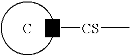

wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group, and (xlv) a sulfo group, or (2) a heterocyclic group which may be substituted with 1-5 substituents selected from the above-mentioned substituent group (T),

X¹ represents (1) a chemical bond, (2) a methylene group which may be substituted with 1 or 2 substituents selected from C₁₋₄ alkyl, C₁₋₄ alkoxy, C₁₋₄ alkylthio, halogen and cyano, or (3) a vinylene group which may be substituted with 1 or 2 substituents selected from C₁₋₄ alkyl, C₁₋₄ alkoxy, C₁₋₄ alkylthio, halogen and cyano,

B¹ represents (1) a 5-memebred heterocyclic group, which may be substituted with 1-5 substituents selected from the above-mentioned substituent group (T), whose ring constituting atom other than carbon atoms is a heteroatom selected from nitrogen and sulfur atoms, or (2) a condensed heterocyclic group which may be substituted with 1-5 substituents selected from the above-mentioned substituent group (T) and is composed of a 5- or 6-membered heterocyclic ring and a benzene ring, or a 5- or 6-membered heterocyclic ring and a 5- or 6-membered heterocyclic ring, and

Z¹ represents (1) a hydrocarbon group selected from (i) a C₁₋₆ alkyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (ii) a C₂₋₆ alkenyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (iii) a C₂₋₆ alkynyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (iv) a C₃₋₆ cycloalkyl group which may be substituted with 1-5 substituents selected from (a) C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkylsulfonyl, (k) cyano, (l) C₁₋₄ alkoxy-carbonyl, (m) carbamoyl and (n) mono- or di-C₁₋₄ alkyl-carbamoyl, (v) a C₃₋₆ alkadienyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (vi) a C₆₋₁₄ aryl group which may be substituted with 1-5 substituents selected from (a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkylsulfonyl, (k) cyano, (l) C₁₋₄ alkoxy-carbonyl, (m) carbamoyl and (n) mono- or di-C₁₋₄ alkyl-carbamoyl, (2) an acyl group selected from (i) C₁₋₄ alkyl-carbonyl, (ii) C₁₋₄ alkoxy-carbonyl, (iii) C₁₋₄ alkylthio-carbonyl, (iv) C₁₋₄ alkoxy-thiocarbonyl, (v) C₁₋₄ alkylthio-thiocarbonyl, (vi) mono- or di-C₁₋₄ alkyl-carbamoyl and (vii) mono- or di-C₁₋₄ alkyl-thiocarbamoyl, each of which may be substituted with 1-5 halogens, (3) a formyl group, (4) an amino group which may be substituted with 1 or 2 substituents selected from (a) C₁₋₄ alkyl, (b) C₁₋₄ alkyl-carbonyl which may be substituted with 1-5 halogens, (c) C₁₋₄ alkoxy-carbonyl, (d) mono- or di-C₁₋₄ alkyl-carbamoyl and (e) mono- or di-C₁₋₄ alkyl-thiocarbamoyl, (5) a group represented by —N═CR¹R² wherein each of R¹ and R² independently represents a hydrogen atom or a C₁₋₄ alkyl group, (6) a 3- to 6-memebred cyclic amino group, (7) a group represented by —OR³ wherein R³ represents a hydrogen atom, a C₁₋₄ alkyl group which may be substituted with 1-5 halogens, a C₁₋₄ alkyl-carbonyl group which may be substituted with 1-5 halogens, a C₁₋₄ alkoxy-carbonyl group which may be substituted with 1-5 halogens, a formyl group, or a C₁₋₄ alkylsulofnyl group which may be substituted with 1-5 halogens, or (8) a group represented by —S(O)ₙR⁴ wherein n is an integer of 0 to 2, and R⁴ represents (a) a hydrogen atom, (b) a C₁₋₄ alkyl group which may be substituted with 1-5 halogens, or (c) a C₆₋₁₄ aryl group which may be substituted with 1-5 C₁₋₄ alkyls;

[6] the agricultural and horticultural composition according to any one of the above [1] to [3], wherein A¹ represents a C₆₋₁₄ aryl group which may be substituted with 1-3 C₁₋₄ alkyls, X¹ represents a chemical bond, B¹ represents a thienyl, pyrazolyl, isothiazolyl, imidazolyl, thiazolyl, thiadiazolyl, dioxaindanyl or imidazopyridyl group which may be substituted with 1-5 substituents selected from C₁₋₄ alkyl which may be substituted with 1-5 halogens, C₁₋₄ alkoxy, C₁₄ alkylthio, cyano, halogen and nitro, and Z¹ represents a C₁₆ alkyl group or a C₁₋₄ alkoxy group;

[7] an agricultural and horticultural composition which is used for applying a compound represented by the formula (II):

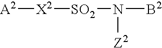

wherein A² represents (1) (i) an aryl group which may be substituted with 1-5 substituents selected from the substituent group (T′) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkyl-carbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxy-carbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula:

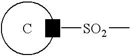

wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthio-thiocarbonyl group, (xxviii) a carbamoyl group, (xxix) a mono- or di-C₁₋₄ alkylcarbamoyl group, (xxx) a group represented by the formula:

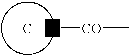

wherein the ring C represents a 3- to 6-membered nitrogen-containing heterocyclic group, (xxxi) a thiocarbamoyl group, (xxxii) a mono- or di-C₁₋₄ alkyl-thiocarbamoyl group, (xxxiii) a group represented by the formula:

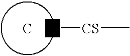

wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group, and (xlv) a sulfo group, or (2) a heterocyclic group which may be substituted,

X² represents (1) a chemical bond, (2) a methylene group which may be substituted, or (3) a vinylene group which may be substituted,

B² represents an aryl group which may be substituted, and

Z² represents (1) an alkyl group which may be substituted with a substituent selected from mono- or di-C₁₋₄ alkylamino, hydroxy, halogen, C₁₋₆ alkoxy, C₁₋₆ alkoxy-carbonyl, C₁₋₆ alkylthio and cyano, (2) a vinyl group, (3) an allyl group, (4) a propadienyl group, (5) an alkynyl group which may be substituted, (6) a cycloalkyl group which may be substituted, (7) an aryl group which may be substituted, (8) an acyl group which may be substituted, (9) a formyl group, (10) an amino group which may be substituted, (11) a group represented by —N═CR¹R² wherein each of R¹ and R² independently represents a hydrogen atom, or a hydrocarbon group which may be substituted, (12) a cyclic amino group, (13) a group represented by —OR³ wherein R³ represents a hydrogen atom, a hydrocarbon group which may be substituted, an acyl group which may be substituted, a formyl group, or an alkyl sulfonyl group which may be substituted, or (14) a group represented by —S(O)ₙR⁴ wherein n is an integer of 0 to 2, and R⁴ represents a hydrogen atom, or a hydrocarbon group which may be substituted, or a salt thereof in combination with a different agricultural chemical active ingredient;

[8] the agricultural and horticultural composition according to the above [7] which comprises the compound represented by the formula (II) or the salt thereof, and the different agricultural chemical active ingredient;

[9] the agricultural and horticultural composition according to the above [7] which is a combination of a composition comprising the compound represented by the formula (II) or the salt thereof, and a composition comprising the different agricultural chemical active ingredient;

[10] the agricultural and horticultural composition according to any one of the above [7] to [9], wherein A² represents (1) a C₆₋₁₄ aryl group which may be substituted with 1-5 substituents selected from the substituent group (T′) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkyl-carbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxy-carbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula:

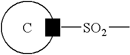

wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthio-thiocarbonyl group, (xxviii) a carbamoyl group, (xxix) a mono- or di-C₁₋₄ alkylcarbamoyl group, (xxx) a group represented by the formula:

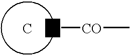

wherein the ring C represents a 3- to 6-membered nitrogen-containing heterocyclic group, (xxxi) a thiocarbamoyl group, (xxxii) a mono- or di-C₁₋₄ alkyl-thiocarbamoyl group, (xxxiii) a group represented by the formula:

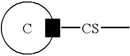

wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group and (xliv) a sulfo group, or (2) a heterocyclic group which may be substituted with 1-5 substituents selected from the substituent group (T) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkyl-carbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxy-carbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula:

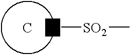

wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthio-thiocarbonyl group, (xxviii) a carbamoyl group, (xxix) a mono- or di-C₁₋₄ alkylcarbamoyl group, (xxx) a group represented by the formula:

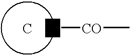

wherein the ring C represents a 3- to 6-membered nitrogen-containing heterocyclic group, (xxxi) a thiocarbamoyl group, (xxxii) a mono- or di-C₁₋₄ alkyl-thiocarbamoyl group, (xxxiii) a group represented by the formula:

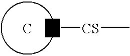

wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group and (xlv) a sulfo group,

X² represents (1) a chemical bond, (2) a methylene group which may be substituted with 1 or 2 substituents selected from C₁₋₄ alkyl, C₁₋₄ alkoxy, C₁₋₄ alkylthio, halogen and cyano, or (3) a vinylene group which may be substituted with 1 or 2 substituents selected from C₁₋₄ alkyl, C₁₋₄ alkoxy, C₁₋₄ alkylthio, halogen and cyano,

B² represents a C₆₋₁₄ aryl group which may be substituted with 1-5 substituents selected from the abovementioned substituent group (T), and

Z² represents (1) a C₁₋₆ alkyl group which may be substituted with 1-5 substituents selected from mono- or di-C₁₋₄ alkylamino, hydroxy, halogen, C₁₋₄ alkoxy, C₁₋₄ alkoxy-carbonyl, C₁₋₄ alkylthio and cyano, (2) a vinyl group, (3) an allyl group, (4) a propadienyl group, (5) a C₂₋₆ alkynyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (6) a C₃₋₆ cycloalkyl group which may be substituted with 1-5 substituents selected from (a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkyl sulfonyl, (k) cyano, (l) C₁₋₄ alkoxy-carbonyl, (m) carbamoyl, and (n) mono- or di-C₁₋₄ alkyl-carbamoyl, (7) a C₆₋₁₄ aryl group which may be substituted with 1-5 substituents selected from (a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkyl sulfonyl, (k) cyano, (l) C₁₋₄ alkoxy-carbonyl, (m) carbamoyl, and (n) mono- or di-C₁₋₄ alkyl-carbamoyl, (8) an acyl group which may be substituted with 1-5 halogens and is selected from (i) C₁₋₄ alkyl-carbonyl, (ii) C₁₋₄ alkoxy-carbonyl, (iii) C₁₋₄ alkylthio-carbonyl, (iv) C₁₋₄ alkoxy-thiocarbonyl, (v) C₁₋₄ alkylthio-thiocarbonyl, (vi) mono- or di-C₁₋₄ alkyl-carbamoyl, and (vii) mono- or di-C₁₋₄ alkyl-thiocarbamoyl, (9) a formyl group, (10) an amino group which may be substituted with 1 or 2 substituents selected from (a) C₁₋₄ alkyl, (b) C₁₋₄ alkyl-carbonyl which may be substituted with 1-5 halogens, (c) C₁₋₄ alkoxy-carbonyl, (d) mono- or di-C₁₋₄ alkyl-carbamoyl and (e) mono- or di-C₁₋₄ alkyl-thiocarbamoyl, (11) a group represented by —N═CR¹R² wherein each of R¹ and R² independently represents a hydrogen atom or a C₁₋₄ alkyl group, (12) a 3- to 6-memebred cyclic amino group, (13) a group represented by —OR³ wherein R³ represents a hydrogen atom, a C₁₋₄ alkyl group which may be substituted with 1-5 halogens, a C₁₋₄ alkyl-carbonyl group which may be substituted with 1-5 halogens, a C₁₋₄ alkoxy-carbonyl group which may be substituted with 1-5 halogens, a formyl group, or a C₁₋₄ alkylsulfonyl group which may be substituted with 1-5 halogens, or (14) a group represented by —S(O)ₙR⁴ wherein n is an integer of 0 to 2, and R⁴ represents (a) a hydrogen atom, (b) a C₁₋₄ alkyl group which may be substituted with 1-5 halogens, or (c) a C₆₋₁₄ aryl group which may be substituted with 1-5 C₁₋₄ alkyls;

[11] the agricultural and horticultural composition according to any one of the above [7] to [9], wherein A² represents (1) a C₆₋₁₄ aryl group which may be substituted with 1-5 substituents selected from (i) a C₁₋₄ alkyl group which may be substituted with 1-5 halogens, (ii) a C₁₋₄ alkoxy group which may be substituted with 1-5 halogens, (iii) an amino group which may be substituted with 1 or 2 C₁₋₄ alkyl-carbonyls, (iv) a C₁₋₄ alkoxy-carbonyl group, (v) a halogen atom, (vi) a cyano group, and (vii) a nitro group, or (2) a thienyl, triazolyl, imidazolyl, isoxazolyl, pyrazolyl, pyridyl, quinolyl, benzothiadiazolyl, imidazothiazolyl or imidazopyridyl group, each of which may be substituted with 1-5 substituents selected from (i) a C₁₋₄ alkyl group, (ii) a C₁₋₄ alkoxy-carbonyl group, (iii) a carbamoyl group, (iv) a mono- or di-C₁₋₄ alkylcarbamoyl group, (v) a C₁₋₄ alkylsulfonyl group, (vi) a halogen atom, (vii) a carboxyl group, and (viii) a cyano group,

X² represents (1) a chemical bond, (2) a methylene group which may be substituted with 1 or 2 C₁₋₄ alkyls, or (3) a vinylene group which may be substituted with 1 or 2 C₁₋₄ alkyls,

B² represents a C₆₋₁₄ aryl group which may be substituted with 1-5 substituents selected from (1) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrazono and C₁₋₄ alkylthio, (2) a C₂₋₄ alkynyl group, (3) a hydroxyl group, (4) a C₁₋₄ alkoxy group which may be substituted with 1-5 substituents selected from halogen and C₁₋₄ alkoxy, (5) a C₁₋₄ alkyl-carbonyloxy group, (6) a C₁₋₄ alkylthio group, (7) a C₁₋₄ alkylsulfinyl group, (8) a C₁₋₄ alkylsulfonyl group, (9) a mono- or di-C₁₋₄ alkylsulfamoyl group, (10) an amino group, (11) a formyl group, (12) a C₁₋₄ alkoxycarbonyl group, (13) a carbamoyl group, (14) a mono- or di-C₁₋₄ alkylcarbamoyl group, (15) a thiocarbamoyl group, (16) a halogen atom, (17) a carboxyl group, (18) a thiocyanato group, (19) a cyano group, (20) a nitroso group, and (21) a nitro group, and

Z² represents (1) a C₁₋₆ alkyl group which may be substituted with 1-5 substituents selected from mono- or di-C₁₋₄ alkylamino, hydroxy, halogen, C₁₋₄ alkoxy, C₁₋₄ alkoxy-carbonyl, C₁₋₄ alkylthio and cyano, (2) a vinyl group, (3) an allyl group, (4) a propadienyl group, (5) a C₂₋₆ alkynyl group which may be substituted with 1-5 halogens, (6) a C₃₋₆ cycloalkyl group, (7) a C₆₋₁₄ aryl group, (8) a C₁₋₄ alkyl-carbonyl group which may be substituted with 1-5 halogens, (9) an amino group which may be substituted with 1 or 2 substituents selected from C₁₋₄ alkyl, C₁₋₄ alkylcarbonyl and C₁₋₄ alkoxy-carbonyl, (10) a group represented by —N═CR¹R² wherein each of R¹ and R² independently represents a C₁₄ alkyl group, (11) a group represented by —OR³ wherein R³ represents a C₁₋₄ alkyl group or a C₁₋₄ alkylcarbonyl group, or (12) a group represented by —S(O)ₙR⁴ wherein n is an integer of 0 to 2, and R⁴ represents (a) a C₁₋₄ alkyl group which may be substituted with 1-5 halogens or (b) a C₆₋₁₄ aryl group which may be substituted with 1-5 C₁₋₄ alkyls;

[12] the agricultural and horticultural composition according to any one of the above [7] to [9], wherein A² represents a phenyl group which may be substituted with 1-3 substituents selected from C₁₋₄ alkyl, halogen, and cyano, X² represents a chemical bond, B² represents a phenyl group which may be substituted with 1-5 substituents selected from (1) a C₁₋₄ alkyl group which may be substituted with 1-3 halogens, (2) a C₁₋₄ alkoxy group, (3) a C₁₋₄ alkylthio group, (4) a thiocarbamoyl group, (5) a halogen atom, (6) a cyano group and (7) a nitro group, and Z² represents (1) a C₁₋₆ alkyl group which may be substituted with 1-3 C₁₋₄ alkoxys, (2) a C₃₋₆ cycloalkyl group, (3) an ally group or (4) a C₁₋₄ alkoxy group;

[13] the agricultural and horticultural composition according to any one of the above [7] to [9], wherein the compound or the salt thereof is 4′-chloro-N-ethyl-2′-nitro-p-toluenesulfonanilide, 2′,4′-dinitro-N-ethyl-p-toluenesulfonanilide, 2′,4′-dicyano-N-ethyl-p-toluenesulfonanilide, 4′-chloro-N-isopropyl-2′-nitro-p-toluenesulfonanilide, 4′-fluoro-N-isopropyl-2′-nitro-p-toluenesulfonanilide, 4′-cyano-N-isopropyl-2′-nitro-p-toluenesulfonanilide, 4′-chloro-N-isopropyl-2′-nitro-p-toluenesulfonanilide, 2′,4′-dinitro-N-isopropyl-p-toluenesulfonanilide, 4′-nitro-N-isopropyl-2′-cyano-p-toluenesulfonanilide, 2′-cyano-N-methoxy-4′-nitro-p-toluenesulfonanilide or 2′,4′-dinitro-N-methoxy-p-toluenesulfonanilide, or a salt thereof;

[14] an agricultural and horticultural composition which is used for applying a compound represented by the formula (III):

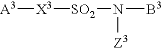

wherein A³ represents (1) an aryl group which may be substituted or (2) a heterocyclic group which may be substituted,

X³ represents (1) a chemical bond, (2) a methylene group which may be substituted, or (3) a vinylene group which may be substituted,

B³ represents a 6-memebred heterocyclic group having a substituent selected from the substituent group (T) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkyl-carbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxy-carbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula:

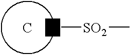

wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthio-thiocarbonyl group, (xxviii) a carbamoyl group, (xxix) a mono- or di-C₁₋₄ alkylcarbamoyl group, (xxx) a group represented by the formula:

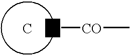

wherein the ring C represents a 3- to 6-membered nitrogen-containing heterocyclic group, (xxxi) a thiocarbamoyl group, (xxxii) a mono- or di-C₁₋₄ alkyl-thiocarbamoyl group, (xxxiii) a group represented by the formula:

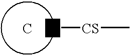

wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group and (xlv) a sulfo group, and

Z³ represents (1) a hydrocarbon group which may be substituted, (2) an acyl group which may be substituted, (3) a formyl group, (4) an amino group which may be substituted, (5) —N═NCR¹R² wherein each of R¹ and R² independently represents a hydrogen atom or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group or a sulfonyl group which may be substituted or (8) a group represented by —S(O)ₙR⁴ wherein n is an integer of 0 to 2, and R⁴ represents a hydrogen atom or a hydrocarbon group which may be substituted, or a salt thereof in combination with a different agricultural chemical active ingredient;

[15] the agricultural and horticultural composition according to the above [14] which comprises the compound represented by the formula (III) or the salt thereof, and the different agricultural chemical active ingredient;

[16] the agricultural and horticultural composition according to the above [14] which is a combination of a composition comprising the compound represented by the formula (III) or the salt thereof, and a composition comprising the different agricultural chemical active ingredient;

[17] the agricultural and horticultural composition according to any one of the above [14] to [16], wherein A³ represents (1) a C₆₋₁₄ aryl group which may be substituted with 1-5 substituents selected from the substituent group (T) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkyl-carbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxy-carbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula:

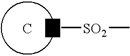

wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthio-thiocarbonyl group, (xxviii) a carbamoyl group, (xxix) a mono- or di-C₁₋₄ alkylcarbamoyl group, (xxx) a group represented by the formula:

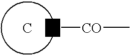

wherein the ring C represents a 3- to 6-membered nitrogen-containing heterocyclic group, (xxxi) a thiocarbamoyl group, (xxxii) a mono- or di-C₁₋₄ alkyl-thiocarbamoyl group, (xxxiii) a group represented by the formula:

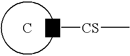

wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group and (xlv) a sulfo group, or (2) a heterocyclic group which may be substituted with 1-5 substituents selected from the above-mentioned substituent group (T),

X³ represents (1) a chemical bond, (2) a methylene group which may be substituted with 1 or 2 substituents selected from C₁₋₄ alkyl, C₁₋₄ alkoxy, C₁₋₄ alkylthio, halogen and cyano, (3) a vinylene group which may be substituted with 1 or 2 substituents selected from C₁₋₄ alkyl, C₁₋₄ alkoxy, C₁₋₄ alkylthio, halogen and cyano,

B³ represents a 6-membered heteroring substituted with 1-5 substituents selected from the above-mentioned substituent group (T), and

Z³ represents (1) a hydrocarbon group selected from (i) a C₁₋₆ alkyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (ii) a C₂₋₆ alkenyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (iii) a C₂₋₆ alkynyl group which may be substituted with 1-5 substituents selected from (a) halogens, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (iv) a C₃₋₆ cycloalkyl group which may be substituted with 1-5 substituents selected from(a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkyl sulfonyl, (k) cyano, (l) C₁₋₄ alkoxy-carbonyl, (m) carbamoyl, and (n) mono- or di-C₁₋₄ alkyl-carbamoyl, (v) a C₃₋₆ alkadienyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (vi) a C₆₋₁₄ aryl group which may be substituted with 1-5 substituents selected from (a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be-substituted with 1-5 halogens, (g) mercapto, (h) C₁₋₄ alkylthio, (i) C₁₋₄ alkylsulfinyl, (j) C₁₋₄ alkyl sulfonyl, (k) cyano, (l) C₁₋₄ alkoxy-carbonyl, (m) carbamoyl and (n) mono- or di-C₁₋₄ alkyl-carbamoyl, (2) an acyl group selected from (i) C₁₋₄ alkyl-carbonyl, (ii) C₁₋₄ alkoxycarbonyl, (iii) C₁₋₄ alkylthio-carbonyl, (iv) C₁₋₄ alkoxy-thiocarbonyl, (v) C₁₋₄ alkylthio-thiocarbonyl, (vi) mono- or di-C₁₋₄ alkyl-carbamoyl, and (vii) mono- or di-C₁₋₄ alkyl-thiocarbamoyl, each of which may be substituted with 1-5 halogens, (3) a formyl group, (4) an amino group which may be substituted with 1 or 2 substituents selected from (a) C₁₋₄ alkyl, (b) C₁₋₄ alkyl-carbonyl which may be substituted with 1-5 halogens, (c) C₁₋₄ alkoxy-carbonyl, (d) mono- or di-C₁₋₄ alkyl-carbamoyl and (e) mono- or di-C₁₋₄ alkyl-thiocarbamoyl, (5) a group represented by —N═CR¹R² wherein each of R¹ and R² independently represents a hydrogen atom or a C₁₋₄ alkyl group, (6) a 3- to 6-memebred cyclic amino group, (7) a group represented by —OR³ wherein R³ represents a hydrogen atom, a C₁₋₄ alkyl group which may be substituted with 1-5 halogens, a C₁₋₄ alkyl-carbonyl group which may be substituted with 1-5 halogens, a C₁₋₄ alkoxycarbonyl group which may be substituted with 1-5 halogens, a formyl group, or a C₁₋₄ alkylsulfonyl group which may be substituted with 1-5 halogens or (8) a group represented by —S(O)ₙR⁴ wherein n is an integer of 0 to 2, and R⁴ represents (a) a hydrogen atom, (b) a C₁₋₄ alkyl group which may be substituted with 1-5 halogens, or (c) a C₆₋₁₄ aryl group which may be substituted with 1-5 C₁₋₄ alkyls;

[18] the agricultural and horticultural composition according to any one of the above [14] to [16], wherein A³ represents a phenyl group which may be substituted with 1-5 C₁₋₄ alkyls or an imidazolyl group which may be substituted with 1 or 2 C₁₋₄ alkyls, X³ represents a chemical bond, B³ represents a pyridyl, pyridazinyl or pyrimidinyl group which may be substituted with 1-5 substituents selected from C₁₋₄ alkyl which may be substituted with 1-5 halogens, C₁₋₄ alkoxy, halogen, nitro and cyano, and Z³ represents a C₁₋₆ alkyl group, a C₃₋₆ cycloalkyl group or a C₁₋₄ alkoxy group;

[19] an agricultural and horticultural composition which is used for applying a compound represented by the formula (IV):

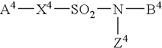

wherein A⁴ represents (1) an aryl group which may be substituted or (2) a heterocyclic group which may be substituted,

X⁴ represents (1) a chemical bond, (2) a methylene group which may be substituted or (3) a vinylene group which may be substituted,

B⁴ represents a pyridazinyl group or a pyrazinyl group, and

Z⁴ represents (1) a hydrocarbon which may be substituted, (2) an acyl group which may be substituted, (3) a formyl group, (4) an amino group which may be substituted, (5) —N═CR¹R² wherein each of R¹ and R² independently represents a hydrogen atom or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group or a sulfonyl group which may be substituted or (8) a group represented by —S(O)ₙR⁴ wherein n is an integer of 0 to 2 and R⁴ represents a hydrogen atom or a hydrocarbon group which may be substituted, or a salt thereof in combination with a different agricultural chemical active ingredient;

[20] the agricultural and horticultural composition according to the above [19] which comprises the compound represented by the formula (IV) or the salt thereof, and the different agricultural chemical active ingredient;

[21] the agricultural and horticultural composition according to the item [19] which is a combination of a composition comprising the compound represented by the formula (IV) or the salt thereof, and a composition comprising the different agricultural chemical active ingredient;

[22] an agricultural and horticultural composition which is used for applying a compound represented by the formula (V):

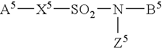

wherein A⁵ represents a 4-methylphenyl group, X⁵ represents a chemical bond, B⁵ represents a pyridyl group or a pyrimidinyl group, and Z⁵ represents a C₁₋₄ alkyl group, or a salt thereof in combination with a different agricultural chemical active ingredient;

[23] the agricultural and horticultural composition according to the above [22] which comprises the compound represented by the formula (V) or the salt thereof, and the different agricultural chemical active ingredient;

[24] the agricultural and horticultural composition according to the above [22] which is a combination of a composition comprising the compound represented by the formula (V) or the salt thereof, and a composition comprising the different agricultural chemical active ingredient;

[25] an agricultural and horticultural composition which is used for applying a compound represented by the formula (VI):

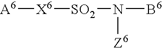

wherein A⁶ represents a phenyl group which may be substituted with a substituent selected from C₁₋₄ alkyl, halogen and cyano, X⁶ represents a chemical bond, B⁶ represents a 2-nitrophenyl group or a 2-cyanophenyl group substituted with a substituent selected from halogen, nitro and cyano, and Z⁶ represents an ethyl group, an isopropyl group, a cyclopropyl group, a methoxy group, an ethoxy group or an isopropoxy group, or a salt thereof in combination with a different agricultural chemical active ingredient;

[26] the agricultural and horticultural composition according to the above [25] which comprises the compound represented by the formula (VI) or the salt thereof, and the different agricultural chemical active ingredient;

[27] the agricultural and horticultural composition according to the above [25] which is a combination of a composition comprising the compound represented by the formula (VI) or the salt thereof, and a composition comprising the different agricultural chemical active ingredient;

[28] the agricultural and horticultural composition according to any one of the above [1] to [27], wherein the different agricultural chemical active ingredient is an insecticidal component;

[29] the agricultural and horticultural composition according to any one of the above [1] to [27], wherein the different agricultural chemical component agent is a microbiocidal component;

[30] the agricultural and horticultural composition according to the item [1], wherein the different agricultural chemical active ingredient is an insecticidal and an microbiocidal components; and

[31] the agricultural and horticultural composition according to the above [29] or [30] , wherein the microbiocidal component is at least one component selected from epoxiconazole, flusilazole, picoxystrobin, pyraclostrobin, trifloxystrobin, and iprovalicarb.

Preferred embodiments of the present invention are:

[32] a microbiocidal composition for agriculture and horticulture which comprises 4′-chloro-N-ethyl-2′-nitro-p-toluenesulfonanilide or a salt thereof, and epoxiconazole;

[33] a microbiocidal composition for agriculture and horticulture which comprises 4′-chloro-N-ethyl-2′-nitro-p-toluenesulfonanilide or a salt thereof, and flusilazole;

[34] a microbiocidal composition for agriculture and horticulture which comprises 4′-chloro-N-ethyl-2′-nitro-p-toluenesulfonanilide or a salt thereof, and picoxystrobin;

[35] a microbiocidal composition for agriculture and horticulture which comprises 4′-chloro-N-ethyl-2′-nitro-p-toluenesulfonanilide or a salt thereof, and pyraclostrobin;

[36] a microbiocidal composition for agriculture and horticulture which comprises 4′-chloro-N-ethyl-2′-nitro-p-toluenesulfonanilide or a salt thereof, and trifloxystrobin; and

[37] a microbiocidal composition for agriculture and horticulture which comprises 4′-chloro-N-ethyl-2′-nitro-p-toluenesulfonanilide or a salt thereof, and iprovalicarb.

The present invention also provides:

[38] a method for reinforcing microbiocidal effect of at least one of the compounds represented by the formulas (I) to (VI), and salts thereof which comprises at least one of the compounds represented by the formulas (I) to (VI) or a salt thereof is used in combination with a different agricultural chemical active ingredient; and

[39] a method for reinforcing microbiocidal effect or insecticidal effect of an agricultural chemical active ingredient other than those represented by the formulas (I) to (VI) or salts thereof which comprises at least one of the compounds represented by the formulas (I) to (VI) or a salt thereof is used in combination with the other agricultural chemical active ingredient.

### DETAILED DESCRIPTION OF THE INVENTION

The compound (I⁰) which is a sulfonamide derivative, may have optical active isomers, diastereomers, and/or geometrical isomers. The present invention embraces each of these isomers, and mixtures of these isomers.

The aryl group in the “aryl group which may be substituted” as A⁰ may be C₆₋₁₄ aryl groups such as phenyl and naphthyl (for example, 1-naphthyl and 2-naphthyl).

A substituent of the aryl group may be as follows:

i) a C₁₋₄ alkyl group (for example, methyl, ethyl, n-propyl, isopropyl, n-butyl, sec-butyl, isobutyl or tert-butyl) which may be substituted with 1-5 substituents selected from halogen, hydroxy, imino, hydroxyimino, C₁₋₄ alkoxyimino (for example, methoxyimino or ethoxyimino), hydrazono, mono- or di-C₁₋₄ alkylhydrozono (for example, methylhydrazono, ethylhydrazono or dimethylhydrazono) and C₁₋₄ alkylthio (for example, methylthio, ethylthio, n-propylthio, isopropylthio, n-butylthio, sec-butylthio, isobutylthio or tert-butylthio),

(ii) a C₃₋₆ cycloalkyl group (for example, cyclopropyl, cyclobutyl, cyclopentyl, or cyclohexyl) which may be substituted with 1-5 halogens,

(iii) a C₂₋₄ alkenyl group (for example, vinyl, ally, propenyl, isopropenyl, 2-methyl-1-propenyl, 1-butenyl, 2butenyl, or 3-butenyl) which may be substituted with 1-5 substituents selected from halogen, cyano and nitro,

(iv) a C₃₋₆ cycloalkenyl group (for example, cyclopropenyl, cyclobutenyl, cyclopentenyl, or cyclohexenyl) which may be substituted with 1-5 halogens,

(v) a C₂₋₄ alkynyl group (for example, ethynyl, 1-propynyl, 2-propynyl, 1-butynyl, 2-butynyl, or 3-butynyl) which may be substituted with 1-5 halogens,

(vi) a hydroxyl group,

(vii) a C₁₋₄ alkoxy group (for example, methoxy, ethoxy, n-propoxy, isopropoxy, n-butoxy, isobutoxy, sec-butoxy, or tert-butoxy) which may be substituted with 1-5 substituents selected from halogen and C₁₋₄ alkoxy (for example, methoxy or ethoxy),

(viii) a formyloxy group,

(ix) a C₁₋₄ alkyl-carbonyloxy group (for example, acetyloxy, propionyloxy, butylyloxy, or isobutylyloxy) which may be substituted with 1-5 halogens,

(x) a C₁₋₄ alkoxy-carbonyloxy group (for example, methoxycarbonyloxy, ethoxycarbonyloxy, n-propoxycarbonyloxy, or isopropoxycarbonyloxy) which may be substituted with 1-5 halogens,

(xi) a mercapto group,

(xii) a C₁₋₄ alkylthio group (for example, methylthio, ethylthio, n-propylthio, isopropylthio, n-butylthio, isobutylthio, sec-butylthio, or tert-butylthio) which may be substituted with 1-5 halogens,

(xiii) a C₁₋₄ alkyl-carbonylthio group (for example, acetylthio, propionylthio, butylthio, or isobutylthio) which may be substituted with 1-5 halogens,

(xiv) a C₁₋₄ alkoxy-carbonylthio group (for example, methoxycarbonylthio, ethoxycarbonylthio, n-propoxycarbonylthio, or isopropoxycarbonylthio) which may be substituted with 1-5 halogens,

(xv) a C₁₋₄ alkylsulfinyl group (for example, methylsulfinyl, ethylsulfinyl, n-propylsulfinyl, or isopropylsulfinyl) which may be substituted with 1-5 halogens,

(xvi) a C₁₋₄ alkylsulfonyl group (for example, methylsulfonyl, ethylsulfonyl, n-propylsulfonyl, or isopropylsulfonyl) which may be substituted with 1-5 halogens,

(xvii) a sulfamoyl group,

(xviii) a mono- or di-C₁₋₄ alkylsulfamoyl group (for example, methylsulfamoyl, ethylsulfamoyl, n-propylsulfamoyl , dimethylsulfamoyl, ethylmethylsulfamoyl, or diethylsulfamoyl),

(xix) a group represented by the following formula:

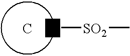

wherein the ring C represents a 3- to 6-membered nitrogen-containing heterocyclic group (for example, aziridino, azetidino, pyrrolidino, piperidino, morpholino, or thiomorpholino),

(xx) an amino group which may be substituted with one or two substituents selected from C₁₋₄ alkyl (for example, methyl, ethyl, n-propyl, isopropyl, n-butyl, isobutyl, sec-butyl, or tert-butyl), C₂₋₄ alkenyl (for example, vinyl, allyl, propenyl, isopropenyl, 2-methyl-1-propenyl, 1-butenyl, 2-butenyl, or 3-butenyl), C₂₋₄ alkynyl (for example, ethynyl, 1-propynyl, 2-propynyl, 1-butynyl, 2-buthynyl, or 3-buthynyl), hydroxy, C₁₋₄ alkoxy (for example, methoxy, ethoxy, n-propoxy, isopropoxy, n-butoxy, isobutoxy, sec-butoxy, or tert-butoxy), formyloxy, C₁₋₄ alkyl-carbonyloxy (for example, acetyloxy, propionyloxy, butylyloxy, or isobutyloxy), formyl and C₁₋₄ alkyl-carbonyl (for example, acetyl, propionyl, butylyl, or isobutylyl),

(xxi) a 3- to 6-membered cyclic amino group (for example, aziridino, azetidino, pyrrolidino, piperidino, morpholino, or thiomorpholino),

(xxii) a formyl group,

(xxiii) a C₁₋₄ alkyl-carbonyl group (for example, acetyl, propionyl, butylyl, or isobutylyl) which may be substituted with 1-5 halogens,

(xxiv) a C₁₋₄ alkoxy-carbonyl group (for example, methoxycarbonyl, ethoxycarbonyl, n-propoxycarbonyl, or isopropoxycarbonyl) which may be substituted with 1-5 halogens,

(xxv) a C₁₋₄ alkylthio-carbonyl group (for example, (methylthio)carbonyl, (ethylthio)carbonyl, (n-propylthio)carbonyl, (isopropylthio)carbonyl, (n-butylthio)carbonyl, (isobutylthio)carbonyl, (sec-butylthio)carbonyl, or (tert-butylthio)carbonyl),

(xxvi) a C₁₋₄ alkoxy-thiocarbonyl group (for example, (methoxy)thiocarbonyl, (ethoxy)thiocarbonyl, (n-propoxy)thiocarbonyl, or (isopropoxy)thiocarbonyl),

(xxvii) a C₁₋₄ alkylthio-thiocarbonyl group (for example, (methylthio)thiocarbonyl, (ethylthio)thiocarbonyl, (n-propylthio)thiocarbonyl, (isopropylthio)thiocarbonyl, (n-butylthio)thiocarbonyl, (isobutylthio)thiocarbonyl, (sec-butylthio)thiocarbonyl, or (tert-butylthio)thiocarbonyl,

(xxviii) a carbamoyl group,

(xxix) a mono- or di-C₁₋₄ alkylcarbamoyl group (for example, methylcarbamoyl, ethylcarbamoyl, n-propylcarbamoyl , dimethylcarbamoyl, ethylmethylcarbamoyl, or diethylcarbamoyl),

(xxx) a group represented by the following formula:

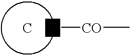

the ring C represents a 3- to 6-membered nitrogen-containing heterocyclic group (for example, aziridino, azetidino, pyrrolidino, piperidino, morpholino, or thiomorpholino),

(xxxi) a thiocarbamoyl group,

(xxxii) a mono- or di-C₁₋₄ alkyl-thiocarbamoyl group (for example, (methyl)thiocarbamoyl, (ethyl)thiocarbamoyl, (n-propyl)thiocarbamoyl, (dimethy)thiolcarbamoyl, (ethylmethyl)thiocarbamoyl, or (diethyl)thiocarbamoyl),

(xxxiii) a group represented by the following:

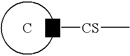

the ring C represents a 3- to 6-membered nitrogen-containing heterocyclic group (for example, aziridino, azetidino, pyrrolidino, piperidino, morpholino, or thiomorpholino),

(xxxiv) a halogen atom (for example, fluorine, chlorine, bromine or iodine),

(xxxv) a carboxyl group,

(xxxvi) a thiocyanate group,

(xxxvii) an isothiocyanate group,

(xxxviii) a cyano group,

(xxxix) an isocyano group,

(xl) an azide group,

(xli) a nitroso group,

(xlii) a nitro group,

(xliii) an azocyano group,

(xliv) an azoxycyano group (—NO═N—CN), and

(xlv) a sulfo group.

The above-mentioned substituent group of the above-mentioned substituents (i) to (xlv) may be referred to as the substituent group T hereinafter. The substituent group of the above-mentioned substituents (i) to (xliii) and (xlv) may be referred to as the substituent group (T′). (The “halogen” in the above-mentioned substituent is, for example, fluorine, chlorine, bromine or iodine)

The number of the substituent(s) in the aryl group is from 1 to 5, preferably from 1 to 3.

The heterocyclic group in the “heterocyclic group which may be substituted” as A⁰ represents, for example, a 5- or 6-memebred heterocyclic group containing 1-4 heteroatoms selected from nitrogen, oxygen and sulfur atoms; or a condensed heterocyclic group composed of a 5- or 6-memebred heterocyclic group containing 1-4 heteroatoms selected from nitrogen, oxygen and sulfur atoms and a benzene ring, or a condensed heterocyclic group composed of a 5- or 6-memebred heterocyclic group containing 1-4 heteroatoms selected from nitrogen, oxygen and sulfur atoms and a 5- or 6-memebred heterocyclic group containing 1-4 heteroatoms selected from nitrogen, oxygen and sulfur atoms.

Specific examples thereof include pyrrolyl (for example, 1-, 2-, or 3-pyrrolyl), pyrazolyl (for example, 1-, 3-, 4- or 5-pyrazolyl), imidazolyl (for example, 1-, 2-, 4- or 5-imidazolyl), triazolyl (for example, 1,2,3-triazole-1-, 4- or 5-yl, 1,2,4-triazole-1-, 3-, 4- or 5-yl), tetrazolyl (for example, tetrazole-1-, 2- or 5-yl), furyl (for example, 2- or 3-furyl), thienyl (for example, 2-, or 3-thienyl), oxazolyl (for example, 2-, 4- or 5-oxazolyl), isoxazolyl (for example, 3-, 4- or 5-isoxazolyl), oxadiazolyl (for example, 1,2,3-oxadiazole-4- or 5-yl, 1,2,4-oxadiazole-3- or 5-yl, or 1,2,5-oxadiazole-3-yl, 1,3,4-oxadiazole-2-yl), thiazolyl (for example, 2-, 4- or 5-thiazolyl), isothiazolyl (for example, 3-, 4- or 5-isothiazolyl), thiadiazolyl (for example, 1,2,3-thiadiazole-4- or 5-yl, 1,2-4-thiadiazole-3- or 5-yl, 1,2,5-thiadiazole-3-yl, or 1,3,4-thiadiazole-2-yl), pyrrolidinyl (for example, 1-, 2- or 3-pyrrolidinyl), pyridyl (for example, 2-, 3- or 4-pyridyl), pyridazinyl (for example, 3- or 4-pyridazinyl), pyrimidinyl (for example, 2-, 4- or 5-pyrimidinyl), pyradinyl, pyperidinyl (for example, 1-, 2-, 3- or 4-pyperidinyl), pyperadinyl (for example, 1 or 2-pyperadinyl), indolyl (for example, 3H-indole-2-, 3-, 4-, 5-, 6- or 7-yl), pyranyl (for example, 2-, 3- or 4-pyranyl), thiopyranyl (for example, 2-, 3- or 4-thiopyranyl), morpholinyl (for example, 2-, 3- or 4-morpholinyl), thiomorpholinyl, quinolyl (for example, 2-, 3-, 4-, 5-, 6-, 7- or 8-quinolyl), isoquinolyl, pyrido[2,3-d]pyrimidinyl (for example, pyrido[2,3-d]pyrimidine-2-yl), naphthilidinyl such as 1,5-, 1,6-, 1,7-, 1,8-, 2,6-, or 2,7-naphthilidinyl (for example, 1,5-naphthilidine-2- or 3-yl), thieno[2,3-d]pyridyl (for example, thieno[2,3-d]pyridine-3-yl), pyradinoquinolyl (for example, pyradino[2,3-d]quinolyl-2-yl), chromenyl (for example, 2H-chromene-2-, 3-, 4-, 5- or 6-yl), chromanyl (for example, 1-, 2-, 3-, 4-, 5-, 6-, 7- or 8-chromanyl), isochromanyl (for example, 1-, 3-, 4-, 5-, 6-, 7- or 8-isochromanyl), benzofuryl (for example, 2-, 3-, 4-, 5-, 6- or 7-benzofuryl), benzothienyl (for example, 2-, 3-, 4-, 5-, 6- or 7-benzothienyl), benzoimidazolyl (for example, 2-, 4-, 5-, 6- or 7-benzoimidazolyl), indazolyl (for example, 1H-indazole-1-, 3-, 4-, 5-, 6- or 7-yl), benzoxazolyl (for example, 2-, 4-, 5-, 6- or 7- benzoxazolyl), benzoisoxazolyl (for example, 3-, 4-, 5-, 6- or 7-benzoisoxazolyl), benzothiazolyl (for example, 2, 4-, 5-, 6- or 7-benzothiazolyl), benzothiadiazolyl (for example, benzo-1,2,3-thiadiazole-4-, 5-, 6- or 7-yl, benzo-1,2,4-thiadiazole-3-, 4-, 5-, 6- or 7-yl, benzo-1,2,5-thiadiazole-3-, 4-, 5-, 6- or 7-yl, or benzo-1,3,4-thiadiazole-2-, 4-, 5-, 6- or 7-yl), benzoisothiazolyl (for example, 3-, 4-, 5-, 6- or 7-benzoisothiazolyl), benzotriazolyl (for example, 4-, 5-, 6-, 7- or 8-benzo1,2,3-triazolyl, or 3-, 5-, 6-, 7- or 8-benzo-1,2,4- triazolyl), cinnolyl (for example, 3-, 4-, 5-, 6-, 7- or 8-cinnolyl), phthaladinyl (for example, 1-, 5- or 6-phthaladinyl), quinazolinyl (for example, 2-, 4-, 5-, 6-, 7- or 8-quinazolinyl), quinoxalinyl (for example, 2-, 5- or 6-quinoxalinyl), imidazopyridyl(for example, imidazo[1,2-a]pyridyl such as imidazo[1,2-a]pyridine-2-yl or imidazo[1,2-a]pyridine-3-yl), imidazothiazolyl (for example, imidazo[2,1-b]thiazolyl such as imidazo[2,1-b]thiazole-5-yl), dioxaindanyl (for example, 1,3-dioxaindanyl such as 1,3-dioxaindane-2-, 4-, 5-, 6- or 7-yl), and so on.

Among these heterocyclic groups, triazolyl, pyridyl, quinolyl, thienyl, isoxazolyl, pyrazolyl, imidazolyl, benzothiadiazolyl, imidazopyridyl, imidazothiazolyl and so on are particularly preferred.

As a substituent of the heterocyclic group, a substituent included in the above-mentioned substituent group (T) is preferred. The number of the substituent(s) is from 1 to 5, preferably from 1 to 3.

Preferred substituents of the aryl group in the “the aryl group which may be substituted” of A⁰ or the heterocyclic group in the “heterocyclic group which may be substituted” of A⁰ are the following:

(1) C₁₋₄ alkyl which may be substituted with 1-5 halogens,

(2) amino which may be substituted with 1 or 2 C₁₋₄ alkyl-carbonyls,

(3) nitro,

(4) C₁₋₄ alkoxy which may be substituted with 1-5 halogens,

(5) halogen,

(6) C₁₋₄ alkoxy-carbonyl,

(7) cyano,

(8) mono- or di-C₁₋₄ alkylcarbamoyl,

(9) C₁₋₄ alkylsulfonyl,

(10) carbamoyl, and

(11) carboxyl.

As A⁰, a phenyl group which may be substituted with 1-3 substituents selected from C₁₋₄ alkyl, halogen and cyano is preferred. A phenyl group which may be substituted with 1-3 substituents selected from C₁₋₄ alkyl and halogen is particularly preferred. The substituent with which the phenyl group is substituted at the 4-position is particularly preferred.

As a substituent of the methylene group as X⁰, the following are preferred:

(1) C₁₋₄ alkyl (for example, methyl, ethyl, n-propyl, isopropyl, n-butyl, isobutyl, sec-butyl and tert-butyl),

(2) C₁₋₄ alkoxy (for example, methoxy, ethoxy, n-propoxy, isopropoxy, n-butoxy, isobutoxy, sec-butoxy, and tert-butoxy),

(3) C₁₋₄ alkylthio (for example, methylthio, ethylthio, n-propylthio, isopropylthio, n-butylthio, isobutylthio, sec-butylthio and tert-butylthio),

(4) halogen atoms (for example, fluorine, chlorine, bromine and iodide), and

(5) cyano. The number of the substituent(s) is 1 or 2.

Examples of a substituent of the vinylene group of X⁰ may be the same as those exemplified with respect to the methylene group of X⁰. The number of the substituent(s) is 1 or 2.

As X⁰, a chemical bond (a single bond or a bonding hand), a methylene group which may be substituted with 1 or 2 C₁₋₄ alkyls, and a vinylene group which may be substituted with 1 or 2 alkyls are particularly preferred. A chemical bond is particularly preferred.

Examples of the “heterocyclic group which may be substituted” of B⁰ may be the same as those exemplified with respect to the “heterocyclic group which may be substituted” of A⁰.

Preferred heterocyclic groups are thienyl, pyrazolyl, imidazolyl, thiazolyl, isothiazolyl, thiadiazolyl, pyridyl, pyridazinyl, pyrimidinyl, imidazopyridyl, and dioxaindanyl. Preferred substituents of the heterocyclic group are nitro, halogen, cyano, C₁₋₄ alkyl which may be substituted with 1-5 halogens, C₁₋₄ alkoxy, and C₁₋₄ alkylthio.

Examples of the “aryl group which may be substituted” of B⁰ may be the same as those exemplified with respect to the “aryl group which may be substituted” of A⁰. As the aryl group, a phenyl group is particularly preferred. As a substituent of the aryl group, the following are preferred: (1) halogen, (2) C₁₋₄ alkyl which may be substituted with 1-5 substituents selected from halogen, hydroxy, imino, hydroxyimino, C₁₋₄ alkoxyimino, hydrazono, mono- or di-C₁₋₄ alkylhydrazono and C₁₋₄ alkylthio, (3) C₂₋₄ alkynyl, (4) alkoxy which may be substituted with 1-5 substituents selected from halogen and C₁₋₄ alkoxy, (5) C₁₋₄ alkylthio, (6) C₁₋₄ alkylsulfinyl, (7) C₁₋₄ alkylsulfonyl, (8) C₁₋₄ alkyl-carbonyloxy, (9) C₁₋₄ alkoxy-carbonyl, (10) carboxyl, (11) cyano, (12) nitro, (13) nitroso, (14) formyl, (15) carbamoyl, (16) mono- or di-C₁₋₄ alkylcarbamoyl, (17) thiocarbamoyl, (18) hydroxy, (19) mono- or di-C₁₋₄ alkylsulfamoyl, (20) thiocyanate, (21) azoxycyano, and (22) amino.

The “hydrocarbon group” in the “hydrocarbon group which may be substituted” of Z⁰ may be:

(i) a C₁₋₆ alkyl group(for example, methyl, ethyl, n-propyl, isopropyl, n-butyl, isobutyl, sec-butyl, tert-butyl, n-pentyl, sec-pentyl, isopentyl, neopentyl, n-hexyl, or isohexyl),

(ii) a C₂₋₆ alkenyl group (for example, a straight chain C₂₋₆ alkenyl group such as vinyl, allyl, propenyl, isopropenyl, 1-butenyl, 2-butenyl or 3-butenyl, etc.; a branched C₂₋₆ alkenyl group such as 2-methyl-1-propenyl, 2-methyl-2-propenyl, 1-methyl-2-propenyl, 2-methyl-1-butenyl, 3methyl-1-butenyl, 1,2-dimethyl-2-propenyl, 1,1-dimethyl-1-propenyl, 1-methyl-2-butenyl, 3-methyl-2-butenyl, 2-methyl-2-butenyl, 1-methyl-3-butenyl, 1-ethyl-2-propenyl, 2-methyl-3-butenyl, 3-methyl-3-butenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-3-pentenyl, 1,1-dimethyl-2-butenyl, 1,2-dimethyl-2-butenyl, 1,3-dimethyl-2-butenyl, 2,3-dimethyl-2-butenyl, 1-methyl-3-pentenyl, 2-methyl-3-pentenyl, 3-methyl-3-pentenyl, 4-methyl-3-pentenyl, 1,1-dimethyl-3-butenyl, 1,2-dimethyl-3-butenyl, 1,3-dimethyl-3-butenyl, 2,2-dimethyl-3-butenyl, 2,3-dimethyl-3-butenyl, 1-methyl-4-pentenyl, 2-ethyl-1-butenyl, 2-ethyl-2-butenyl, 1-ethyl-1-butenyl, or 1-ethyl-2-butenyl, etc.),

(iii) a C₂₋₆ alkynyl group (for example, ethynyl, 1-propynyl, 2-propynyl, 1-butynyl, 2-butynyl or 3-butynyl),

(iv) a C₃₋₆ cycloalkyl group (for example, cyclopropyl, cyclobutyl, cyclopentyl, or cyclohexyl),

(v) a C₃₋₆ alkadienyl group (for example, 1,2-propadienyl, 1,2-butadienyl, 1,3-butadienyl, 3-methyl-1,2-dienyl, 1,2pentadienyl, 2,4-pentadienyl, 1-methyl-1,2-pentadienyl, or 1-methyl-1,3-pentadienyl), and

(vi) a C₆₋₁₄ aryl group (for example, naphthyl such as 1- naphthyl or 2-naphthyl).

In the case that the hydrocarbon group is the alkyl, alkenyl, alkynyl or alkadienyl group, a substituent of the hydrocarbon group may be the following:

(a) a halogen atom (for example, fluorine, chlorine, bromine or iodine),

(b) an amino group,

(c) a mono- or di-C₁₋₄ alkylamino group (for example, methylamino, ethylamino, dimethylamino or methylethylamino)

(d) a hydroxy group,

(e) a C₁₋₄ alkoxy group (for example, methoxy, ethoxy, n-propoxy, isopropoxy, n-butoxy, isobutoxy, sec-butoxy, or tert-butoxy) which may be substituted with 1-5 (preferably 1-3) halogens (for example, fluorine, chlorine, bromine and iodine),

(f) a mercapto group,

(g) a C₁₋₄ alkylthio group (for example, methylthio, ethylthio, n-propylthio, isopropylthio, n-butylthio, isobutylthio, sec-butylthio, or tert-butylthio),

(h) a C₁₋₄ alkylsulfinyl group (for example, methylsulfinyl, ethylsulfinyl, n-propylsulfinyl or isopropylsulfinyl),

(i) a C₁₋₄ alkylsulfonyl group (for example, methylsulfonyl, ethylsulfonyl, n-propylsulfoyl or isopropylsulfonyl),

(j) a cyano group,

(k) a C₁₋₄ alkoxy-carbonyl group (for example, methoxycarbonyl, ethoxycarbonyl, n-propoxycarbonyl, or isopropoxycarbonyl),

(l) a carbamoyl group, or

(n) a mono- or di-C₁₋₄ alkyl-carbamoyl group (for example, methylcarbamoyl, ethylcarbamoyl, n-propylcarbamoyl, dimethylcarbamoyl, ethylmethylcarbamoyl or diethylcarbamoyl). The number of the substituent(s) is from 1 to 5 (preferably from 1 to 3).

In the case that the hydrocarbon group is the cycloalkyl, or the aryl group, a substituent of the hydrocarbon group may be the following:

(a) a C₁₋₄ alkyl group (for example, methyl, ethyl, propyl, isopropyl, tert-butyl, chloromethyl or trifluoromethyl) which may be substituted with 1-5 (preferably 1-3) halogens (for example, fluorine, chlorine, bromine and iodine),

(b) a halogen atom (for example, fluorine, chlorine, bromine or iodine),

(c) an amino group,

(d) a mono- or di-C₁₋₄ alkylamino group (for example, methylamino, ethylamino, dimethylamino or methylethylamino)

(e) a hydroxy group,

(g) a C₁₋₄ alkoxy group (for example, methoxy, ethoxy, n-propoxy, isopropoxy, n-butoxy, isobutoxy, sec-butoxy, or tert-butoxy) which may be substituted with 1-5 (preferably 1-3) halogens (for example, fluorine, chlorine, bromine and iodine),

(g) a mercapto group,

(h) a C₁₋₄ alkylthio group (for example, methylthio, ethylthio, n-propylthio, isopropylthio, n-butylthio, isobutylthio, sec-butylthio, or tert-butylthio),

(i) a C₁₋₄ alkylsulfinyl group (for example, methylsulfinyl, ethylsulfinyl, n-propylsulfinyl or isopropylsulfinyl),

(j) a C₁₋₄ alkylsulfonyl group (for example, methylsulfonyl, ethylsulfonyl, n-propylsulfoyl or isopropylsulfonyl),

(k) a cyano group,

(l) a C₁₋₄ alkoxy-carbonyl group (for example, methoxycarbonyl, ethoxycarbonyl, n-propoxycarbonyl, or isopropoxycarbonyl),

(m) a carbamoyl group, and

(n) a mono- or di-C₁₋₄ alkyl-carbamoyl group (for example, methylcarbamoyl, ethylcarbamoyl, n-propylcarbamoyl, dimethylcarbamoyl, ethylmethylcarbamoyl or diethylcarbamoyl). The number of the substituent(s) is from 1 to 5, preferably from 1 to 3.

The “acyl group” in the “acyl group which may be substituted ” of Z⁰ may be the following:

(i) a C₁₋₄ alkyl-carbonyl group (for example, acetyl, propionyl, butylyl, or isobutylyl),

(ii) a C₁₋₄ alkoxy-carbonyl group (for example, methoxycarbonyl, ethoxycarbonyl, n-propoxycarbonyl, or isopropoxycarbonyl),

(iii) a C₁₋₄ alkylthio-carbonyl group (for example, (methylthio)carbonyl, (ethylthio)carbonyl, (n-propylthio)carbonyl, (isopropylthio)carbonyl, (n-butylthio)carbonyl, (isobutylthio)carbonyl, (sec-butylthio)carbonyl, or (tert-butylthio)carbonyl),

(iv) a C₁₋₄ alkoxy-thiocarbonyl group (for example, (methoxy)thiocarbonyl, (ethoxy)thiocarbonyl, (n-propoxy)thiocarbonyl, or (isopropoxy)thiocarbonyl),

(v) a C₁₋₄ alkylthio-thiocarbonyl group (for example, (methylthio)thiocarbonyl, (ethylthio)thiocarbonyl, (n-propylthio)thiocarbonyl, (isopropylthio)thiocarbonyl, (n-butylthio)thiocarbonyl, (isobutylthio)thiocarbonyl, (sec-butylthio)thiocarbonyl, or (tert-butylthio)thiocarbonyl, or

(vi) a mono- or di-C₁₋₄ alkyl-carbamoyl group (for example, methylcarbamoyl, ethylcarbamoyl, n-propylcarbamoyl, dimethylcarbamoyl, ethylmethylcarbamoyl, or diethylcarbamoyl).

(vii) a mono- or di-C₁₋₄ alkyl-thiocarbamoyl group (for example, (methyl)thiocarbamoyl, (ethyl)thiocarbamoyl, (n-propyl)thiocarbamoyl, (dimethyl)thiocarbamoyl, (ethylmethyl)thiocarbamoyl, or (diethyl)thiocarbamoyl.

As a substituent of the acyl group, a halogen (for example, fluorine, chlorine, bromine or iodine) is preferred. The number of the substituent(s) is from 1 to 5 (preferably from 1 to 3).

A substituent of the “amino group which may be substituted” of Z⁰ may be the following:

(a) C₁₋₄ alkyl (for example, methyl, ethyl, n-propyl, isopropyl, n-butyl, isobutyl, sec-butyl or tert-butyl),

(b) C₁₋₄ alkyl-carbonyl (for example, acetyl, propionyl, butylyl, or isobutylyl) which may be substituted with 1-5 (preferably 1-3) halogens (for example, fluorine, chlorine, bromine and iodine),

(c) C₁₋₄ alkoxy-carbonyl (for example, methoxycarbonyl, ethoxycarbonyl, n-propoxycarbonyl, or isopropoxycarbonyl),

(d) mono- or di-C₁₋₄ alkyl-carbamoyl group (for example, methylcarbamoyl, ethylcarbamoyl, n-propylcarbamoyl, dimethylcarbamoyl, ethylmethylcarbamoyl, or diethylcarbamoyl), and

(e) mono- or di-C₁₋₄ alkyl-thiocarbamoyl group (for example, (methyl)thiocarbamoyl, (ethyl)thiocarbamoyl, (n-propyl)thiocarbamoyl, (dimethyl)thiocarbamoyl, (ethylmethyl)thiocarbamoyl, or (diethyl)thiocarbamoyl. The number of the substituent(s) is 1 or 2.

Examples of the “hydrocarbon group which may be substituted” of R¹, R², R³ and R⁴ are the same as those exemplified with respect to the “hydrocarbon group which may be substituted” of Z⁰.

As the “hydrocarbon group which may be substituted” as R¹ and R², a C₁₋₄ alkyl group (for example, methyl, ethyl, n-propyl, isopropyl, n-butyl, isobutyl, sec-butyl or tert-butyl) is particularly preferred.

As the “hydrocarbon group which may be substituted” of R³, a C₁₋₄ alkyl group (for example, methyl, ethyl, n-propyl, isopropyl, n-butyl, isobutyl, sec-butyl or tert-butyl) which may be substituted with 1-5 (preferably 1-3) halogens (fluorine, chlorine, bromine and iodine) is particularly preferred.

As the “hydrocarbon group which may be substituted” of R⁴, (1) a C₁₋₄ alkyl group (for example, methyl, ethyl, n-propyl, isopropyl, n-butyl, isobutyl, sec-butyl or tert-butyl) which may be substituted with 1-5 (preferably 1-3) halogens (fluorine, chlorine, bromine and iodine) and (2) a C₆₋₁₄ aryl group which may be substituted with 1-5 (preferably 1-3) C₁₋₄ alkyls (for example, methyl, ethyl, n-propyl, isopropyl, n-butyl, isobutyl, sec-butyl and tert-butyl) are particularly preferred.

The cyclic amino group of Z⁰ may be a 3- to 6-membered cyclic amino group (for example, aziridino, azetidino, pyrrolidino, piperidino, morpholino, or thiomorpholino),

Examples of the “acyl group which may be substituted” of R³ are the same as those exemplified with respect to the “acyl group which may be substituted” of Z⁰. A C₁₋₄ alkyl-carbonyl group (for example, acetyl, propionyl, butylyl, or isobutylyl) which may be substituted with 1-5 (preferably 1-3) halogens (fluorine, chlorine, bromine and iodine) and a C₁₋₄ alkoxy-carbonyl group (for example, methoxycarbonyl, ethoxycarbonyl, n-propoxycarbonyl, or isopropoxycarbonyl) which may be substituted with 1-5 (preferably 1-3) halogens (fluorine, chlorine, bromine and iodine) are particularly preferred.

The “alkylsulfonyl” in “alkylsulfonyl group which may be substituted ” as R³ may be a C₁₋₄ alkylsulfonyl group such as methylsulfonyl, ethylsulfonyl, n-propylsulfonyl, or isopropylsulfonyl. As a substituent of the alkylsulfonyl group, a halogen (fluorine, chlorine, bromine or iodine) is preferred. The number of the substituent(s) is from 1 to 5 (preferably 1 to 3)

As Z⁰, the following among the above-mentioned groups are preferred:

(1) a C₁₋₆ alkyl group which may be substituted with 1-3 substituents selected from hydroxy, halogen, cyano, C₁₋₄ alkylthio, C₁₋₄ alkoxy, C₁₋₄ alkoxy-carbonyl, and mono- or di-C₁₋₄ alkylamino,

(2) a C₂₋₆ alkenyl group,

(3) a C₂₋₆alkynyl group which may be substituted with 1-3 halogens,

(4) a C₃₋₆ cycloalkyl group,

(5) a C₃₋₆ alkadienyl group,

(6) a phenyl group,

(7) a C₁₋₄ alkyl-carbonyl group which may be substituted with 1-3 halogens,

(8) an amino group which may be substituted with 1 or 2 substituents selected from C₁₋₄ alkyl, C₁₋₄ alkyl-carbonyl and C₁₋₄ alkoxycarbonyl,

(9) a group represented by —N═CR¹R² wherein R¹ and R² each independently represents a hydrogen atom or a C₁₋₄ alkyl group,

(10) a C₁₋₄ alkoxy group,

(11) a C₁₋₄ alkyl-carbonyloxy group,

(12) a C₁₋₄ alkylthio group which may be substituted with 1-5 halogens,

(13) a C₁₋₄ alkylsulfinyl group which may be substituted with 1-5 halogens,

(14) a C₁₋₄ alkylsulfonyl group, or

(15) a phenylsulfonyl group which may be substituted with 1-3 C₁₋₄ alkyls.

The salt of the compound (I⁰) is not limited to a specific one in so far as it is a salt acceptable in agricultural chemistry. In the case that the compound (I⁰) is basic, the salt may be a salt of an inorganic acid, such as hydrofluoric acid, hydrochloric acid, hydrobromic acid, phosphoric acid, sulfuric acid, nitric acid, or a perchloric acid; or a salt of an organic acid, such as formic acid, acetic acid, propionic acid, tartaric acid, malic acid, citric acid, oxalic acid, succinic acid, benzoic acid, picric acid, methanesulfonic acid, or p-toluenesulfonic acid. In the case that the compound (I⁰) is acidic, the above-mentioned salt may be a salt thereof with an alkali metal, such as lithium, sodium or potassium; a salt thereof with an alkali earth metal such as magnesium or calcium; an ammonium salt thereof, that is, a salt thereof with ammonia, methylamine, dimethylamine, trimethylamine, triethylamine, ethylenediamine, TMEDA (tetramethylethylenediamine), aniline, N,N-dimethylaniline, pyridine, lutidine, collidine, hydrazine or the like; or a salt thereof with urea, guanidine or the like.

Among the compounds (I⁰) or salts thereof, the following compound (I), compound (II), which include the compound (II′) described hereinafter unless otherwise stated, compound (III), compound (IV) and compound (V), or salts thereof are preferred.

[1] The compound (I) or the salt thereof is a compound represented by the following, or a salt:

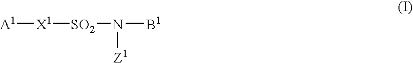

wherein A¹ represents (1) an aryl group which may be substituted or (2) a heterocyclic group which may be substituted,

X¹ represents (1) a chemical bond, (2) a methylene group which may be substituted, or (3) a vinylene group which may be substituted,

B¹ represents a 5-membered heterocyclic group other than an isoxazolyl group which may be substituted, or a condensed heterocyclic group which may be substituted, and

Z¹ represents (1) a hydrocarbon group which may be substituted, (2) an acyl group which may be substituted, (3) a formyl group, (4) an amino group which may be substituted, (5) a group represented by —N═CR¹R² wherein R¹ and R² each independently represents a hydrogen atom or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group, or an alkylsulfonyl group which may be substituted, (8) a group represented by —S(O)ₙR⁴ wherein n is an integer of 0 to 2, and R⁴ represents a hydrogen atom or a hydrocarbon group which may be substituted.

A substituent of each of A¹, X¹ and Z¹ is as defined with respect to the substituent of each of A⁰, X⁰ and Z⁰.

The 5-membered heterocyclic group in the “5-membered heterocyclic group which may be substituted” as B¹ may be, a 5-membered heterocyclic group, containing 1-4 (preferably 1-3) heteroatoms selected from nitrogen and sulfur atoms, wherein a ring-constituting atom other than carbon atoms is a nitrogen or sulfur atom, and is, for example, pyrrolyl (for example, 1-, 2- or 3-pyrrolyl), pyrazolyl (for example, 1-, 3-, 4- or 5-pyrazolyl), imidazolyl (for example, 1-, 2-, 4- or 5-imidazolyl), triazolyl (for example, 1,2,3-triazole-1-, 4- or 5-yl, or 1,2,4-triazole-1-, 3-, 4- or 5-yl), tetrazolyl (for example, tetrazole-1-, 2- or 5-yl), thienyl (for example, 2- or 3-thienyl), thiazolyl (for example, 2-, 4- or 5-thiazolyl), isothiazolyl (for example, 3-, 4- or 5-isothiazolyl), thiadiazolyl (for example, 1,2,3-thiadiazole-4- or 5-yl, 1,2,4-thiadiazole-3- or 5-yl, 1,2,5-thiadiazole-3-yl, or 1,3,4-thiadiazole-2-yl), or pyrrolidinyl (for example, 1-, 2- or 3-pyrrolidinyl). Thienyl, pyrrozolyl, isothiazolyl, imidazolyl, thiazolyl and thiadiazolyl are particularly preferred.

As a substituent of the 5-membered heterocyclic group, a substituent selected from the above-mentioned substituent group (T) is preferred. The number of the substituent(s) is from 1 to 5 (preferably from 1 to 3). As the substituent, halogen, nitro, cyano, C₁₋₄ alkyl which may be substituted with 1-5 halogens, C₁₋₄ alkoxy and C₁₋₄ alkylthio are preferred.

The “condensed heterocyclic group” in the “condensed heterocyclic group which may be substituted” of B¹ is preferably a condensed heterocyclic group composed of a 5- or 6-memebred heterocyclic ring and a benzene ring, or a 5- or 6-memebred heterocyclic ring and a 5- or 6-membered heterocyclic ring. Specific examples thereof include indolyl (for example, 3H-indole-2-, 3-, 4-, 5-, 6- or 7-yl), quinolyl (for example, 2-, 3-, 4-, 5-, 6-, 7- or 8-quinolyl), isoquinolyl, pyrido[2,3-d]pyrimidinyl (for example, pyrido[2,3-d]pyrimidine-2-yl), naphthilidinyl such as 1,5-, 1,6-, 1,7-, 1,8-, 2,6-, or 2,7-naphthilidinyl (for example, 1,5-naphthilidine-2- or 3-yl), thieno[2,3- d]pyridyl (for example, thieno[2,3-d]pyridine-3-yl), pyradinoquinolyl (for example, pyradino[2,3-d]quinolyl-2-yl), chromenyl (for example, 2H-chromene-2-, 3-, 4-, 5- or 6-yl), chromanyl (for example, 1-, 2-, 3-, 4-, 5-, 6-, 7- or 8-chromanyl), isochromanyl (for example, 1-, 3-, 4-, 5-, 6-, 7- or 8-isochromanyl), benzofuryl (for example, 2-, 3-, 4-, 5-, 6- or 7-benzofuryl), benzothienyl (for example, 2-, 3-, 4-, 5-, 6- or 7-benzothienyl), benzoimidazolyl (for example, 2-, 4-, 5-, 6- or 7-benzoimidazolyl), indazolyl (for example, 1H-indazole-1-, 3-, 4-, 5-, 6- or 7-yl), benzoxazolyl (for example, 2-, 4-, 5-, 6- or 7-benzoxazolyl), benzoisoxazolyl (for example, 3-, 4-, 5-, 6- or 7-benzoisoxazolyl), benzothiazolyl (for example, 2, 4-, 5-, 6- or 7-benzothiazolyl), benzothiadiazolyl (for example, benzo-1,2,3-thiadiazole-4-, 5-, 6- or 7-yl, benzo-1,2,4-thiadiazole-3-, 4-, 5-, 6- or 7-yl, benzo-1,2,5-thiadiazole-3-, 4-, 5-, 6- or 7-yl, or benzo-1,3,4thiadiazole-2-, 4-, 5-, 6- or 7-yl), benzoisothiazolyl (for example, 3-, 4-, 5-, 6- or 7-benzoisothiazolyl), benzotriazolyl (for example, 4-, 5-, 6-, 7- or 8-benzo-1,2,3-triazolyl, or 3-, 5-, 6-, 7- or 8-benzo-1,2,4-triazolyl), cinnolyl (for example, 3-, 4-, 5-, 6-, 7- or 8-cinnolyl), phthaladinyl (for example, 1-, 5- or 6-phthaladinyl), quinazolinyl (for example, 2-, 4-, 5-, 6-, 7- or 8-quinazolinyl), quinoxalinyl (for example, 2-, 5- or 6-quinoxalinyl), imidazopyridyl(for example, imidazo[1,2-a]pyridyl such as imidazo[1,2-a]pyridine-2-yl or imidazo[1,2-a]pyridine-3-yl), and imidazothiazolyl (for example, imidazo[2,1-b]thiazolyl such as imidazo[2,1-b]thiazole-5-yl), and dioxaindanyl (for example, 1,3dioxaindanyl such as 1,3-dioxaindane-2-, 4-, 5-, 6- or 7-yl).

As a substituent of the “condensed heterocyclic group”, any substituent selected from the above-mentioned substituent group (T) is preferred. The number of the substituent(s) is from 1 to 5 (preferably from 1 to 3). As the substituent, nitro is particularly preferred.

As the compound (I), preferred is the compound represented by the formula (I) wherein A¹ represents a C₆₋₁₄ aryl group which may be substituted with 1-3 C₁₋₄ alkyls,

X¹ represents a chemical bond,

B¹ represents a thienyl, pyrazolyl, isothiazolyl, imidazolyl, thiazolyl, thiadiazolyl, dioxaindanyl or imidazopyridyl group, which may be substituted with 1-5 substituents selected from C₁₋₄ alkyl, C₁₋₄ alkoxy, C₁₋₄ alkylthio, cyano, halogen and nitro, and

Z¹ represents a C₁₋₆ alkyl or C₁₋₄ alkoxy group; or a salt thereof.

More preferred embodiments of the compound (I) or the salt thereof are as follows.

(1) As A¹, phenyl which may be substituted with 1-3 C₁₋₄ alkyls is preferred, and 4-methylphenyl is particularly preferred.

(2) As B¹, preferred is (i) a thienyl, pyrazolyl, isothiazolyl, imidazolyl, thiazolyl, or thiadiazolyl group which may be substituted with 1-5 substituents selected from C₁₋₄ alkyl which may be substituted with 1-5 halogens, C₁₋₄ alkoxy, C₁₋₄ alkylthio, cyano, halogen and nitro, or (ii) a dioxaindanyl or imidazopyridyl group which may be substituted with 1-3 nitros.

As B¹, more preferred are:

(i) a thienyl group which may be substituted with 1-3 substituents selected from halogen and nitro,

(ii) a pyrazolyl group which may be substituted with 1-3 substituents selected from C₁₋₄ alkyl, nitro and cyano,

(iii) an imidazolyl group which may be substituted with 1-3 substituents selected from C₁₋₄ alkyl and nitro,

(iv) a thiazolyl group which may be substituted with 1-3 substituents selected from C₁₋₄ alkyl which may be substituted with 1-5 halogens, C₁₋₄ alkylthio, halogen, nitro and cyano,

(v) a thiadiazolyl group (preferably, a 1,3,4-thiadiazolyl group) which may be substituted with C₁₋₄ alkyl which may be substituted with 1-5 halogens,

(vi) an isothiazolyl group which may be substituted with 1-3 substituents selected from C₁₋₄ alkyl which may be substituted with 1-5 halogens, C₁₋₄ alkoxy, nitro and cyano,

(vii) a 1,3-dioxaindanyl group which may be substituted with 1-3 nitros, and

(viii) imidazo[1,2-a] pyridyl group which may be substituted with 1-3 nitros.

(3) As Z¹, a C₁₋₆ alkyl or C₁₋₄ alkoxy group is preferred.

(4) As X¹, a chemical bond (a single bond or a bonding hand) is preferred.

The above-mentioned preferred embodiments (1) to (4) of A¹, B¹, Z¹ and X¹ may be used in any combination thereof.

[2] The compound (II) or the salt thereof is a compound represented by the following formula (II) or a salt thereof:

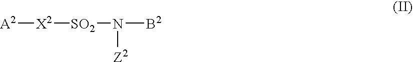

wherein A² represents (1) an aryl group which may be substituted with 1-5 substituents selected from the substituent group (T′), or (2) a heterocyclic group which may be substituted,

X² represents (1) a chemical bond, (2) a methylene group which may be substituted, or (3) a vinylene group which may be substituted,

B² represents an aryl group which may be substituted, and

Z² represents (1) an alkyl group which may be substituted with a substituent selected from mono- or di-C₁₋₆ alkylamino, hydroxy, halogen, C₁₋₆ alkoxy, C₁₋₆ alkoxy-carbonyl, C₁₋₆ alkylthio and cyano,

(2) a vinyl group,

(3) an allyl group,

(4) a propadienyl group,

(5) an alkynyl group which may be substituted,

(6) a cycloalkyl group which may be substituted,

(7) an aryl group which may be substituted,

(8) an acyl group which may be substituted,

(9) a formyl group,

(10) an amino group which may be substituted,

(11) a group represented by —N═CR¹R² wherein R¹ and R² each independently represents a hydrogen atom, or a hydrocarbon group which may be substituted,

(12) a cyclic amino group,

(13) a group represented by —OR³ wherein R³ represents a hydrogen atom, a hydrocarbon group which may be substituted, an acyl group which may be substituted, a formyl group, or an alkyl sulfonyl group which may be substituted, or

(14) a group represented by —S(O)ₙR⁴ wherein n is an integer of 0 to 2, and R⁴ represents a hydrogen atom, or a hydrocarbon group which may be substituted.

The aryl group as A² may be a C₆₋₁₄ aryl group such as phenyl or naphthyl (for example, 1-naphthyl or 2-naphthyl), etc. Phenyl is particularly preferred.

The heterocyclic group which may be substituted of A² is as defined with respect to the heterocyclic group which may be substituted of A⁰.

A substituent of X² is as defined with respect to the substituent of X⁰.

The aryl group which may be substituted of B² is as defined with respect to the aryl group which may be substituted of B⁰. As the aryl group, phenyl is particularly preferred.

The alkyl group in the “alkyl group which may be substituted with a substituent selected from mono- or di-C₁₋₄ alkylamino, hydroxy, halogen, C₁₋₆ alkoxy, C₁₋₆ alkoxycarbonyl, C₁₋₆ alkylthio and cyano” of Z² may be a C₁₋₆ alkyl group such as methyl, ethyl, n-propyl, isopropyl, n-butyl, isobutyl, sec-butyl, tert-butyl, n-pentyl, sec-pentyl, isopentyl, neopentyl, n-hexyl, or isohexyl, etc. The number of the substituent(s) of the alkyl group is from 1 to 5 (preferably from 1 to 3). The mono- or di-C₁₋₄ alkylamino as the substituent may be methylamino, ethylamino, n-propylamino, dimethylamino, ethylmethylamino, diethylamino, etc. Mono- or di-C₁₋₄ alkylamino is particularly preferred. The halogen as the substituent may be fluorine, chlorine, bromine, or iodine. The C₁₋₆ alkoxy may be methoxy, ethoxy, n-propoxy, isopropoxy, n-butoxy, isobutoxy, sec-butoxy, tert-butoxy, etc. C₁₋₄ alkoxy is particularly preferred. The C₁₋₆ alkoxy-carbonyl may be methoxycarbonyl, ethoxycarbonyl, n-propoxycarbonyl, isopropoxycarbonyl, etc. C₁₋₄ alkoxy-carbonyl is particularly preferred. The C₁₋₆ alkylthio may be methylthio, ethylthio, n-propylthio, ispropylthio, n-butylthio, isobutylthio, sec-butylthio, tert-butylthio, etc. C₁₋₄ alkylthio is particularly preferred.

The alkynyl in “alkynyl which may be substituted” of Z² may be a C₂₋₆ alkynyl group such as ethynyl, 1-propynyl, 2-propynyl, 1-butynyl, 2-butynyl, 3-butynyl, etc. The cycloalkyl in the “cycloalkyl which may be substituted” may be a C₃₋₆ cycloalkyl group such as cyclopropyl, cyclobutyl, cyclopentyl, cyclohexyl, etc. The aryl in the “aryl group which may be substituted” may be a C₆₋₁₄ aryl group such as phenyl or naphthyl (for example, 1-naphthyl or 2-naphthyl), etc. A substituent of the above-mentioned alkynyl, cycloalkyl or aryl group may be the same as those defined with respect to each of the alkynyl, cycloalkyl or aryl group of the hydrocarbon group in the “hydrocarbon group which may be substituted” of Z⁰. The number of the substituent(s) of the alkynyl, cycloalkyl or aryl group is from 1 to 5 (preferably from 1 to 3).

The “acyl group which may be substituted”, the “amino group which may be substituted”, the “group represented by —N═CR¹R²”, the “cyclic amino group”, the “group represented by —OR³”, and the “group represented by —S(O)ₙR⁴”, of Z², are as defined with respect to the “acyl group which may be substituted”, the “amino group which may be substituted”, the “group represented by —N═CR¹R² ”, the “cyclic amino group”, the “group represented by —OR³”, and the “group represented by —S(O)ₙR⁴”, of Z⁰, respectively.

As the compound (II), preferred is the compound represented by the formula (II) wherein:

A² represents (1) a C₆₋₁₄ aryl group which may be substituted with 1-5 substituents selected from:

(i) a C₁₋₄ alkyl group which may be substituted with 1-5 halogens,

(ii) a C₁₋₄ alkoxy group which may be substituted with 1-5 halogens,

(iii) an amino group which may be substituted with 1 or 2 C₁₋₄ alkyl-carbonyl,

(iv) a C₁₋₄ alkoxy-carbonyl group,

(v) a halogen atom,

(vi) a cyano group, and

(vii) a nitro group, or (2) a thienyl, triazolyl, imidazolyl, isoxazolyl, pyrazolyl, pyridyl, quinolyl, benzothiadiazolyl, imidazothiazolyl, or imidazopyridyl group, which may be substituted with 1-5 substituents selected from:

(i) a C₁₋₄ alkyl group,

(ii) a C₁₋₄ alkoxy-carbonyl group,

(iii) a carbamoyl group,

(iv) a mono- or di-C₁₋₄ alkylcarbamoyl group,

(v) a C₁₋₄ alkylsulfonyl group,

(vi) a halogen atom,

(vii) a carboxyl group, and

(viii) a cyano group,

X² represents (1) a chemical bond,

(2) a methylene group which may be substituted with 1 or 2 C₁₋₄ alkyls, or

(3) a vinylene group which may be substituted with 1 or 2 C₁₋₄ alkyls,

B² represents a C₆₋₁₄ aryl group which may be substituted with 1-5 substituents selected from:

(1) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio,

(2) a C₂₋₄ alkynyl group,

(3) a hydroxy group,

(4) a C₁₋₄ alkoxy group which may be substituted with 1-5 substituents selected from halogen and C₁₋₄ alkoxy,

(5) a C₁₋₄ alkyl-carbonyloxy group,

(6) a C₁₋₄ alkylthio group,

(7) a C₁₋₄ alkylsulfinyl group,

(8) a C₁₋₄ alkylsulfonyl group,

(9) a mono- or di-C₁₋₄ alkylsulfamoyl group,

(10) an amino group,

(11) a formyl group,

(12) a C₁₋₄ alkoxy-carbonyl group,

(13) a carbamoyl group,

(14) a mono- or di-C₁₋₄ alkylcarbamoyl group,

(15) a thiocarbamoyl group,

(16) a halogen atom,

(17) a carboxyl group,

(18) a thiocyanate group,

(19) a cyano group,

(20) a nitroso group, and

(21) a nitro group, and

Z² represents (1) a C₁₋₆ alkyl group which may be substituted with 1-5 substituents selected from mono- or di-C₁₋₄ alkylamino, hydroxy, halogen, C₁₋₄ alkoxy, C₁₋₄ alkoxy-carbonyl, C₁₋₄ alkylthio and cyano,

(2) a vinyl group,

(3) an allyl group,

(4) a propadienyl group,

(5) a C₂₋₆ alkynyl group which may be substituted with 1-5 halogens,

(6) a C₃₋₆ cycloalkyl group,

(7) a C₆₋₁₄ aryl group,

(8) a C₁₋₄ alkyl-carbonyl which may be substituted with 1-5 halogens,

(9) an amino group which may be substituted with 1 or 2 substituents selected from C₁₄ alkyl, C₁,₄ alkyl-carbonyl and C₁₋₄ alkoxy-carbonyl,

(10) a group represented by —N═CR¹R² wherein R1 and R² each independently represents a C₁₋₄ alkyl group,

(11) a group represented by —OR³ wherein R³ represents a C₁₋₄ alkyl group or a C₁₋₄ alkyl-carbonyl group, or

(12) a group represented by —S(O)ₙR⁴ wherein n is an integer of 0 to 2, and R⁴ represents (a) a C₁₋₄ alkyl group which may be substituted with 1-5 halogens, or (b) a C₆₋₁₄ aryl group which may be substituted with 1-5 C₁₋₄ alkyls; or a salt thereof.

More preferred embodiments of the compound (II) or a salt thereof are as follows.

(1) A² is preferably (a) a phenyl group which may be substituted with 1-3 substituents selected from C₁₋₄ alkyl which may be substituted with 1-3 halogens, halogen, nitro, cyano, acetylamino, C₁₋₄ alkoxy which may be substituted with 1-3 halogens, and C₁₋₄ alkoxy-carbonyl,

(b) a naphthyl group,

(c) an isoxazolyl group which may be substituted with 1-3 C₁₋₄ alkyls,

(d) a triazolyl group which may be substituted with 1-3 mono- or di-C₁₋₄ carbamoyls,

(e) a pyridyl group,

(f) a quinolyl group,

(g) a thienyl group which may be substituted with 1-3 substituents selected from C₁₋₄ alkyl and halogen,

(h) a pyrazolyl group which may be substituted with 1-3 substituents selected from C₁₋₄ alkyl, C₁₋₄ alkoxy-carbonyl, carboxyl, carbamoyl, cyano and halogen,

(i) an imidazyolyl group which may be substituted 1-3 C₁₋₄ alkyls,

(j) a benzothiadiazolyl (preferably, a 2,1,3-benzothiadiazolyl group),

(k) an imidazothiazolyl group (preferably an imidazo[2,1-b]thiazolyl group) which may be substituted with 1-3 halogens, or

(l) an imidazopyridyl group (preferably, an imidazo[1,2a]pyridyl group) which may be substituted with 1-3 substituents selected from halogen and C₁₋₄ alkylsulfonyl. More preferred are phenyl and thienyl groups which may be substituted with 1-3 substituents selected from C₁₋₄ alkyl, C₁₋₄ alkoxy, halogen and cyano. A phenyl group which may be substituted with 1-3 substituents selected from C₁₋₄ alkyl and halogen is preferred, and a phenyl group substituted, at its 4-position, with a methyl group or a chlorine atom is particularly preferred.

(2) B² is preferably a phenyl group substituted, at its 2- or 4-position, with a substituent selected from:

(a) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio,

(b) a C2-4 alkynyl group,

(c) a hydroxy group,

(d) a C₁₋₄ alkoxy group which may be substituted with 1-5 substituents selected from halogen and C₁₋₄ alkoxy,

(e) a C₁₋₄ alkyl-carbonyloxy group,

(f) a C₁₋₄ alkylthio group,

(g) a C₁₋₄ alkylsulfinyl group,

(h) a C₁₋₄ alkylsulfonyl group,

(i) a mono- or di-C₁₋₄ alkylsulfamoyl group,

(j) a formyl group,

(k) a C₁₋₄ alkoxy-carbonyl group,

(l) a carbamoyl group,

(m) a mono- or di-C₁₋₄ alkylcarbamoyl group,

(n) a thiocarbamoyl group,

(o) a halogen atom,

(p) a carboxyl group,

(q) a thiocyanate group,

(r) a cyano group,

(s) a nitroso group, and

(t) a nitro group.

As B², a group represented by the following is particularly preferred:

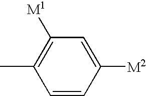

wherein M¹ represents a nitro group, a cyano group, a trifluoromethyl group, or a thiocarbamoyl group, and M² represents a halogen atom, a cyano group, a nitro group, or a trifluoromethyl group.

(3) Z² is preferably (a) a C₁₋₆ alkyl group which may be substituted with 1-5 substituents selected from mono- or di-C₁₋₄ alkylamino, hydroxy, halogen, C₁₋₄ alkoxy, C₁₋₄ alkoxy-carbonyl, C₁₋₄ alkylthio, and cyano,

(b) a vinyl group,

(c) an allyl group,

(d) a propadienyl group,

(e) a C₂₋₆ alkyl group which may be substituted with 1-5 halogens,

(f) a C₃₋₆ cycloalkyl group, or

(g) a C₁₋₄ alkoxy group. Particularly preferred are a C₁₋₆ alkyl group, a C₃₋₆ cycloalkyl group, a vinyl group, an allyl group, a C₂₋₆ alkynyl group, or a C₁₋₄ alkoxy group.

(4) X² is preferably a chemical bond (a single bond or a bonding hand).

The above-mentioned preferred embodiments (1) to (4) of A², B², Z² and X² may be used in any combination.

As another preferred embodiment of the compound (II) or a salt thereof is as follows.

A² represents a phenyl group which may be substituted with 1-3 substituents selected from C¹⁻⁴ alkyl, halogen and cyano,

X² represents a chemical bond,

B² represents a phenyl group which may be substituted with 1-5 substituents selected from (1) a C₁₋₄ alkyl group which may be substituted with 1-3 halogens,

(2) a C₁₋₄ alkoxy group,

(3) a C₁₋₄ alkylthio group,

(4) a thiocarbonyl group,

(5) a halogen atom,

(6) a cyano group, and

(7) a nitro group, and

Z² represents (1) a C₁₋₆ alkyl group which may be substituted with 1-3 C₁₋₄ alkoxy groups, (2) a C₃₋₆ cycloalkyl group, (3) an allyl group, or (4) a C₁₋₄ alkoxy.

[3] The compound (III) or a salt thereof is a compound represented by the following formula (III), or a salt thereof:

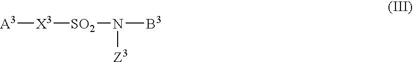

wherein A³ represents (1) an aryl group which may be substituted or (2) a heterocyclic group which may be substituted,

X³ represents (1) a chemical bond, (2) a methylene group which may be substituted, or (3) a vinylene group which may be substituted,

B³ represents a 6-memebred heterocyclic group having a substituent, and

Z³ represents (1) a hydrocarbon group which may be substituted, (2) an acyl group which may be substituted, (3) a formyl group, (4) an amino group which may be substituted, (5) a group represented by —N═NCR¹R² wherein R1 and R² each independently represents a hydrogen atom or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group or a sulfonyl group which may be substituted, or (8) a group represented by —S(O)ₙR⁴ wherein n is an integer of 0 to 2, and R⁴ represents a hydrogen atom, or a hydrocarbon group which may be substituted.

A³, X³ and Z³ are as defined with respect to A⁰, X⁰ and Z⁰, respectively.

The “6-membered heterocyclic group” in the “6-membered heterocyclic group having a substituent” of B³ may be a 6-membered heterocyclic group containing 1-4 heteroatoms selected from nitrogen, oxygen and sulfur atoms. Specific examples thereof include pyridyl (for example, 2-, 3-, or 4-pyridyl), pyridazinyl (for example, 3- or 4-pyridazinyl), pyrimidinyl (for example, 2-, 4- or 5-pyrimidinyl), pyrazinyl, pyperidinyl (for example, 1-, 2-, 3- or 4-pyperidinyl), and pyperadinyl (for example, 1- or 2-pyperadinyl) or the like.

Among these 6-membered heterocyclic groups, pyridyl, pyridazinyl, and pyrimidinyl are particularly preferred.

A substituent of the 6-membered heterocyclic group is preferably any substituent included in the above-mentioned substituent group (T). The number of the substituent(s) is from 1 to 5 (preferably from 1 to 3).

As the compound (III), preferred is a compound represented by the formula (III) wherein:

A³ represents a phenyl group which may be substituted with 1-5 C₁₋₄ alkyls, or an imidazolyl group which may be substituted with 1 or 2 C₁₋₄ alkyls,

X³ represents a chemical bond,

B³ represents a pyridyl, pyridazinyl, or pyrimidinyl group which may be substituted with 1-5 substituents selected from C₁₋₄ alkyl, C₁₋₄ alkoxy, halogen, nitro and cyano, and

Z³ represents a C₁₋₆ alkyl group, or a C₃₋₆ cycloalkyl group.

As A³, a phenyl group which may be substituted with 1-5 C₁₋₄ alkyls is more preferred. Furthermore, a 4-methylphenykl group is still more preferred.

[4] The compound (IV) or the salt thereof is a compound represented by the following formula (IV), or a salt thereof:

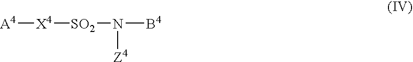

wherein A⁴ represents (1) an aryl group which may be substituted or (2) a heterocyclic group which may be substituted,

X⁴ represents (1) a chemical bond, (2) a methylene group which may be substituted, or a vinylene group which may be substituted,

B⁴ represents a pyridazinyl group or a pyrazinyl group, and

Z⁴ represents (1) a hydrocarbon which may be substituted, (2) an acyl group which may be substituted,

(3) a formyl group, (4) an amino group which may be substituted, (5) a group represented by —N═CR¹R² wherein R1 and R² each independently represents a hydrogen atom, or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group, or a sulfonyl group which may be substituted, or (8) a group represented by —S(O)ₙR⁴ wherein n is an integer of 0 to 2, and R⁴ represents a hydrogen atom, or a hydrocarbon group which may be substituted.

A⁴, X⁴ and Z⁴ are as defined with respect to A⁰, X⁰ and Z⁰, respectively.

[5] The compound (V) or the salt thereof is a compound represented by the following formula (V), or a salt thereof:

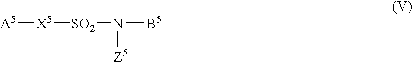

wherein A⁵ represents a 4-methylphenyl group,

X⁵ represents a chemical bond (a single bond or a bonding hand),

B⁵ represents a pyridyl group or a pyrimidinyl group, and

Z⁵ represents a C₁₋₄ alkyl group (for example, methyl, ethyl, n-propyl or isopropyl).

Among the above-mentioned compounds (I) to (V), the compounds (I) to (III) or salts thereof are preferred. The compound (II) or a salt thereof is particularly preferred.

Among the above-mentioned compound (I⁰) or a salt thereof, a compound (VI) represented by the following formula (VI) or a salt thereof is a novel compound, and is particularly preferably used. The compound (VI) or a salt thereof is included in the compound (II) or a salt thereof.

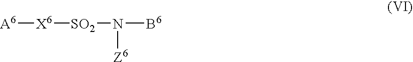

wherein A⁶ represents a phenyl group which may be substituted with a substituent selected from C₁₋₄ alkyl (for example, methyl, ethyl, n-propyl or isopropyl), halogen (for example, fluorine, chlorine, bromine, iodine) and cyano, X⁶ represents a chemical bond (a single bond or a bonding hand), B⁶ represents a 2-nitrophenyl group (or a 6-nitrophenyl group) substituted with a substituent selected from halogen (for example, fluorine, chlorine, bromine, iodine), nitro and cyano, and Z⁶ represents an ethyl group, an isopropyl group, or a cyclopropyl group.

The number of the substituent(s) of the phenyl group as A⁶ is from 1 to 3. As the substituent, methyl and a chlorine atom are particularly preferred. The substituent of the phenyl group is preferably positioned at the 4-position thereof.

The number of the substituent(s) of the 2-nitrophenyl group as B⁶ is from 1 to 3. As the substituent, halogen and cyano are particularly preferred. This substituent is preferably positioned at the 4-position of the 2-nitrophenyl group (or the 6-nitrophenyl group).

The above-mentioned compound (I⁰), (I), (II), (III), (IV), (V) or (VI), or a salt thereof (which may be referred to as the “compound (I⁰) or a salt thereof” hereinafter) can be produced by the process described in, for example, JP 2001-26506A.

For example, the compound (I⁰) or a salt thereof can be obtained by reacting a compound represented by the formula (VII):

A⁰—X⁰—SO₂—L

wherein A⁰ and X⁰ are as defined above, and L represents a leaving group, with a compound represented by the formula (VIII):

H₂N—B⁰

wherein B⁰ is as defined above, or a salt thereof, or reacting a compound represented by the formula (IX):

A⁰—X⁰—SO₂—NH₂

wherein A⁰ and X⁰ are as defined above, or a salt thereof, with a compound represented by the formula (X):

L′—B⁰

wherein L′ represents a leaving group, and B⁰ is as defined above, and then reacting the resultant compound or a salt thereof with a compound represented by the formula (XI):

Z⁰—L″

wherein L″ represents a leaving group, and Z⁰ is as defined above.

In the present invention, the compound (I⁰) or a salt thereof is used in combination with a different agricultural chemical active ingredient such as an insecticide, an acaricide, a nematicide, a herbicide, a plant hormone drug, a plant growth adjuster, a bactericide, a synergist, an attractant, a repellent, a dye, a fertilizer, etc. The different agricultural chemical active ingredient may be incorporated into a single composition comprising the compound (I⁰) or a salt thereof. Alternatively, the different agricultural chemical active ingredient may be separately formulated into an independent different composition, and subsequently the different compositions may be used in combination with the compound (I⁰) or the salt thereof upon use.

Typical examples of the insecticide, the acaricide, and the nematicide which can be combined with the compound (I⁰) or the salt thereof so as to be used are as follows: acequinocyl (3-dodecy-1,4-dihydro-1,4-dioxo-2-naphthyl acetate), acetoprole ((RS)-1-[5-amino-1-(2,6-dichloro-α,α,α-trifluoro-p-tolyl)-4-(methylsulfinyl)pyrazol-3-yl]ethanone), bistrifluron (1-[2-chloro-3,5-bis(trifluoromethyl)phenyl]-3-(2,6-difluorobenzoyl)urea), cybutryne (N2-tert-buty-N4-cyclopropyl-6-metholthio-1,3,5triazine-2,4-diamine), dinotefuran ((RS)-1-methyl-2-nitro3-(tetrahydro-3-furylmethyl)guanidine), ethiprole (5-amino1-(2,6-dichloro-α,α,α-trifluoro-p-tolyl)-4-ethylsulfinylpyrazole-3-carbonitrile), fluacrypyrim (NA-83, methyl(E)-2-{α-[2-isopropoxy-6-(trifluoromethyl) pyrimidine-4-yloxy]-o-tolyl}-3-methoxyacrylate), flunicoamid (IKI-220), indoxacarb (methyl (S)-N-[7-chloro-2,3,4a,5-tetrahydro-4a-(methoxycarbonyl)indeno[1,2-e][1,3,4]oxadiazine-2-ylcarbonyl]-4′-(trifluoromethoxy carbanilate or methyl (S)-7-chloro-2,3,4a,5-tetrahydro-2-[methoxycarbonyl(4-trifluoromethoxyphenyl)carbamoyl]indeno[1,2-e][1,3,4]oxadiazine-4a-carboxylate), spinosad (a mixture of 50-90% of (2R,3aS,5aR,5bS,9S,13S,14R,16aS,16bR)-2-(6-deoxy-2,3,4-tri-O-methol-α-L-mannopyranosyloxy)-13-(4-dimethylamino-2,3,4,6-tetradeoxy-β-D-erythropyranosyloxy)-9-ethyl-2,3,3a,5a,5b,6,7,9,10,11,12,13,14,15,16a,16b-hexadecahydro-14-methyl-1H-8-oxacyclododeca[b]as-indacene7,15-dione and 50-5% of (2S,3aR,5aS,5bS,9S,13S,14R,16aS,16bR)-2-(6-deoxy)-2,3,4tri-O-methyl-α-L-mannopyranosyloxy)13-(4-dimethylamino-2,3,4,6-tetradeoxy-β-D-erythropyranosyloxy)-9-ethyl-2,3,3a,5a,5b,6,7,9,10,11,12,13,14,15,16a,16b-hexadecahydro-4,14-dimethyl-1H-8-oxacylododeca[b]as-indacene-7,15-dione), spirodiclofen (3-(2,4-dichlorophenyl)-2-oxo-1-oxaspiro[4.5]dec-3-en-4-yl-2,2-dimethylbutyrate).

Typical examples of the bactericide which can be used in combination with the compound (I⁰) or a salt thereof are as follows:

bethoxazin (3-benzo[b]thien-2-yl-5,6-dihydro-1,4,2oxathiazine 4-oxide), BJL994, carbendazim, cyflupheamide (NF-149), epoxiconazole ((2RS,3SR)-1-[3-(2-chlorophenyl)-2,3-epoxy-2-(4-fluorophenyl)propyl]-1H-1,2,4-triazole), ethaboxam ((RS)-N-(α-cyano-2-thienyl)-4-ethyl-2-(ethylamino)-1,3-thiazole-5-carboxamide), fenamidone ((S)1-anilino-4-methyl-2-methylthio-4-phenylimidazolin-5-one), fenpropimorph, flusilazole, fuberidazole, iprovalicarb (isopropyl 2-methyl-1-[(1-p-tolylethyl)carbamoyl]-(S)-p-ropylcarbamate), picoxystrobin (methyl (E)-3-mthoxy-2-{2-[6-(trifluoromethyl)-2-pyridyloxymethyl]phenyl}acrylate), pyraclostrobin (methyl N-{2-[1-(4-chlorophenyl)-1-H-pyrazol-3-yloxymethyl]phenyl}(N-methoxy)carbamate), simeconazole ((RS)-2-(4-fluorophenyl)-1-(1H-1,2,4-triazole-1-yl)-3-(trimethylsilyl)propan-2-ol), spiroxamine (8-tert-butyl-1,4-dioxaspiro[4.5]decan-2-ylmethyl(ethyl)(propyl)amine), trifloxystrobin (methyl-(E)-methoxyimino-{(E)-α-[1-(α,α,α-trifluoro-m-tolyl)ethylideneaminooxy]-o-tolyl}acetate), zoxamide ((RS)-3,5-dichloro-N-(3-chloro-1-ethyl-1-methyl-2oxapropyl)-p-toluamide).

Typical examples of the herbicide, the plant hormone drug, and the plant growth adjuster which can be combined with the compound (I⁰) or the salt thereof so as to be used are as follows:

amicarbazone (4-amino-N-tert-butyl-4,5-dihydro-3-isopropyl-5-oxo-1H-1,2,4-triazole-1-carboxamide), beflubutamid (N-benzyl-2-(α,α,α,4-tetrafluoro-m-tolyloxy) butyramide, benzobicyclon (3-(2-chloro-4-mesylbenzoyl)-2-phenylthiobicyclo[3.2.1]oct-2-en-4-one, cinidon-ethyl (ethyl 2-chloro-3-[2-chloro-5-(cyclohex-1-ene-1,2-dicarboximido)phenyl] acrylate), dimethenamid-P ((S)-2-chloro-N-(2,4-dimethyl-3-thienyl)-N-(2-methyoxy-1-methylethyl) acetamide), epocholeone (22,23-epoxy-6-oxo-7-oxa-6(7a)-homo-5α-stigmastane-2α,3α-diyl dipropionate), fluazolate (isopropyl 5-[4-bromo-1-methyl-5-(trifluromethyl)pyrazol-3-yl]-2-chloro-4-fluorobenzoate), flucarbazone (4,5-dihydro-3-methoxy-4-4-methyl-5-oxo-N-[2-(trifluoromethoxy)phenylsulfonyl]-1H-1,2,4-triazole-1-carboxamide), flufenacet (4′-fluoro-N-isopropyl-2-[5-(trifluoromethyl)-1,3,4-thiadiazol-2-yloxy]acetanilide, flufenpyr (2-chloro-5-[1,6-dihydro-5-methyl-6-oxo-4-(trifluoromethyl)pyridazine-1-yl]-4-fluorophenoxyacetic acid), foramsulfuron (1-(4,6-dimethoxypyrimidine-2-yl)-3- [2-(dimethylcarbamoyl)-5-foramidophenylsulfonyl]urea, imazapic ((RS)-2-(4-isopropyl-4-methyl-5-oxo-2-imidazoline-2-yl)-5-methylnicotinic acid, indosulfuron (4-iodo-2-[3-(4methoxy-6-methyl-1,3,5-triazine-2-yl)ureidosulfonyl]benzoic acid), isoxachlortole (4-chloro-2-mesylphenyl 5-cyclopropyl-1,2-oxazol-4-yl ketone), isoxadifen (4,5-dihydro-5,5-diphenyl-1,2-oxazole-3-carboxylic acid), mesosulfuron (2-[(4,6-dimethoxypyrimidine-2-ylcarbamoyl)sulfamoyl]-α-(methanesulfoamido)-p-toluic acid), mesotrinone (2-(4-mesyl-2-nitrobenzoyl)cyclohexane-1,3dione), penoxsulam (3-(2,2)-difluoroethoxy)-N-(5,8-dimethoxy[1,2,4]triazolo[1,5-c ]pyrimidine-2-yl)-α,α,α-trifluorotoluene-2-sulfonamide, picolinafen (4′-fluoro-6-(α,α,α-trifluoro-m-tolyloxy)pyridine-2-carboxanilide), profluazol (1,2′-dichloro-4′-fluoro-5′-[(6S,7aR)-6-fluoro-2,3,5,6,7,7a-hexahydro-1,3-dioxo-1H-pyrrolo[1,2-c]imidazol-2-yl]methanesulfoanilide), profoxydim (2-{(EZ)-1-[(2RS)-2-(4-chlorophenoxy)propoxyimino]butyl}-3-hydroxy-5-(thian-3-yl)cyclohex-2-en-1-one), prohydrojasmon (propyl(1RS,2RS)-(3-oxo-2-pentylcyclopentyl) acetate containing 10 2% propyl(1RS,2SR)-oxo-2-pentylcyclopentyl) acetate, propoxycarbazone (methyl 2-(4,5-dihydro-4-methyl-5-oxo-3-propoxy-1H-1,2,4-triazol-1-yl)carboxamidosulfonylbenzoate), pyraclonil (1-(3-chloro-4,5,6,7-tetrahydropyrazolo[1,5-a]pyridine-2-yl)-5-[methyl(prop-2-ynyl)amino]pyrazole-4carbonitrile, pyribenzoxium (benzopheno O-[2,6-bis(4,6-dimethoxypyridine-2-yloxy)benzoyl]oxime), pyridafol (6-chloro-3-phenylpyridazine-4-ol), pyriftalid (CGA279233), tepraloxydim ((EZ)-(RS)-2-{1-[(2E)-3-chloroallyloxyimino]propyl}-3-hydroxy-5-perhydropyran-4-ylcyclohex-2-en-1-one), and trifloxysulfuron (CGA29223).

Among the above-mentioned “different agricultural chemical active ingredients”, the bactericide active component and insecticide active component are preferred.

As the above-mentioned bactericide active component, preferred are carbendazim, epoxiconazole, fenpropimorph, flusilazole, fuberidazole, picoxystrobin, pyraclostrobin, and trifloxystrobin as a soil-treating agent or a seed-treating agent for wheat; epoxiconazole, flusilazole, picoxystrobin, pyraclostrobin, and trifloxystrobin as dusting powder for stalks and leaves of wheat; BJL994, iprovalicarb, picoxystrobin, pyraclostrobin, and trifloxystrobin as dusting powder for stalks and leaves of fruit trees and vegetables; and so on.

Preferred embodiments of the composition comprising the compound (I⁰) of the present invention or a salt thereof and a different agricultural chemical active ingredient are as follows:

[1] a microbiocidal agent for agriculture and horticulture which comprises the compound (I) or a salt thereof, and a different agricultural chemical active ingredient,

[2] a microbiocidal agent for agriculture and horticulture which comprises the compound (II) or a salt thereof, and a different agricultural chemical active ingredient,

[3] a microbiocidal agent for agriculture and horticulture which comprises the compound (III) or a salt thereof, and a different agricultural chemical active ingredient,

[4] a microbiocidal agent for agriculture and horticulture which comprises the compound (IV) or a salt thereof, and a different agricultural chemical component agent,

[5] a microbiocidal agent for agriculture and horticulture which comprises the compound (V) or a salt thereof, and a different agricultural chemical active ingredient,

[6] a microbiocidal agent for agriculture and horticulture which comprises the compound (VI) or a salt thereof, and a different agricultural chemical active ingredient,

[7] the microbiocidal agent for agriculture and horticulture according to any one of the above-mentioned [1] to [6], wherein the different agricultural chemical active ingredient is an insecticidal component,

[8] the microbiocidal agent for agriculture and horticulture according to any one of the above-mentioned [1] to [6], wherein the different agricultural chemical active ingredient is an antibacterial component, and

[9] the microbiocidal agent for agriculture and horticulture according to the above-mentioned [8], wherein the antibacterial component is at least one selected from epoxiconazole, flusilazole, picoxystrobin, pyraclostrobin, trifloxystrobin, and iprovalicarb.

Among the above-mentioned compound (I), (II), (III), (IV), (V) or (VI), or a salt thereof, the compound (I), (II), (III), or (VI), or a salt thereof is preferred. The compound (II), (II′) or (VI), or a salt thereof is particularly preferred.

Specifically, the following are preferred: 4′-chloro-N-ethyl-2′-nitro-p-toluenesulfonanilide, 2′,4′-dinitro-N-ethyl-p-toluenesulfonanilide, 2′,4′-dicyano-N-ethyl-p-toluenesulfonanilide, 4′-chloro-N-isopropyl-2′-nitro-p-toluenesulfonanilide, 4′-fluoro-N-isopropyl-2′-nitro-p-toluenesulfonanilide, 4′-cyano-N-isopropyl-2′-nitro-p-toluenesulfonanilide, 4′-chloro-N-isopropyl-2′-nitro-p-toluenesulfonanilide, 2′,4′-dinitro-N-isopropyl-p-toluenesulfonanilide, 4′-nitro-N-isopropyl-2′-cyano-p-toluenesulfonanilide, 2′-cyano-N-methoxy-4′-nitro-p-toluenesulfonanilide, or 2′,4′-dinitro-N-methoxy-p-toluenesulfonanilide, or a salt thereof.

These compositions may contain one or more (preferably one to three) the above different agricultural chemical active ingredients such as the insecticide active component, the acaricide active component and the bactericide active component. Examples thereof include a composition comprising the compound (I⁰) [for example, the compound (I), (II), (III), (IV), (V) or (VI)] or a salt thereof, epoxiconazole, and pyraclostrobin; and a composition comprising the compound (I⁰) [for example, the compound (I), (II), (III), (IV), (V) or (VI)] or a salt thereof, fenpropimorph, epoxiconazole, and pyraclostrobin.

More preferred embodiments of the composition comprising the different agricultural chemical active ingredient are:

(i) a microbiocidal composition for agriculture and horticulture which comprises 4′-chloro-N-ethyl-2′-nitro-p-toluenesulfonanilide or a salt thereof, and epoxiconazole.

(ii) a microbiocidal composition for agriculture and horticulture which comprises 4′-chloro-N-ethyl-2′-nitro-p-toluenesulfonanilide or a salt thereof, and flusilazole.

(iii) a microbiocidal composition for agriculture and horticulture which comprises 4′-chloro-N-ethyl-2′-nitro-p-toluenesulfonanilide or a salt thereof, and picoxystrobin.

(iv) a microbiocidal composition for agriculture and horticulture which comprises 4′-chloro-N-ethyl-2′-nitro-p-toluenesulfonanilide or a salt thereof, and pyraclostrobin.

(v) a microbiocidal composition for agriculture and horticulture which comprises 4′-chloro-N-ethyl-2′-nitro-p-toluenesulfonanilide or a salt thereof, and trifloxystrobin.

(vi) a microbiocidal composition for agriculture and horticulture which comprises 4′-chloro-N-ethyl-2′-nitro-p-toluenesulfonanilide or a salt thereof, and iprovalicarb.

The blended agricultural chemical composition comprising the compound (I⁰) or a salt thereof, and a different agricultural chemical active ingredient can be used in a conventional preparation form. That is, one or more (preferably one to three) of the compounds (I⁰) and salts thereof, and one or more (preferably one to three) different agricultural chemical active ingredients, as effective components, are mixed with or dispersed in an appropriate liquid carrier, or are mixed with or adsorbed on an appropriate solid carrier, dependently on a particular use thereof. The resultant formulation can be used in the form of, for example, an emulsion, oily agent, aqueous suspension, liquid agent, ULV agent, hydrating agent, powdered agent, DL (driftless) powdered agent, granular agent, fine granular agent, fine granular agent F, flowable agent, dry flowable agent, tablet, jumbo agent, spray, ointment, paste, foam agent, aerosol, microcapsule, coating agent for seeds, smoking agent, or stick agent for irrigating crops. If necessary, the following may be added to the formulation: an emulsifying agent, suspending agent, spreading agent, penetrating agent, wetting agent, dispersing agent, viscous liquid agent, stabilizing agent, binder, fluidization auxiliary, solidification inhibitor, flocculating agent, antioxidant, floating agent, antifoaming agent, antifreezing agent, antiseptic, water-removing agent, ultraviolet absorber, ultraviolet scattering agent, coloring agent, suspension stabilizing agent, or the like. The formulation can be prepared by any per se known method. That is, the formulation can be prepared by mixing the compound (I⁰) or a salt thereof, a liquid carrier or a solid carrier, and optionally the above-mentioned various additives, and a different agricultural chemical agent component, homogeneously.

An emulsion may be produced by mixing and dissolving the effective components, an emulsifying agent, an organic solvent and so on homogeneously. A granular agent or granular hydrating agent may be produced by mixing the compound (I⁰) or a salt thereof, a dispersing agent (surfactant), a binder, a bulking agent (or the solid carrier) and so on homogeneously and then granulizing the mixture. A powdered agent (such as a DL powdered agent) may be produced by mixing and pulverizing the effective components, a bulking agent (or a solid carrier) and so on homogeneously. A flowable agent may be produced by mixing and dispersing the effective components, a dispersing. agent and so on in a mixer and then pulverizing the mixture in a wet manner using a dynomill. A jumbo agent may be produced by mixing the effective components, a dispersing agent (surfactant), a binder, a floating agent, a bulking agent (or a solid carrier) and so on homogeneously and then granulating the mixture.

When a jumbo agent, a granular agent, a granular hydrating agent, a hydrating agent or the like is scattered, a unit made of 20 to 200 g of the agent may be wrapped with a water-soluble film. The unit may be used for convenience. The water-soluble film may be a film made of polyvinyl alcohol, carboxymethylcellulose, starch, gelatin, polyvinyl pyrrolidone, polyacrylic acid, or a salt thereof, Pluran (trade name, starch type polysaccharide), Paogen (trade name, thermoplastic water-soluble polymer) or the like.

Examples of a suitable liquid carrier (solvent) to be used include water; alcohols such as methanol, ethanol, propanol, isopropanol, ethylene glycol, etc.; ketones such as acetone, methyl ethyl ketone, etc.; ethers such as 1,4-dioxane, tetrahydrofuran, ethylene glycol monomethyl ether, diethylene glycol monomethyl ether, propylene glycol monomethyl ether, etc.; aliphatic hydrocarbons such as kerosene, lamp oil, fuel oil, machine oil, edible oil, etc.; aromatic hydrocarbons such as benzene, toluene, xylene, solvent naphtha, methylnaphthalene, etc..; halogenated hydrocarbons such as dichloromethane, chloroform, carbon tetrachloride, etc.; acid amides such as N,N-dimethylformamide, N,N-dimethylacetoamide, etc.; esters such as ethyl acetate, butyl acetate and aliphatic acid glycerin ester, etc.; nitrites such as acetonitrile, propionitrile, etc., and so on. One or more (preferably one to three) of them may be used by mixing them in an appropriate proportion.

Examples of a solid carrier (diluting or bulking agent) include plant powders such as soybean powder, tobacco powder, wheat powder, wood flour, etc.; clays such as kaolin, bentonite, acid white clay, etc.; talcs such as talc powder, agalmatolite powder, etc.; mineral powders such as diatomite, mica, etc.; calcium carbonate; alumina; sulfur powder; active carbon; and so on. One or more (preferably one to three) of them may be used by mixing them in an appropriate proportion. Examples of an ointment base include polyethylene glycol; pectin; polyhydric alcohol esters of higher fatty acids, such as glycerin monoester of stearic acid, etc.; cellulose derivatives such as metylcellulose, etc.; sodium alginate; bentonite; higher alcohols; polyhydric alcohols such as glycerin; Vaseline; white Vaseline; liquid paraffin; lard; various plant oils; lanoline; dehydrated lanoline; hardened oil; resins; and so on. One or more (preferably one to three) of them may be used. Alternatively, one or more of the following surfactants may further be added thereto. Examples of a surfactant to be used as an emulsifying agent, a spreading agent, a penetrating agent, a wetting agent or a dispersing agent include soaps; nonionic surfactants, for example, polyoxyethylene alkyl ethers (such as New Calgen D1504™ (TM: registered trade mark), Noygen ET65™, Noygen ET83™, and Noygen ET157™, etc.), polyoxyethylene alkylphenyl ethers, polyoxyethylene nonylphenyl ethers (such as Nonypole 20™, Nonypole 10™, etc.), polyoxyethylene alkylallyl ethers (such as Noygen EA142™, Noygen EA92™, made by Dai-ichi Kogyo Seiyaku Co., Ltd., and Nonal™, made by Toho Chemical Industry Co., Ltd.), polyethylene glycol ethers (such as Nonypole 85™, Nonypole 100™ and Nonypole 160™, made by Sanyo Chemicals Co., Ltd.), polyhydric alcohol esters (such as Tween 20™, Tween 80™, made by Kao Corp.), polyoxyethylene polyoxypropylene ethers, polyoxyethylene distyrene-modified phenyl ethers (such as Noygen EA87™, Noygen EA177 ™, etc.), polyoxyethylene alkylesters (such as Ionet MO20™, Ionet MO600™, etc.), sorbitan fatty acid esters (such as Leodole SP-S10™, Leodole TW-S20™, etc.), polyoxyetylene sorbitan fatty acid esters, block copolymers of ethylene oxide and propylene oxide (such as Newpole PE64™), higher fatty acid alkanolamide, alkylmaleic acid copolymers (such as Demol EP™, etc.), etc.; cationic surfactants, for example, alkylamine salts and quaternary ammonium salts, etc.; polymer compounds, for example, alkylsulfates (such as Emal 10™, Emal 40™, made by Kao Corp.), alkylsulfonates (such as Neogen ™, Neogen T™, made by Dai-ichi Kogyo Seiyaku Co., Ltd., Neopelex made by Kao Corp.), metal salts of polycondensed naphthalenesulfonic acid, a formalin condensate of naphthalenesulfonate (such a new Calgen FS4™, etc.), alkylnaphthalenesulfonate (such as Solpole 5115™), metal salts of ligninsulfonic acid, alkylallysulfonate, alkylallysulfonate sulfate, etc.; anionic surfactants, for example, polynaphthylmethanesulfonate, sodium polystyrenesulfonate, metal salts of polycarbonic acid, ammonium polyoxyethylene styrylphenyl ether sulfate, higher alcohol sulfonate, higher alcohol ether sulfonate, dialkylsulfosuccinate (such as New Calgen EP70 ™, etc.), alkali metal salts of higher fatty acid, etc.; and so on, at need. As the salt, there may be used a sodium salt, potassium salt, ammonium salt, diethanolamine salt, triethanolamine salt, monoisopropanolamine salt, diisopropanolamine salt, triisopropanolamine salt, or some other tertiary amine salt such as dialkyldimethyl ammonium salt, etc. to such a degree that it does not hinder the performance of the surfactant.

Preferred examples of a spreading agent are anionic surfactants containing a tertiary amine as a cation [such as dialkyldimethyl ammonium polynahthylmethanesulfonate, the example of which is Needs™ (sold by Kumiai Chemistry Industry Co., Ltd., and produced by Kao Corp.), etc.], etc., among the above-mentioned surfactants.

Examples of a stabilizing agent include compounds having an epoxy group, antioxidants [such as dibutylhydroxytoluene (BHT), butylhydroxyanisole (BHA), tetrakis[3-(3,5-di-tert-butyl-4-hydroxyphenyl) propionyloxymethyl]methane (Irganox 1010), DL-tocopherol, propyl gallate, erythorbic acid, sodium erythorbate, and isopropyl cinnate], phosphoric acid, PAP auxiliaries (such as iosopropyl acid phosphate), cyclodextrin (Toyoderin P), tall oil fatty acid (hertall fatty acid) and so on. One or more (preferably one to three) of them may be used. The proportion thereof in the formulation may be appropriately selected.

Examples of a binder include dextrin, α-starch, polyvinyl alcohol, Arabian gum, sodium alginate, polyvinyl pyrrolidone, glucose, sucrose, mannitol, sorbitol and so on. One or more (preferably one to three) of them may be used by mixing them in an appropriate proportion.

Examples of a fluidization auxiliary include PAP auxiliaries (such as iosopropyl acid phosphate), talc and so on. One or more (preferably one to three) of them may be used by mixing them in an appropriate proportion.

Examples of a solidification inhibitor include white carbon, diatomite, magnesium stearate, aluminum oxide, titanium dioxide and so on. One or more (preferably one to three) of them may be used by mixing them in an appropriate proportion.

Examples of a flocculating agent. include liquid paraffin, ethylene glycol, diethylene glycol, triethylene glycol, isobutylene polymer (such as IP Solvent) and so on. One or more (preferably one to three) of them may be used by mixing them in an appropriate proportion.

Examples of an antioxidant include dibutylhydroxytoluene, 4,4-thiobis-6-tert-butyl-3-methylphenol, butylhydroxyanisole, p-octylphenyl, mono- (or di or tri) (a-methylbenzyl)phenol, 2,6-di-tert-butyl-4-methylphenyl, tetrakis[3-(3,5-di-tert-butyl-4-hydroxyphenyl) propionyloxymethyl]methane, etc. One or more (preferably one to three) of them may be used by mixing them in an appropriate proportion.

A floating agent is used particularly to produce a jumbo agent. A powder base having a specific gravity of 1 or less (preferably from 0.5 to 1) is preferred. The powder base is preferably a base having a particle size of 600 μm or less, preferably from 10 to 600 μm. The powder base made of an inorganic material is a material having one or more independent bubble cells obtained by firing a natural glassy material. Examples thereof include pearlite made of pearlstone or obsidian, Shirasu ballon (trade name) made of volcanic soil, vermiculite, and so on, as well as Filite (trade name), which is composed of aluminosilicate-based, fine, hollow bodies obtained by firing working and so on. Examples of the powder base made of an organic material include higher fatty acids, such as stearic acid, palmitic acid, etc. which are in a solid form at ambient temperature; higher alcohols such as stearyl alcohol, etc.; paraffin wax; etc., each of which is generally called a waxy material. These waxy materials have water repellency. Therefore, water does not penetrate into the materials easily, and the agricultural chemical active ingredients are confined in the waxy materials for a long time. As a result, the active components may not easily be dispersed in water. Thus, the wax materials, when used, are preferably mixed with the above-mentioned glassy hollow bodies.

Examples of an antifoaming agent include silicone-based antifoaming agents (such as Antifoam E20) and so on. One or more (preferably one to three) of them may be used by mixing them in an appropriate proportion.

Examples of an antifreezing agent include ethylene glycol, diethylene glycol, polyethylene glycol, glycerin, etc. One or more (preferably one to three) of them may be used by mixing them in an appropriate proportion.

Examples of an antiseptic include butylparaben, sodium sorbate, etc. One or more (preferably one to three) of them may be used by mixing them in an appropriate proportion.

Examples of a water-removing agent include anhydrous gymsum, silica gel powder, etc. One or more (preferably one to three) of them may be used by mixing them in an appropriate proportion.

Examples of an ultraviolet absorber include 2-(2′-hydroxy-5′-methylphenyl)benzotriazole, 2-ethoxy-2′-methyloxalic acid bisanilide, dimethyl succinate-1-(2-hydroxyethyl)-4-hydroxy-2,2,6,6-tetramethylpyperidine polycondensate, etc. One or more (preferably one to three) of them may be used by mixing them in an appropriate proportion.

Examples of an ultraviolet scattering agent include titanium dioxide, etc. One or more (preferably one to three) of them may be used by mixing them in an appropriate proportion.

Examples of a coloring agent include cyanine green, Erio Green B400, etc. One or more (preferably one to three) out of them may be used by mixing them in an appropriate proportion.

Examples of a suspension stabilizing agent include polyvinyl alcohol (such as Gosenol GH17), clay minerals (such as Kunipia F, and VEEGUM R), silicon dioxide (such as Aerosil COK84), etc. One or more (preferably one to three) of them may be used by mixing them in an appropriate proportion.

In the case that the compound (I⁰) or a salt thereof and the different agricultural chemical active ingredient are used as separate compositions, each of the compositions can be produced according to the same manner as that described above.

The present inventors have found out that by combing the compound (I), (II), (III), (IV), (V) or (VI), or a salt thereof with the different agricultural chemical active ingredient, microbiocidal effect is synergistically made larger than in the case that each of them is used alone.

That is, the microbiocidal agent according to the present invention which is a combination of the above-mentioned sulfonamide [for example, the compound (I), (II), (III), (IV), (V) or (VI)] and the different agricultural chemical active ingredient(s) exhibits the following superior effects: (1) the bactericide, insecticide, acaricide, or nematicide effect thereof is made larger than in the case that each of the drug components is used alone; (2) bactericide, insecticide, acaricide or nematicide effect is immediately given; (3) a wide bactericide, insecticide, acaricide or nematicide spectrum, which the existing bactericide, insecticide, acaricide or nematicide does not have, is induced, or the bactericide, insecticide, acaricide or nematicide effect remains for a ling time; (4) the dosage thereof can be made lower than in the case that each of the drug components is used alone; (5) intenser extermination effect on various harmful organisms can be expected than in the case that each of the drug components is used alone; and so on.

Thus, another embodiment of the present invention is a process for reinforcing the microbiocidal effect of the compound (I), (II), (III), (IV), (V) or (VI), wherein the compound (I), (II), (III), (IV), (V) or (VI), or a salt thereof is used in combination with the different agricultural chemical active ingredient(s).

Examples of diseases which can be prevented by combining the compound (I⁰) or the salt thereof with the different agricultural chemical active ingredient(s) are as follows: diseases of rice plant, such as Pyricularia oryzae, Helminthosporium oryzae (Cochliobolus milyabeansus), Gibberella fujikuroi, Rhizopus oryzae, and Rhizoctonia solani; diseases of oats, such as Puccinia coronata; diseases of barley, such as Erysiphe graminis, Rhynchsporium secalis, Cochliobolus satibvus, Helminthosporium gramineum (Pyrenophora gramineum), Pyrenophra teres, Tilletia caries, and Ustilago nuda; diseases of wheat, such as Erysiphe, Leptosphaeria nodorum ( Septoria nodrum ), Pucinia striiformis, Typhula incarnate, Pseudocercosorella Herportrichoides, Calonecteria graminicola ( Fusarium nivale ), Puccinia granimis, Typhula ishikareiensis, Gibberella zeae, Puccinia recondita ( Puccinia triticina ), Helminthosporium granimeum, Tilletia caries, Septoria tritici, and Ustilago tritici; diseases of corn, such as Pythium debaryanum; diseases of rye, such as Fusarium nivale; diseases of potato, such as Phytophthora infestans; diseases of tobacco, such as Peronospora tabacina, Phytophothora parasitica var, Cercospora nicotianae, and tobacco mosaic virus; diseases of sugar beet, such as Cercospora beticola, Pythium debrayanum ( Rhizoctonia solani ), and Pythium aphanidermatum; diseases of paprika, such as Botrytis cinerea; diseases of kidney bean, such as Botrytis cinerea, Sclerotinia sclerotiorum and Corticium rolfsii; diseases of broad bean, such as Erysiphe polygoni, Sphaerotheca fuliginea, Uromyces fabae ( Uromyces phaseoli ), and Botrytis cinerea; diseases of peanut, such as Mucosphaerella archidicola; diseases of cabbage, such as Rhizoctonia solani; diseases of cucumber, such as Sphaerotheca fuliginea, Fusarium oxysporum, Mycosphaerella melonis, Pseudoperonospora cubensis, Botryis cinerea, Sclerotinia sclerotiorum, Colletotrichum lagenarium, Fusarium oxysporum ( Pythium aplanidermatum, Rhizoctonia solani ), and Cucumber mosaic virus; diseases of komatsuna (kind of Chinese cabbgage), such as Plasmodiophora brassicae; diseases of celery, such as Septoria apii; diseases of Japanese radish, such as Fusarium oxysporum; diseases of tomato, such as Fusarium oxysporum, Phytophthora infestans, Alternaria solani, Botrytis cinerea, Phytophthora capsici, and Alternaria tomato; diseases of eggplant, such as Phytophthora capsici, and Verticillium albo-atrum; diseases of Chinese cabbage, such as Alternaria japonica, and Plasmodiophora brassicae; diseases of sweet pepper, such as Phytophthora capsici, and Botrytis cinerea; diseases of lettuce, such as Botrytis cinerea; diseases of citrus fruits, such as Diaporthe citri; diseases of pear, such as Venturia nashicola, Alternaria kikuchiana, and Gymnosporangium haraeanum; diseases of grape, such as Plasmopara viticola, Botrytis cinerea, and Elsinoe ampelina; diseases of peach, such as Taphrina deformans and Mycosphaerella cerasella; diseases of apple, such as Podosphaera leucotria, Cladsporium carpophilum, Botrytis cinerea, Venturia inaequalis, Gymnosporangium yamadae, Rosellinina nectrix, and Alternaria mali; and diseases of cereals, fruit trees, and vegetables, for example, oil-seed rape, sunflower, carrot, pepper, strawberry, melon, kiwi fruit, onion, leek, sweet potato, fig tree, Japanese apricot, asparagus, persimmon, soybean, adzuki bean, watermelon plant, crown daisy, spinach, and tea plant. In particular, the present invention exhibits high activity to diseases caused by Pyricularia, Cochliobolus, Curvularia, Pyrenophora, Alternaria genera, and genera closely related thereto. Examples of the diseases include Pyricularia oryzae, Helminthosporium oryzae and Monographella albescens which rice plant suffers from; Cochliobolus satibvus, Helminthosporium gramineum ( Pyrenophora gramineum ), and Pyrenophra teres which barley suffers from; Cephalosporinm stripe and Cochliobolus satibvus which wheat suffers from; Cochliobus heterostrophus which corn suffers from; Phytophthora infestans which potato suffers from; Alternaria brassicicola which komatsuna suffers from; Alternaria solani and Alternaria tomato which tomato suffers from; Alternaria japonica which Japanese cabbage suffers from; Alternaria kikuchina which pear suffers from; and Alternaria mali which apple suffers from.

The compound (I⁰) wherein Z⁰ represents a group represented by —OR³ or a salt thereof has superior effect of preventing knot diseases of Brassica campestris plants such as canola, turnip, cauliflower, cabbage, komatsuma, rapeseed, and Chinese cabbage. The compounds (I), (II) and (III) wherein Z¹, Z² or Z³ is a group represented by —OR³, or salts thereof are preferred. The compound (II′) represented by the following formula (II′):

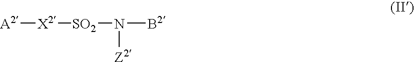

wherein A²′, X²′, and B²′ have the same meanings as A², X², and B², respectively, and Z²′ represents a group represented by —OR³ wherein R³ has the same meaning as described above, or a salt thereof is particularly preferred.

As the compounds (II′), preferred are compounds or salts thereof wherein:

A²′ represents (1) a C₆₋₁₄ aryl group which may be substituted with 1-5 substituents selected from:

(i) a C₁₋₄ alkyl group which may be substituted with 1-5 halogens,

(ii) a C₁₋₄ alkoxy group which may be substituted with 1-5 halogens,

(iii) an amino group which may be substituted with 1 or 2 C₁₋₄ alkyl-carbonyl,

(iv) a C₁₋₄ alkyl-carbonyl group,

(v) a halogen atom,

(vi) a cyano group, and

(vii) a nitro group, or

(2) a thienyl, triazolyl, imidazolyl, isoxazolyl, pyrazolyl, pyridyl, quinolyl, benzothiadiazolyl, imidazothiazolyl, or imidazopyridyl group, which may be substituted with 1-5 substituents selected from:

(i) a C₁₋₄ alkyl group,

(ii) a C₁₋₄ alkoxy-carbonyl group,

(iii) a carbamoyl group,

(iv) a mono- or di-C₁₋₄ alkylcarbamoyl group,

(v) a C₁₋₄ alkylsulfonyl group,

(vi) a halogen atom,

(vii) a carboxyl group, and

(viii) a cyano group,

X²′ represents (1) a chemical bond,

(2) a methylene group which may be substituted with 1 or 2 C₁₋₄ alkyls, or

(3) a vinylene group which may be substituted with 1 or 2 C₁₋₄ alkyls,

B²′ represents a C₆₋₁₄ aryl group which may be substituted with 1-5 substituents selected from:

(1) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio,

(2) a C₂₋₄ alkynyl group,

(3) a hydroxy group,

(4) a C₁₋₄ alkoxy group which may be substituted with 1-5 substituents selected from halogen and C₁₋₄ alkoxy,

(5) a C₁₋₄ alkyl-carbonyloxy group,

(6) a C₁₋₄ alkylthio group,

(7) a C₁₋₄ alkylsulfinyl group,

(8) a C₁₋₄ alkylsulfonyl group,

(9) a mono- or di-C₁₋₄ alkylsulfamoyl group,

(10) an amino group,

(11) a formyl group,

(12) a C₁₋₄ alkoxy-carbonyl group,

(13) a carbamoyl group,

(14) a mono- or di-C₁₋₄ alkylcarbamoyl group,

(15) a thiocarbamoyl group,

(16) a halogen atom,

(17) a carboxyl group,

(18) a thiocyanate group,

(19) a cyano group,

(20) a nitroso group, and

(21) a nitro group, and

Z²′ represents a group represented by a group represented by —OR³ wherein R³ represents a C₁₋₄ alkyl, or C₁₋₄ alkoxy-carbonyl group.

More preferred embodiments of the compound (II′) or the salt thereof are as follows:

(1) A²′ is preferably (a) a phenyl group which may be substituted with 1-3 substituents selected from C₁₋₄ alkyl which may be substituted with 1-3 halogens, halogen and nitro,

(b) a thienyl group which may be substituted with 1-3 halogens, or

(c) a pyrazolyl group which may be substituted with 1-3 substituents selected from C₁₋₄ alkyl and halogen.

A phenyl group substituted, at its 4-position, with methyl is particularly preferred.

(2) B² is preferably a phenyl group which may be substituted with a substituent selected from:

(a) a C₁₋₄ alkyl group which may be substituted with 1-5 (preferably 1-3) halogens,

(b) a halogen atom,

(c) a cyano group, and

(d) a nitro group. The compound having this substituent at the 2- or 4-position of its phenyl group is particularly preferred.

(3) Z² is preferably a C₁₋₄ alkoxy group, or a C₁₋₄ alkyl-carbonyloxy group. A methoxy group and an ethoxy group are particularly preferred.

(4) X² is preferably a chemical bond (a single bond or a bonding hand).

The preferred embodiments of the A²′, B²′, Z²′, and X²′, described in the above-mentioned (1) to (4), may be combined with each other at will.

The mixture composition of the compound (I⁰) or the salt thereof and the different agricultural chemical active ingredient can be used as a superior microbiocidal composition having a microbiocidal effect and a very small toxicity so as to be safe. The mixture agricultural chemical composition of the present invention can be used in the same way as conventional microbiocidal compositions, and exhibits better effects than the conventional compositions. For example, the present invention can be used as follows; the application thereof to seedling-growing boxes, spray thereof onto stalks and leaves of farm products, application thereof to water in paddy fields, application thereof to seeds or soil, direct application thereof to trunks of fruit trees, or the like. The application amount thereof can be changed within a wide range, depending on the application period, application spot, application manner thereof, or the like. The mixture agricultural chemical composition of the present invention is desirably applied in such a manner that the amount of the effective component (the compound (I⁰) or the salt thereof) is usually from 0.3 to 3,000 g, preferably from 50 to 1,000 g per hectare. In the case that the mixture agricultural chemical composition of the present invention is a water dispersible powder, the composition, when used, should be diluted in such a manner that the final concentration of the effective component is from 0.1 to 1,000 ppm, preferably from 10 to 500 ppm. The content of the compound (I⁰) or the salt thereof is usually from about 0.1 to 80% by weight, preferably from about 1 to 20% by weight of the total amount of the formulation.

Specifically, the content is usually from about 1 to 80% by weight, preferably from about 1 to 20% by weight when the compound (I⁰) or the salt thereof is used as an emulsion, liquid agent, hydrating agent (for example, granular hydrating agent), aqueous suspension formulation, microemulsion, or the like. The content is usually from about 0.1 to 50% by weight, preferably from about 1 to 20% by weight when the compound (I₀) or the salt thereof is used as an oily agent, powdered agent, or the like. The content is usually from about 5 to 50% by weight, preferably from about 1 to 20% by weight when the compound (I⁰) or the salt thereof is used as a granular agent, tablet, jumbo agent, or the like. The amount of the different agricultural chemical active ingredient (for example, an insecticide, acaricide, herbicide, and/or microbiocidal agent) blended in the mixture agricultural chemical composition of the present invention is usually from about 1 to 80% by weight, preferably from about 1 to 20% by weight of the total amount of the formulation. The content of the additives other than the above-mentioned effective components varies dependently on the kind or the content of the effective components or the applying form of the formulation. However, this content is usually from about 0.001 to 99.9% by weight, preferably from about 1 to 99% by weight. More specifically, the amount of the surfactant is usually from about 1 to 20% by weight, preferably from about 1 to 15% by weight of the total amount of the composition. The amount of the fluidization auxiliary is from about 1 to 20% by weight, and the amount of the carrier is from about 1 to 90% by weight, preferably from about 1.to 70% by weight. Specifically, when the formulation is produced, the surfactant is usually added in an amount of about 1 to 20% (preferably about 1 to 10%) by weight, and water is added in an amount of 20 to 90% by weight. When the emulsion, the hydrating agent (for example, granular hydrating agent), or the like is used, it is advisable that the agent is diluted with water or the like (for example, about 100 to 5,000 times) and then the agent is sprayed.

In the case that the compound (I⁰) or the salt thereof and the different agricultural chemical active ingredient are separately made into compositions, they can be used according to the above-mentioned manner.

### EXAMPLES

The following Reference Examples, Formulation Examples and Test Examples further illustrate the present invention in detail, but are not construed to limit the scope thereof.

Abbreviations used in the description on Reference Examples and Test Examples, which is below, have the following meanings.

s: singlet, d: doublet, t: triplet, q: quartet, m: multiplet, dd: double doublet, dt: double triplet, dq: double quartet, septet: septet, br: broad, brs: broad singlet, ddd: double double doublet, ddt: double double triplet, brd: broad doublet, brq: broad quartet, J: coupling constant, JHF: coupling constant between hydrogen and fluorine atoms, Hz: hertz, CDCl3: deuterium chloroform, DMSO-d6: deuterium dimethylsulfoxide, DMF: N,N-dimethylforamide, %: % by weight, mp: melting point, Me: methyl group, Et: ethyl group, n-Pr: n-propyl group, i-Pr: isopropyl group, c-Pr: cyclopropyl group, n-Bu: butyl group, i-Bu: isobutyl group, s-Bu: secondary butyl group, t-Bu: tertiary butyl group, Ac: acetyl group, and Ph: phenyl group. The wording “room temperature” means a temperature of 15 to 25° C.

### Reference Example 1

### Synthesis of 4′-chloro-N-ethyl-2′-nitro-p-toluenesulfonanilide (Which may be Referred to as the Compound No. 289)

As described as Example 4 in JP 2001-26506A, 0.05 g (1.25 mmole) of 60% sodium hydride was suspended in 2.0 mL of DMF. To the suspension was added 0.30 g (0.92 mmole) of 4′-chloro-2′-nitro-p-toluenesulfonanilide under stirring at room temperature. The suspension solution was stirred at room temperature for 15 minutes, and then thereto was dropwise added 0.50 mL (6.25 mmoles) of ethyl iodide. The solution was stirred and heated at 100° C. for 1 hour, and then the reaction solution was poured into water. The organic phase was extracted with ethyl acetate. The extracted solution was washed with water and saturated salt water. Thereafter, the solution was dried over anhydrous magnesium sulfate and then concentrated under reduced pressure. The residue was subjected to silica gel chromatography, and eluted out with ethyl acetate-hexane (1:3), so as to yield 0.24 g of the captioned compound as a light yellow crystal (yield: 74%).

### Reference Example 2

Compounds represented by the formula (I⁰) described in 2001-26506A are shown in Tables 1 to 29.

TABLE 1

| Compound | | | | | Melting |
|---|---|---|---|---|---|
| No. | A | X | Z | B | point (° C.) |
| 1 | 4-Me—Ph | — | Me | 4-Me—Ph | |
| 2 | 4-Me—Ph | — | Me | 4-Et—Ph | Oily material¹⁾ |
| 3 | 4-Me—Ph | — | Me | 4-(n-Pr)—Ph | |
| 4 | 4-Me—Ph | — | Me | 4-(i-Pr)—Ph | 92.5-93.5 |
| 5 | 4-Me—Ph | — | Me | 4-(n-Bu)—Ph | |
| 6 | 4-Me—Ph | — | Me | 2-F—Ph | |
| 7 | 4-Me—Ph | — | Me | 3-F—Ph | |
| 8 | 4-Me—Ph | — | Me | 4-F—Ph | 92.0-94.5 |
| 9 | 4-Me—Ph | — | Me | 2-Cl—Ph | 98.0-99.0 |
| 10 | 4-Me—Ph | — | Me | 3-Cl—Ph | |
| 11 | 4-Me—Ph | — | Me | 4-Cl—Ph | |
| 12 | 4-NH₂—Ph | — | Me | 4-Cl—Ph | 170.0-174.0 |
| 13 | 4-AcNH—Ph | — | Me | 4-Cl—Ph | 195.0-199.0 |
| 14 | 4-NO₂—Ph | — | Me | 4-Cl—Ph | 183.0-184.0 |
| 15 | 3,5-Me₂-4- | — | Me | 4-Cl—Ph | 109.0-112.0 |
| | Isoxazoyl | | | | |
| 16 | 4-Me—Ph | — | Et | 4-Cl—Ph | |
| 17 | 4-Me—Ph | — | Me | 2-Br—Ph | |
| 18 | 4-Me—Ph | — | Me | 3-Br—Ph | |
| 19 | 4-Me—Ph | — | Me | 4-Br—Ph | 82.5-83.5 |
| 20 | 4-Me—Ph | — | Me | 2-SMe—Ph | 120.0-122.0 |

¹⁾NMR(CDCl₃) δ: 1.22(3H, t, J=7.6Hz), 2.42(3H, s), 2.63(2H, q, J=7.6Hz), 3.14(3H, s), 6.99(2H, d, J=8.6 & 2.3Hz), 7.12(2H, d, J=8.6 & 2.3Hz), 7.24(2H, d, J=8.3Hz), 7.45(2H, d, J=8.3Hz).

TABLE 2

| Com- | | | | | |
|---|---|---|---|---|---|
| pound | | | | | Melting |
| No. | A | X | Z | B | point (° C.) |
| 21 | 4-Me—Ph | — | Me | 2-SOMe—Ph | |
| 22 | 4-Me—Ph | — | Me | 2-SO₂Me—Ph | 191.0-194.0 |
| 23 | 4-Me—Ph | — | Me | 2-COOMe—Ph | 91.0-94.0 |
| 24 | 4-Me—Ph | — | Me | 2-COOH—Ph | 161.0-166.0 |
| 25 | 4-Me—Ph | — | Me | 2-CN—Ph | 138.5-140.0 |
| 26 | 4-Me—Ph | — | SO₂-(4- | 2-CN—Ph | 179.5-181.0 |
| | | | Me—Ph) | | |
| 27 | 4-Me—Ph | — | Me | 3-CN—Ph | 112.0-114.5 |
| 28 | 4-Me—Ph | — | Me | 4-CN—Ph | 117.0-120.0 |
| 29 | 4-Me—Ph | — | Et | 4-CN—Ph | 85.4-86.6 |
| 30 | 4-Me—Ph | — | Me | 2-CF₃—Ph | 122.5-124.0 |
| 31 | 4-Me—Ph | — | SO₂-(4- | 2-CF₃—Ph | 176.0-177.5 |
| | | | Me—Ph) | | |
| 32 | 4-Me—Ph | — | Me | 3-CF₃—Ph | 100.0-102.0 |
| 33 | 4-Me—Ph | — | Me | 4-CF₃—Ph | 75.0-76.0 |
| 34 | 4-Me—Ph | — | Me | 2-OCF₃—Ph | |
| 35 | 4-Me—Ph | — | Me | 3-OCF₃—Ph | |
| 36 | 4-Me—Ph | — | Me | 4-OCF₃—Ph | 61.5-63.0 |
| 37 | Ph | — | Me | 2-NO₂—Ph | |
| 38 | 4-Me—Ph | — | Me | 2-NO₂—Ph | 131.5-132.5 |
| 39 | 4-Me—Ph | — | SO₂-(4- | 2-NO₂—Ph | 184.5-186.5 |
| | | | Me—Ph) | | |
| 40 | 4-Me—Ph | — | Me | 3-NO₂—Ph | 108.0-109.0 |

TABLE 3

| Compound | | | | | Melting |
|---|---|---|---|---|---|
| No. | A | X | Z | B | point (° C.) |
| 41 | 4-Me—Ph | — | Me | 4-NO₂—Ph | 179.0-181.0 |
| 42 | 4-Me—Ph | — | Me | 3,4-(OMe)₂—Ph | 108.5-109.5 |
| 43 | 4-Me—Ph | — | Me | 3,4-(OCH₂O)—Ph | 124.0-125.0 |
| 44 | 4-Me—Ph | — | Me | 3,4-(OCF₂O)—Ph | |
| 45 | 4-Me—Ph | — | Me | 2-F-4-Cl—Ph | |
| 46 | 4-Me—Ph | — | Et | 2-F-4-Cl—Ph | |
| 47 | 4-Me—Ph | — | n-Pr | 2-F-4-Cl—Ph | |
| 48 | 4-Me—Ph | — | Me | 2,4-F₂—Ph | |
| 49 | 4-Me—Ph | — | Et | 2,4-F₂—Ph | |
| 50 | 4-Me—Ph | — | n-Pr | 2,4-F₂—Ph | |
| 51 | 4-Me—Ph | — | Me | 2,4-Cl₂—Ph | 86.0-87.0 |
| 52 | 4-Me—Ph | — | Et | 2,4-Cl₂—Ph | |
| 53 | 4-Me—Ph | — | n-Pr | 2,4-Cl₂—Ph | |
| 54 | 4-Me—Ph | — | Me | 2,6-Cl₂—Ph | |
| 55 | 4-Me—Ph | — | Et | 2,6-Cl₂—Ph | |
| 56 | 4-Me—Ph | — | n-Pr | 2,6-Cl₂—Ph | |
| 57 | 4-Me—Ph | — | Me | 3,4-Cl₂—Ph | 85.0-86.0 |
| 58 | 4-Me—Ph | — | Et | 3,4-Cl₂—Ph | |
| 59 | 4-Me—Ph | — | Me | 3,5-Cl₂—Ph | |
| 60 | 4-Me—Ph | — | Et | 3,5-Cl₂—Ph | |

TABLE 4

| Compound | | | | | |
|---|---|---|---|---|---|
| No. | A | X | Z | B | Melting point (° C.) |
| 61 | 4-Me—Ph | — | Me | 2-NH₂-4-Cl—Ph | 101.5-102.5 |
| 62 | 4-Me—Ph | — | Me | 4-Cl-2-SMe—Ph | 84.5-86.0 |
| 63 | 4-Me—Ph | — | Me | 4-Cl-2-SOMe—Ph | 142.0-143.5 |
| 64 | 4-Me—Ph | — | Me | 4-Cl-2-SO₂Me—Ph | 189.5-191.0 |
| 65 | 4-Me—Ph | — | Me | 4-Cl-2-CH₂OH—Ph | 130.0-132.0 |
| 66 | 4-Me—Ph | — | Me | 4-Cl-2-CHO—Ph | 123.0-124.0 |
| 67 | 4-Me—Ph | — | Me | 4-Cl-2-(CH═NOH)—Ph | 160.5-162.0 |
| 68 | 4-Me—Ph | — | Me | 4-Cl-2-(CH═NOMe)—Ph | 123.5-124.5 |
| 69 | 4-Me—Ph | — | Me | 4-Cl-2-(CH═N—NH₂)—Ph | 107.5-109.5 |
| 70 | 4-Me—Ph | — | Me | 4-Cl-2-(CH═N—NMe₂)—Ph | 114.0-115.5 |
| 71 | 4-Me—Ph | — | Me | 4-Cl-2-COOH—Ph | 175.0-177.0 |
| 72 | 4-Me—Ph | — | Et | 4-Cl-2-COOH—Ph | 163.0-165.0 |
| 73 | 4-Me—Ph | — | i-Pr | 4-Cl-2-COOH—Ph | 175.0-176.5 |
| 74 | 4-Me—Ph | — | Me | 2-Cl-4-COOMe—Ph | |
| 75 | 4-Me—Ph | — | Me | 4-Cl-2-COOMe—Ph | 65.5-67.0 |
| 76 | 4-Me—Ph | — | Et | 4-Cl-2-COOMe—Ph | 105.0-107.0 |
| 77 | 4-Me—Ph | — | i-Pr | 4-Cl-2-COOMe—Ph | 113.5-115.5 |
| 78 | 4-Me—Ph | — | Me | 2-Cl-4-CONH₂—Ph | |
| 79 | 4-Me—Ph | — | Me | 4-Cl-2-CONH₂—Ph | 176.5-178.0 |
| 80 | 4-Me—Ph | — | Et | 4-Cl-2-CONH₂—Ph | 148.5-150.0 |

TABLE 5

| Compound | | | | | |
|---|---|---|---|---|---|
| No. | A | X | Z | B | Melting point (° C.) |
| 81 | 4-Me—Ph | — | i-Pr | 4-Cl-2-CONH₂—Ph | 177.0-178.5 |
| 82 | 4-Me—Ph | — | Me | 2-Cl-4-CSNH₂—Ph | |
| 83 | 4-Me—Ph | — | Me | 4-Cl-2-CSNH₂—Ph | 180.5-182.5 |
| 84 | 4-Me—Ph | — | Et | 4-Cl-2-CSNH₂—Ph | 180.0-182.0 |
| 85 | 4-Me—Ph | — | i-Pr | 4-Cl-2-CSNH₂—Ph | 189.0-191.0 |
| 86 | 4-Me—Ph | — | Me | 4-Cl-2-[C(SMe)═NH]—Ph(*) | Amorphous²⁾ |
| 87 | 4-Me—Ph | — | Et | 4-Cl-2-[C(SMe)═NH]—Ph(*) | >160 (Decomposed) |
| 88 | 4-Me—Ph | — | Et | 4-Cl-2-[C(SEt)═NH]—Ph(*) | >161 (Decomposed) |
| 89 | 4-Me—Ph | — | Et | 4-Cl-2-[C(S(i-Pr))═NH]—Ph(*) | >155 (Decomposed) |
| 90 | 4-Me—Ph | — | Me | 4-Cl-2-CONMe₂—Ph | Oily material³⁾ |
| 91 | 4-Me—Ph | — | Me | 2-Cl-4-CN—Ph | |
| 92 | 4-Me—Ph | — | Et | 2-Cl-4-CN—Ph | |
| 93 | 4-Me—Ph | — | i-Pr | 2-Cl-4-CN—Ph | |
| 94 | 4-Me—Ph | — | Me | 4-Cl-2-CN—Ph | 145.0-147.0 |
| 95 | 4-Me—Ph | — | Et | 4-Cl-2-CN—Ph | 138.5-140.5 |
| 96 | 4-Me—Ph | — | n-Pr | 4-Cl-2-CN—Ph | |
| 97 | 4-Me—Ph | — | i-Pr | 4-Cl-2-CN—Ph | 129.5-130.5 |
| 98 | 4-Me—Ph | — | c-Pr | 4-Cl-2-CN—Ph | |
| 99 | 4-Me—Ph | — | Me | 2-CN-4-SMe—Ph | 139.0-140.0 |
| 100 | 4-Me—Ph | — | Et | 2-CN-4-SMe—Ph | 136.0-137.0 |

²⁾NMR(CDCl₃) δ: 2.46(3H, s), 3.17(3H, s), 3.27(3H, s), 6.68(1H, d, J=8.7Hz), 7.34(2H, d, J=8.3Hz), 7.43(1H, dd, J=8.7 & 2.4Hz), 7.51(2H, d, J=8.3Hz), 7.77(1H, d, J=2.4Hz), 11.00-12.00(2H, br).
³⁾NMR(CDCl₃) δ: 2.46(3H, s), 3.01(3H, s), 3.14(6H, s), 6.80(1H, d, J=8.9Hz), 7.20-7.35(2H, m), 7.34(2H, d, J=8.3Hz), 7.66(2H, d, J=8.3Hz).
(*)Isolated as a salt of hydriodic acid. The melting point thereof was measured.

TABLE 6

| Compound | | | | | |
|---|---|---|---|---|---|
| No. | A | X | Z | B | Melting point (° C.) |
| 101 | 4-Me—Ph | — | i-Pr | 2-CN-4-SMe—Ph | 134.0-136.0 |
| 102 | 4-Me—Ph | — | Me | 2-CN-4-SOMe—Ph | |
| 103 | 4-Me—Ph | — | Et | 2-CN-4-SOMe—Ph | |
| 104 | 4-Me—Ph | — | i-Pr | 2-CN-4-SOMe—Ph | |
| 105 | 4-Me—Ph | — | Me | 2-CN-4-SO₂Me—Ph | 179.0-180.5 |
| 106 | 4-Me—Ph | — | Et | 2-CN-4-SO₂Me—Ph | 154.5-156.0 |
| 107 | 4-Me—Ph | — | i-Pr | 2-CN-4-SO₂Me—Ph | 184.0-186.0 |
| 108 | 4-Me—Ph | — | Et | 2-CN-4-COOH—Ph | 178.5-181.5 |
| 109 | 4-Me—Ph | — | Et | 2-CN-4-COOMe—Ph | 135.6-136.8 |
| 110 | 4-Me—Ph | — | SO₂-(4- | 2-CN-4-COOMe—Ph | 166.5-167.5 |
| | | | Me—Ph) | | |
| 111 | 4-Me—Ph | — | Et | 2-CN-4-CONH₂—Ph | 163.5-165.0 |
| 112 | 4-Me—Ph | — | Me | 2,4-(CN)₂—Ph | 146.0-147.3 |
| 113 | 4-Me—Ph | — | Et | 2,4-(CN)₂—Ph | 184.5-185.5 |
| 114 | 4-Me—Ph | — | i-Pr | 2,4-(CN)₂—Ph | 157.2-157.7 |
| 115 | 4-Me—Ph | — | SO₂-(4- | 2,4-(CN)₂—Ph | 195.0-196.5 |
| | | | Me—Ph) | | |
| 116 | 4-Me—Ph | — | Me | 4-Cl-2-CF₃—Ph | 143.0-144.5 |
| 117 | 4-Me—Ph | — | Et | 4-Cl-2-CF₃—Ph | |
| 118 | 4-Me—Ph | — | Me | 3,5-(CF₃)₂—Ph | 110.5-113.0 |
| 119 | 4-Me—Ph | — | Me | 4-Me-2-NO₂—Ph | 123.0-124.0 |
| 120 | 4-Me—Ph | — | Et | 4-Me-2-NO₂—Ph | |

TABLE 7

| Compound | | | | | |
|---|---|---|---|---|---|
| No. | A | X | Z | B | Melting point (° C.) |
| 121 | 4-Me—Ph | — | n-Pr | 4-Me-2-NO₂—Ph | |
| 122 | 4-Me—Ph | — | i-Pr | 4-Me-2-NO₂—Ph | |
| 123 | 4-Me—Ph | — | c-Pr | 4-Me-2-NO₂—Ph | |
| 124 | 4-Me—Ph | — | n-Bu | 4-Me-2-NO₂—Ph | |
| 125 | 4-Me—Ph | — | Me | 2-Me-4-NO₂—Ph | 103.0-104.0 |
| 126 | 4-Me—Ph | — | Me | 4-Me-3-NO₂—Ph | 103.5-106.0 |
| 127 | 4-Me—Ph | — | Me | 4-Et-2-NO₂—Ph | 137.0-139.0 |
| 128 | 4-Me—Ph | — | Me | 4-(i-Pr)-2-NO₂—Ph | 135.0-136.0 |
| 129 | 4-Me—Ph | — | Me | 4-C≡CH-2-NO₂—Ph | |
| 130 | 4-Me—Ph | — | Et | 4-C≡CH-2-NO₂—Ph | |
| 131 | 4-Me—Ph | — | n-Pr | 4-C≡CH-2-NO₂—Ph | |
| 132 | 4-Me—Ph | — | Me | 4-CHO-2-NO₂—Ph | |
| 133 | 4-Me—Ph | — | Et | 4-CHO-2-NO₂—Ph | |
| 134 | 4-Me—Ph | — | n-Pr | 4-CHO-2-NO₂—Ph | |
| 135 | 4-Me—Ph | — | Me | 4-CH═NOMe-2-NO₂—Ph | |
| 136 | 4-Me—Ph | — | Et | 4-CH═NOMe-2-NO₂—Ph | |
| 137 | 4-Me—Ph | — | n-Pr | 4-CH═NOMe-2-NO₂—Ph | |
| 138 | 4-Me—Ph | — | Me | 4-COOMe-2-NO₂—Ph | |
| 139 | 4-Me—Ph | — | Et | 4-COOMe-2-NO₂—Ph | |
| 140 | 4-Me—Ph | — | n-Pr | 4-COOMe-2-NO₂—Ph | |

TABLE 8

| Com- | | | | | |
|---|---|---|---|---|---|
| pound | | | | | Melting point |
| No. | A | X | Z | B | (° C.) |
| 141 | 4-Me—Ph | — | i-Pr | 4-COOMe-2-NO₂—Ph | |
| 142 | 4-Me—Ph | — | c-Pr | 4-COOMe-2-NO₂—Ph | |
| 143 | 4-Me—Ph | — | n-Bu | 4-COOMe-2-NO₂—Ph | |
| 144 | 4-Me—Ph | — | Me | 4-CONH₂-2-NO₂—Ph | |
| 145 | 4-Me—Ph | — | Et | 4-CONH₂-2-NO₂—Ph | |
| 146 | 4-Me—Ph | — | n-Pr | 4-CONH₂-2-NO₂—Ph | |
| 147 | 4-Me—Ph | — | i-Pr | 4-CONH₂-2-NO₂—Ph | |
| 148 | 4-Me—Ph | — | c-Pr | 4-CONH₂-2-NO₂—Ph | |
| 149 | 4-Me—Ph | — | n-Bu | 4-CONH₂-2-NO₂—Ph | |
| 150 | 4-Me—Ph | — | Me | 4-CSNH₂-2-NO₂—Ph | |
| 151 | 4-Me—Ph | — | Et | 4-CSNH₂-2-NO₂—Ph | |
| 152 | 4-Me—Ph | — | n-Pr | 4-CSNH₂-2-NO₂—Ph | |
| 153 | 4-Me—Ph | — | i-Pr | 4-CSNH₂-2-NO₂—Ph | |
| 154 | 4-Me—Ph | — | c-Pr | 4-CSNH₂-2-NO₂—Ph | |
| 155 | 4-Me—Ph | — | n-Bu | 4-CSNH₂-2-NO₂—Ph | |
| 156 | 4-Me—Ph | — | Me | 4-OH-2-NO₂—Ph | 173.0-174.0 |
| 157 | 4-Me—Ph | — | Me | 2-OMe-4-NO₂—Ph | |
| 158 | 4-Me—Ph | — | Et | 2-OMe-4-NO₂—Ph | |
| 159 | 4-Me—Ph | — | n-Pr | 2-OMe-4-NO₂—Ph | |
| 160 | 4-Me—Ph | — | i-Pr | 2-OMe-4-NO₂—Ph | |

TABLE 9

| Com- | | | | | Melting |
|---|---|---|---|---|---|
| pound | | | | | point |
| No. | A | X | Z | B | (° C.) |
| 161 | 4-Me—Ph | — | c-Pr | 2-OMe-4-NO₂—Ph | |
| 162 | 4-Me—Ph | — | n-Bu | 2-OMe-4-NO₂—Ph | |
| 163 | Ph | — | Me | 4-OMe-2-NO₂—Ph | 90.0-91.5 |
| 164 | Ph | — | Et | 4-OMe-2-NO₂—Ph | |
| 165 | Ph | — | n-Pr | 4-OMe-2-NO₂—Ph | |
| 166 | Ph | — | i-Pr | 4-OMe-2-NO₂—Ph | |
| 167 | Ph | — | c-Pr | 4-OMe-2-NO₂—Ph | |
| 168 | Ph | — | n-Bu | 4-OMe-2-NO₂—Ph | |
| 169 | 2-Me—Ph | — | Me | 4-OMe-2-NO₂—Ph | Oily |
| | | | | | material⁴⁾ |
| 170 | 3-Me—Ph | — | Me | 4-OMe-2-NO₂—Ph | |
| 171 | 4-Me—Ph | — | Me | 4-OMe-2-NO₂—Ph | 123.0-124.0 |
| 172 | 2,4,6-Me₃—Ph | — | Me | 4-OMe-2-NO₂—Ph | 161.0-163.0 |
| 173 | 3-OMe—Ph | — | Me | 4-OMe-2-NO₂—Ph | |
| 174 | 4-OMe—Ph | — | Me | 4-OMe-2-NO₂—Ph | 146.0-147.0 |
| 175 | 2-Cl—Ph | — | Me | 4-OMe-2-NO₂—Ph | |
| 176 | 3-Cl—Ph | — | Me | 4-OMe-2-NO₂—Ph | |
| 177 | 4-Cl—Ph | — | Me | 4-OMe-2-NO₂—Ph | 162.5-163.5 |
| 178 | 4-Cl—Ph | — | Et | 4-OMe-2-NO₂—Ph | |
| 179 | 4-Cl—Ph | — | n-Pr | 4-OMe-2-NO₂—Ph | |
| 180 | 4-Cl—Ph | — | i-Pr | 4-OMe-2-NO₂—Ph | |

⁴⁾NMR(CDCl₃) δ: 2.47(3H, s), 3.35(3H, s), 3.85(3H, s), 7.06(1H, dd, J=8.9 & 3.0Hz), 7.10-7.35(3H, m), 7.34(1H, dt, J=8.9Hz), 7.45(1H, dt, J=1.4 & 7.9Hz), 7.69(1H, dd, J=7.9 & 1.4Hz).

TABLE 10

| Com- | | | | | |
|---|---|---|---|---|---|
| pound | | | | | Melting |
| No. | A | X | Y | B | point (° C.) |
| 181 | 4-Cl—Ph | — | c-Pr | 4-OMe-2-NO₂—Ph | |
| 182 | 4-Cl—Ph | — | n-Bu | 4-OMe-2-NO₂—Ph | |
| 183 | 4-Br—Ph | — | Me | 4-OMe-2-NO₂—Ph | |
| 184 | 2,5-Cl₂—Ph | — | Me | 4-OMe-2-NO₂—Ph | 113.0-115.0 |
| 185 | 2-COOMe—Ph | — | Me | 4-OMe-2-NO₂—Ph | |
| 186 | 3-COOMe—Ph | — | Me | 4-OMe-2-NO₂—Ph | |
| 187 | 4-COOMe—Ph | — | Me | 4-OMe-2-NO₂—Ph | |
| 188 | 2-CN—Ph | — | Me | 4-OMe-2-NO₂—Ph | |
| 189 | 3-CN—Ph | — | Me | 4-OMe-2-NO₂—Ph | |
| 190 | 4-CN—Ph | — | Me | 4-OMe-2-NO₂—Ph | |
| 191 | 2-CF₃—Ph | — | Me | 4-OMe-2-NO₂—Ph | |
| 192 | 3-CF₃—Ph | — | Me | 4-OMe-2-NO₂—Ph | |
| 193 | 4-CF₃—Ph | — | Me | 4-OMe-2-NO₂—Ph | |
| 194 | 2-NO₂—Ph | — | Me | 4-OMe-2-NO₂—Ph | 136.5-138.5 |
| 195 | 3-NO₂—Ph | — | Me | 4-OMe-2-NO₂—Ph | 123.5-125.0 |
| 196 | 4-NO₂—Ph | — | Me | 4-OMe-2-NO₂—Ph | 157.5-158.5 |
| 197 | 4-NO₂—Ph | — | Et | 4-OMe-2-NO₂—Ph | |
| 198 | 4-NO₂—Ph | — | n-Pr | 4-OMe-2-NO₂—Ph | |
| 199 | 4-NO₂—Ph | — | i-Pr | 4-OMe-2-NO₂—Ph | |
| 200 | 1-CONEt₂- | — | Me | 4-OMe-2-NO₂—Ph | 119.5-120.5 |
| | Triazole-3-yl | | | | |

TABLE 11

| Compound | | | | | Melting point |
|---|---|---|---|---|---|
| No. | A | X | Z | B | (° C.) |
| 201 | 1-Naphthyl | — | Me | 4-OMe-2-NO₂—Ph | 123.0-124.0 |
| 202 | 1-Naphthyl | — | Me | 4-OMe-2-NO₂—Ph | 180.0-182.0 |
| 203 | 2-Pyridyl | — | Me | 4-OMe-2-NO₂—Ph | 100.0-101.0 |
| 204 | 8-Quinolyl | — | Me | 4-OMe-2-NO₂—Ph | 166.0-170.0 |
| 205 | 4-Me—Ph | — | Et | 4-OMe-2-NO₂—Ph | 91.0-92.0 |
| 206 | 4-Me—Ph | — | n-Pr | 4-OMe-2-NO₂—Ph | 85.0-86.0 |
| 207 | 4-Me—Ph | — | i-Pr | 4-OMe-2-NO₂—Ph | 148.0-149.5 |
| 208 | 4-Me—Ph | — | c-Pr | 4-OMe-2-NO₂—Ph | |
| 209 | 4-Me—Ph | — | n-Bu | 4-OMe-2-NO₂—Ph | Oily material⁵⁾ |
| 210 | 4-Me—Ph | — | CH₂CH═CH₂ | 4-OMe-2-NO₂—Ph | 116.5-117.5 |
| 211 | 4-Me—Ph | — | CH₂CH≡CH | 4-OMe-2-NO₂—Ph | 84.0-85.0 |
| 212 | 4-Me—Ph | — | CH₂CH≡C—I | 4-OMe-2-NO₂—Ph | |
| 213 | 4-Me—Ph | — | Ac | 4-OMe-2-NO₂—Ph | 172.5-174.0 |
| 214 | 4-Me—Ph | — | SO₂-(4- | 4-OMe-2-NO₂—Ph | 180.5-182.0 |
| | | | Me—Ph) | | |
| 215 | 4-Me—Ph | — | Me | 4-OEt-2-NO₂—Ph | 116.0-117.5 |
| 216 | 4-Me—Ph | — | Me | 4-O(n-Pr)-2-NO₂—Ph | 93.0-94.0 |
| 217 | 4-Me—Ph | — | Me | 4-O(i-Pr)-2-NO₂—Ph | 119.5-120.5 |
| 218 | 4-Me—Ph | — | Me | 4-OAc-2-NO₂—Ph | 122.5-123.5 |
| 219 | 4-Me—Ph | — | Me | 4-(OCH₂OCH₃)-2-NO₂—Ph | 110.5-112.0 |
| 220 | Ph | — | Me | 4-SMe-2-NO₂—Ph | |

⁵⁾NMR(CDCl₃) δ: 0.87(3H, t, J=7.2Hz), 1.30(2H, brq, J=7.2Hz), 1.40-1.70(2H, br), 2.43(3H, s), 3.45-3.70(2H, br), 3.87(3H, s), 6.90-7.10(2H, m), 7.26(2H, d, J=8.3Hz), 7.34(1H, d, J=2.2Hz), 7.51(2H, d, J=8.3Hz).

TABLE 12

| Com- | | | | | |
|---|---|---|---|---|---|
| pound | | | | | Melting point |
| No. | A | X | Z | B | (° C.) |
| 221 | Ph | — | Et | 4-SMe-2-NO₂—Ph | |
| 222 | Ph | — | n-Pr | 4-SMe-2-NO₂—Ph | |
| 223 | Ph | — | i-Pr | 4-SMe-2-NO₂—Ph | |
| 224 | Ph | — | c-Pr | 4-SMe-2-NO₂—Ph | |
| 225 | Ph | — | n-Bu | 4-SMe-2-NO₂—Ph | |
| 226 | 4-Me—Ph | — | Me | 4-SMe-2-NO₂—Ph | 130.0-131.0 |
| 227 | 4-Me—Ph | — | Et | 4-SMe-2-NO₂—Ph | 135.0-136.0 |
| 228 | 4-Me—Ph | — | n-Pr | 4-SMe-2-NO₂—Ph | |
| 229 | 4-Me—Ph | — | i-Pr | 4-SMe-2-NO₂—Ph | 124.5-126.0 |
| 230 | 4-Me—Ph | — | c-Pr | 4-SMe-2-NO₂—Ph | |
| 231 | 4-Me—Ph | — | n-Bu | 4-SMe-2-NO₂—Ph | |
| 232 | 4-Me—Ph | — | Me | 4-SOMe-2-NO₂—Ph | 168.5-170.5 |
| 233 | 4-Me—Ph | — | Et | 4-SOMe-2-NO₂—Ph | 115.0-117.0 |
| 234 | 4-Me—Ph | — | n-Pr | 4-SOMe-2-NO₂—Ph | |
| 235 | 4-Me—Ph | — | i-Pr | 4-SOMe-2-NO₂—Ph | 157.5-158.5 |
| 236 | 4-Me—Ph | — | c-Pr | 4-SOMe-2-NO₂—Ph | |
| 237 | 4-Me—Ph | — | n-Bu | 4-SOMe-2-NO₂—Ph | |
| 238 | 4-Me—Ph | — | Me | 4-SO₂Me-2-NO₂—Ph | 147.0-148.0 |
| 239 | 4-Me—Ph | — | Et | 4-SO₂Me-2-NO₂—Ph | 184.0-184.5 |
| 240 | 4-Me—Ph | — | n-Pr | 4-SO₂Me-2-NO₂—Ph | |

TABLE 13

| Com- | | | | | |
|---|---|---|---|---|---|
| pound | | | | | Melting |
| No. | A | X | Z | B | point (° C.) |
| 241 | 4-Me—Ph | — | i-Pr | 4-SO₂Me-2-NO₂—Ph | 178.7-179.3 |
| 242 | 4-Me—Ph | — | c-Pr | 4-SO₂Me-2-NO₂—Ph | |
| 243 | 4-Me—Ph | — | n-Bu | 4-SO₂Me-2-NO₂—Ph | |
| 244 | 4-Me—Ph | — | Me | 4-SO₂NMe₂-2-NO₂—Ph | |
| 245 | 4-Me—Ph | — | Et | 4-SO₂NMe₂-2-NO₂—Ph | |
| 246 | 4-Me—Ph | — | n-Pr | 4-SO₂NMe₂-2-NO₂—Ph | |
| 247 | 4-Me—Ph | — | i-Pr | 4-SO₂NMe₂-2-NO₂—Ph | |
| 248 | 4-Me—Ph | — | c-Pr | 4-SO₂NMe₂-2-NO₂—Ph | |
| 249 | 4-Me—Ph | — | n-Bu | 4-SO₂NMe₂-2-NO₂—Ph | |
| 250 | 4-Me—Ph | — | Me | 4-SCN-2-NO₂—Ph | |
| 251 | 4-Me—Ph | — | Et | 4-SCN-2-NO₂—Ph | |
| 252 | 4-Me—Ph | — | n-Pr | 4-SCN-2-NO₂—Ph | |
| 253 | 4-Me—Ph | — | i-Pr | 4-SCN-2-NO₂—Ph | |
| 254 | 4-Me—Ph | — | c-Pr | 4-SCN-2-NO₂—Ph | |
| 255 | 4-Me—Ph | — | n-Bu | 4-SCN-2-NO₂—Ph | |
| 256 | Ph | — | Me | 4-F-2-NO₂—Ph | |
| 257 | Ph | — | Et | 4-F-2-NO₂—Ph | |
| 258 | Ph | — | n-Pr | 4-F-2-NO₂—Ph | |
| 259 | Ph | — | i-Pr | 4-F-2-NO₂—Ph | |
| 260 | Ph | — | c-Pr | 4-F-2-NO₂—Ph | |

TABLE 14

| Compound | | | | | |
|---|---|---|---|---|---|
| No. | A | X | Y | B | Melting point (° C.) |
| 261 | Ph | — | n-Bu | 4-F-2-NO₂—Ph | |
| 262 | 4-Me—Ph | — | Me | 4-F-2-NO₂—Ph | 93.5-94.5 |
| 263 | 4-Me—Ph | — | Et | 4-F-2-NO₂—Ph | 93.0-94.5 |
| 264 | 4-Me—Ph | — | n-Pr | 4-F-2-NO₂—Ph | 96.0-98.0 |
| 265 | 4-Me—Ph | — | i-Pr | 4-F-2-NO₂—Ph | 129.0-130.0 |
| 266 | 4-Me—Ph | — | CH₂CH═CH₂ | 4-F-2-NO₂—Ph | 76.0-77.0 |
| 267 | 4-Cl—Ph | — | Me | 4-F-2-NO₂—Ph | |
| 268 | 4-Cl—Ph | — | Et | 4-F-2-NO₂—Ph | |
| 269 | 4-Cl—Ph | — | n-Pr | 4-F-2-NO₂—Ph | |
| 270 | 4-Cl—Ph | — | i-Pr | 4-F-2-NO₂—Ph | |
| 271 | 4-Cl—Ph | — | c-Pr | 4-F-2-NO₂—Ph | |
| 272 | 4-Me—Ph | — | i-Pr | 2-Cl-4-NO₂—Ph | 154.0-157.0 |
| 273 | 4-Me—Ph | — | Me | 4-F-3-NO₂—Ph | 119.0-121.0 |
| 274 | 4-Me—Ph | — | Me | 2-Cl-4-NO₂—Ph | 122.0-123.0 |
| 275 | 4-Me—Ph | — | Et | 2-Cl-4-NO₂—Ph | |
| 276 | Ph | — | Me | 4-Cl-2-NO₂—Ph | 102.5-103.5 |
| 277 | Ph | — | Et | 4-Cl-2-NO₂—Ph | 108.0-109.0 |
| 278 | Ph | — | n-Pr | 4-Cl-2-NO₂—Ph | |
| 279 | Ph | — | i-Pr | 4-Cl-2-NO₂—Ph | 129.0-130.5 |
| 280 | Ph | CH2 | Me | 4-Cl-2-NO₂—Ph | 153.5-155.0 |

TABLE 15

| Compound | | | | | Melting point |
|---|---|---|---|---|---|
| No. | A | X | Y | B | (° C.) |
| 281 | Ph | CHMe | Me | 4-Cl-2-NO₂—Ph | |
| 282 | Ph | CH═CH | Me | 4-Cl-2-NO₂—Ph | 162.0-164.0 |
| 283 | 4-Me—Ph | CMe═CH | Me | 4-Cl-2-NO₂—Ph | |
| 284 | 4-Me—Ph | — | Me | 4-Cl-2-NO—Ph | 113.0-114.5 |
| 285 | 4-Me—Ph | — | Et | 4-Cl-2-NO—Ph | |
| 286 | 4-Me—Ph | — | i-Pr | 4-Cl-2-NO—Ph | |
| 287 | 3-Me—Ph | — | Me | 4-Cl-2-NO₂—Ph | 115.5-117.0 |
| 288 | 4-Me—Ph | — | Me | 4-Cl-2-NO₂—Ph | 97.5-99.0 |
| 289 | 4-Me—Ph | — | Et | 4-Cl-2-NO₂—Ph | 132.5-134.0 |
| 290 | 4-Me—Ph | — | n-Pr | 4-Cl-2-NO₂—Ph | 88.0-89.5 |
| 291 | 4-Me—Ph | — | i-Pr | 4-Cl-2-NO₂—Ph | 112.0-114.0 |
| 292 | 4-Me—Ph | — | c-Pr | 4-Cl-2-NO₂—Ph | 98.5-100.0 |
| 293 | 4-Me—Ph | — | n-Bu | 4-Cl-2-NO₂—Ph | |
| 294 | 4-Me—Ph | — | s-Bu | 4-Cl-2-NO₂—Ph | |
| 295 | 4-Me—Ph | — | i-Bu | 4-Cl-2-NO₂—Ph | 127.5-130.0 |
| 296 | 4-Me—Ph | — | t-Bu | 4-Cl-2-NO₂—Ph | |
| 297 | 4-Me—Ph | — | CH═C═CH₂ | 4-Cl-2-NO₂—Ph | |
| 298 | 4-Me—Ph | — | CH═CH₂ | 4-Cl-2-NO₂—Ph | >108 |
| | | | | | (Decomposed) |
| 299 | 4-Me—Ph | — | CH₂CH═CH₂ | 4-Cl-2-NO₂—Ph | 77.0-78.0 |
| 300 | 4-Me—Ph | — | CH₂CH≡CH | 4-Cl-2-NO₂—Ph | 122.0-124.5 |

TABLE 16

| Compound | | | | | |
|---|---|---|---|---|---|
| No. | A | X | Z | B | Melting point (° C.) |
| 301 | 4-Me—Ph | — | CH₂CH≡C—I | 4-Cl-2-NO₂—Ph | |
| 302 | 4-Me—Ph | — | CH₂NMe₂ | 4-Cl-2-NO₂—Ph | |
| 303 | 4-Me—Ph | — | CH₂CH₂OH | 4-Cl-2-NO₂—Ph | 102.0-103.5 |
| 304 | 4-Me—Ph | — | CH₂CH₂F | 4-Cl-2-NO₂—Ph | |
| 305 | 4-Me—Ph | — | CH₂CH₂Br | 4-Cl-2-NO₂—Ph | 70.0-72.0 |
| 306 | 4-Me—Ph | — | CH₂CH₂NMe₂ | 4-Cl-2-NO₂—Ph | 108.0-109.0 |
| 307 | 4-Me—Ph | — | CH₂CH₂SMe | 4-Cl-2-NO₂—Ph | 94.5-95.5 |
| 308 | 4-Me—Ph | — | CH₂OCH₃ | 4-Cl-2-NO₂—Ph | 61.0-62.0 |
| 309 | 4-Me—Ph | — | CH₂COOMe | 4-Cl-2-NO₂—Ph | Oily material⁶⁾ |
| 310 | 4-Me—Ph | — | CH₂CN | 4-Cl-2-NO₂—Ph | |
| 311 | 4-Me—Ph | — | Ac | 4-Cl-2-NO₂—Ph | 173.0-175.0 |
| 312 | 4-Me—Ph | — | COCH₂Cl | 4-Cl-2-NO₂—Ph | 195.0-199.0 |
| 313 | 4-Me—Ph | — | COCF₃ | 4-Cl-2-NO₂—Ph | |
| 314 | 4-Me—Ph | — | NMe₂ | 4-Cl-2-NO₂—Ph | |
| 315 | 4-Me—Ph | — | NHAc | 4-Cl-2-NO₂—Ph | |
| 316 | 4-Me—Ph | — | NHCOOMe | 4-Cl-2-NO₂—Ph | |
| 317 | 4-Me—Ph | — | N═CMe₂ | 4-Cl-2-NO₂—Ph | |
| 318 | 4-Me—Ph | — | SCCl₂F | 4-Cl-2-NO₂—Ph | |
| 319 | 4-Me—Ph | — | SCF₃ | 4-Cl-2-NO₂—Ph | |
| 320 | 4-Me—Ph | — | SCCl₃ | 4-Cl-2-NO₂—Ph | |

⁶⁾NMR(CDCl₃) δ: 2.43(3H, s), 3.74(3H, s), 4.59(2H, brs), 7.24(2H, d, J=8.4Hz), 7.40-7.60(3H, m), 7.71(1H, d, J=8.6Hz), 7.83(1H, d, J=2.3Hz).

TABLE 17

| Com- | | | | | |
|---|---|---|---|---|---|
| pound | | | | | Melting |
| No. | A | X | Z | B | point (° C.) |
| 321 | 4-Me—Ph | — | SOCF₃ | 4-Cl-2-NO₂—Ph | |
| 322 | 4-Me—Ph | — | SO₂Me | 4-Cl-2-NO₂—Ph | 163.5-165.5 |
| 323 | 4-Me—Ph | — | SO₂- | 4-Cl-2-NO₂—Ph | 205.0-206.5 |
| | | | (4-Me—Ph) | | |
| 324 | 4-Me—Ph | — | Ph | 4-Cl-2-NO₂—Ph | 157.0-159.0 |
| 325 | 4-Et—Ph | — | Me | 4-Cl-2-NO₂—Ph | 100.0-101.5 |
| 326 | 4-Et—Ph | — | Et | 4-Cl-2-NO₂—Ph | 123.0-125.0 |
| 327 | 4-Et—Ph | — | n-Pr | 4-Cl-2-NO₂—Ph | |
| 328 | 4-Et—Ph | — | i-Pr | 4-Cl-2-NO₂—Ph | 117.0-118.5 |
| 329 | 4-F—Ph | — | Me | 4-Cl-2-NO₂—Ph | 140.5-141.5 |
| 330 | 4-F—Ph | — | Et | 4-Cl-2-NO₂—Ph | 155.5-156.5 |
| 331 | 4-F—Ph | — | n-Pr | 4-Cl-2-NO₂—Ph | |
| 332 | 4-F—Ph | — | i-Pr | 4-Cl-2-NO₂—Ph | 122.0-123.0 |
| 333 | 4-F—Ph | — | c-Pr | 4-Cl-2-NO₂—Ph | |
| 334 | 4-F—Ph | — | n-Bu | 4-Cl-2-NO₂—Ph | |
| 335 | 2-Cl—Ph | — | Me | 4-Cl-2-NO₂—Ph | 116.0-117.0 |
| 336 | 3-Cl—Ph | — | Me | 4-Cl-2-NO₂—Ph | 136.5-138.5 |
| 337 | 4-Cl—Ph | — | Me | 4-Cl-2-NO₂—Ph | 158.5-160.5 |
| 338 | 4-Cl—Ph | — | Et | 4-Cl-2-NO₂—Ph | 121.5-123.0 |
| 339 | 4-Cl—Ph | — | n-Pr | 4-Cl-2-NO₂—Ph | |
| 340 | 4-Cl—Ph | — | i-Pr | 4-Cl-2-NO₂—Ph | 99.5-100.5 |

TABLE 18

| Compound | | | | | |
|---|---|---|---|---|---|
| No. | A | X | Z | B | Melting point (° C.) |
| 341 | 4-Cl—Ph | — | c-Pr | 4-Cl-2-NO₂—Ph | |
| 342 | 4-Cl—Ph | — | n-Bu | 4-Cl-2-NO₂—Ph | |
| 343 | 4-Cl—Ph | — | CH₂CH═CH₂ | 4-Cl-2-NO₂—Ph | |
| 344 | 4-Cl—Ph | — | CH₂C≡CH | 4-Cl-2-NO₂—Ph | |
| 345 | 4-Cl—Ph | — | CH₂C≡C—I | 4-Cl-2-NO₂—Ph | |
| 346 | 4-Cl—Ph | — | Ph | 4-Cl-2-NO₂—Ph | |
| 347 | 3,4-Cl₂—Ph | — | Me | 4-Cl-2-NO₂—Ph | 140.5-142.0 |
| 348 | 4-Br—Ph | — | Me | 4-Cl-2-NO₂—Ph | 155.5-157.5 |
| 349 | 4-Br—Ph | — | Et | 4-Cl-2-NO₂—Ph | |
| 350 | 4-Br—Ph | — | n-Pr | 4-Cl-2-NO₂—Ph | |
| 351 | 4-Br—Ph | — | i-Pr | 4-Cl-2-NO₂—Ph | |
| 352 | 4-Br—Ph | — | c-Pr | 4-Cl-2-NO₂—Ph | |
| 353 | 4-Br—Ph | — | n-Bu | 4-Cl-2-NO₂—Ph | |
| 354 | 3-CN—Ph | — | Et | 4-Cl-2-NO₂—Ph | 165.0-166.5 |
| 355 | 4-CN—Ph | — | Me | 4-Cl-2-NO₂—Ph | |
| 356 | 4-CN—Ph | — | Et | 4-Cl-2-NO₂—Ph | 146.0-148.0 |
| 357 | 4-CN—Ph | — | n-Pr | 4-Cl-2-NO₂—Ph | |
| 358 | 4-CN—Ph | — | i-Pr | 4-Cl-2-NO₂—Ph | |
| 359 | 4-CN—Ph | — | c-Pr | 4-Cl-2-NO₂—Ph | |
| 360 | 4-CN—Ph | — | n-Bu | 4-Cl-2-NO₂—Ph | |

TABLE 19

| Compound | | | | | Melting point |
|---|---|---|---|---|---|
| No. | A | X | Z | B | (° C.) |
| 361 | 3-CF₃—Ph | — | Me | 4-Cl-2-NO₂—Ph | 120.5-122.0 |
| 362 | 4-CF₃—Ph | — | Et | 4-Cl-2-NO₂—Ph | 105.0-106.0 |
| 363 | 4-OCF₃—Ph | — | Me | 4-Cl-2-NO₂—Ph | 117.0-118.0 |
| 364 | 5-Me-2-Thienyl | — | Me | 4-Cl-2-NO₂—Ph | |
| 365 | 5-Me-2-Thienyl | — | Et | 4-Cl-2-NO₂—Ph | |
| 366 | 5-Me-2-Thienyl | — | n-Pr | 4-Cl-2-NO₂—Ph | |
| 367 | 5-Me-2-Thienyl | — | i-Pr | 4-Cl-2-NO₂—Ph | |
| 368 | 5-Me-2-Thienyl | — | c-Pr | 4-Cl-2-NO₂—Ph | |
| 369 | 5-Me-2-Thienyl | — | n-Bu | 4-Cl-2-NO₂—Ph | |
| 370 | 5-Cl-2-Thienyl | — | Me | 4-Cl-2-NO₂—Ph | 85.0-86.0 |
| 371 | 5-Cl-2-Thienyl | — | Et | 4-Cl-2-NO₂—Ph | 95.0-96.0 |
| 372 | 5-Cl-2-Thienyl | — | n-Pr | 4-Cl-2-NO₂—Ph | |
| 373 | 5-Cl-2-Thienyl | — | i-Pr | 4-Cl-2-NO₂—Ph | |
| 374 | 5-Cl-2-Thienyl | — | c-Pr | 4-Cl-2-NO₂—Ph | |
| 375 | 5-Cl-2-Thienyl | — | n-Bu | 4-Cl-2-NO₂—Ph | |
| 376 | 3,5-Me₂-4-Isoxazolyl | — | Me | 4-Cl-2-NO₂—Ph | 99.0-101.0 |
| 377 | 5-Cl-1,3-Me₂-4-Pyrazolyl | — | Me | 4-Cl-2-NO₂—Ph | 102.0-103.0 |
| 378 | 1-Me-4-COOMe-5- | — | Me | 4-Cl-2-NO₂—Ph | |
| | Pyrazolyl | | | | |
| 379 | 1,3-Me₂-4-COOH-5- | — | Me | 4-Cl-2-NO₂—Ph | 236.5-237.5 |
| | Pyrazolyl | | | | |
| 380 | 1,3-Me₂-4-COOMe-5- | — | Me | 4-Cl-2-NO₂—Ph | 129.0-130.5 |
| | Pyrazolyl | | | | |

TABLE 20

| Compound | | | | | Melting point |
|---|---|---|---|---|---|
| No. | A | X | Z | B | (° C.) |
| 381 | 1,3-Me₂-4-CONH₂-5- | — | Me | 4-Cl-2-NO₂—Ph | 164.0-164.5 |
| | Pyrazolyl | | | | |
| 382 | 1,3-Me₂-4-CN-5- | — | Me | 4-Cl-2-NO₂—Ph | 109.0-110.5 |
| | Pyrazolyl | | | | |
| 383 | 3-Cl-1-Me-4- | — | Me | 4-Cl-2-NO₂—Ph | |
| | COOMe-5-Pyrazolyl | | | | |
| 384 | 1-Me-4-Imidazolyl | — | Me | 4-Cl-2-NO₂—Ph | 199.0-201.5 |
| 385 | 1,2,4-Triazole-3-yl | — | Me | 4-Cl-2-NO₂—Ph | 219.5-220.0 |
| 386 | 2-Pyridyl | — | Me | 4-Cl-2-NO₂—Ph | 127.0-128.0 |
| 387 | 3-Pyridyl | — | Me | 4-Cl-2-NO₂—Ph | 125.5-127.5 |
| 388 | 2,1,3-Benzothiazole- | — | Me | 4-Cl-2-NO₂—Ph | 124.5-126.5 |
| | 4-yl | | | | |
| 389 | 2-Cl-Imidazo[1,2- | — | Me | 4-Cl-2-NO₂—Ph | |
| | a]pyridine-3-yl | | | | |
| 390 | 2-SO₂Et-Imidazo[1,2- | — | Me | 4-Cl-2-NO₂—Ph | |
| | a]pyridine-3-yl | | | | |
| 391 | 6-Cl-Imidazo[2,1- | — | Me | 4-Cl-2-NO₂—Ph | 168.0-172.0 |
| | b]thiazole-5-yl | | | | |
| 392 | 8-Quinolyl | — | Me | 4-Cl-2-NO₂—Ph | 177.0-178.5 |
| 393 | 4-Me—Ph | — | Me | 4-Cl-2—(NO═N—CN)—Ph | 140.0-142.0 |
| 394 | 4-Me—Ph | — | Et | 4-Cl-2—(NO═N—CN)—Ph | |
| 395 | 4-Me—Ph | — | i-Pr | 4-Cl-2—(NO═N—CN)—Ph | |
| 396 | 4-Me—Ph | — | Me | 4-Cl-3—NO₂—Ph | 106.0-107.0 |
| 397 | 4-Me—Ph | — | Me | 5-Cl-2-NO₂—Ph | 118.0-120.0 |
| 398 | 4-Me—Ph | — | Me | 4-Br-2-NO₂—Ph | 108.0-110.5 |
| 399 | 4-Me—Ph | — | Et | 4-Br-2-NO₂—Ph | |
| 400 | 4-Me—Ph | — | n-Pr | 4-Br-2-NO₂—Ph | |

TABLE 21

| Com- | | | | | |
|---|---|---|---|---|---|
| pound | | | | | Melting point |
| No. | A | X | Z | B | (° C.) |
| 401 | 4-Me—Ph | — | i-Pr | 4-Br-2-NO₂—Ph | |
| 402 | 4-Me—Ph | — | c-Pr | 4-Br-2-NO₂—Ph | |
| 403 | 4-Me—Ph | — | n-Bu | 4-Br-2-NO₂—Ph | |
| 404 | 4-Me—Ph | — | Me | 4-Br-3-NO₂—Ph | 93.0-94.5 |
| 405 | 4-Me—Ph | — | Me | 4-I-2-NO₂—Ph | |
| 406 | 4-Me—Ph | — | Me | 4-CN-2-NO₂—Ph | 123.0-124.5 |
| 407 | 4-Me—Ph | — | Et | 4-CN-2-NO₂—Ph | 158.0-160.0 |
| 408 | 4-Me—Ph | — | n-Pr | 4-CN-2-NO₂—Ph | |
| 409 | 4-Me—Ph | — | i-Pr | 4-CN-2-NO₂—Ph | 125.0-126.0 |
| 410 | 4-Me—Ph | — | c-Pr | 4-CN-2-NO₂—Ph | |
| 411 | 4-Cl—Ph | — | Me | 4-CN-2-NO₂—Ph | 159.5-160.5 |
| 412 | 4-Cl—Ph | — | Et | 4-CN-2-NO₂—Ph | 172.5-174.5 |
| 413 | 4-Cl—Ph | — | i-Pr | 4-CN-2-NO₂—Ph | 167.5-168.5 |
| 414 | 4-CN—Ph | — | Et | 4-CN-2-NO₂—Ph | 171.0-172.0 |
| 415 | 5-Cl-2-Thienyl | — | Et | 4-CN-2-NO₂—Ph | 101.5-103.0 |
| 416 | Ph | — | Me | 2-CN-4-NO₂—Ph | |
| 417 | Ph | — | Et | 2-CN-4-NO₂—Ph | |
| 418 | Ph | — | i-Pr | 2-CN-4-NO₂—Ph | |
| 419 | 4-Me—Ph | — | Me | 2-CN-4-NO₂—Ph | 165.0-167.0 |
| 420 | 4-Me—Ph | — | Et | 2-CN-4-NO₂—Ph | 135.0-136.5 |

TABLE 22

| | | | | | Melting point |
|---|---|---|---|---|---|
| Compound No. | A | X | Z | B | (° C.) |
| 421 | 4-Me—Ph | — | i-Pr | 2-CN-4-NO₂—Ph | 140.5-142.5 |
| 422 | 4-Me—Ph | — | Me | 2-NO₂-4-OCF₃—Ph | 91.0-92.0 |
| 423 | 4-Me—Ph | — | Me | 2-NO₂-4-CF₃—Ph | 145.5-147.0 |
| 424 | 4-Me—Ph | — | Et | 2-NO₂-4-CF₃—Ph | |
| 425 | Ph | — | Me | 2,4-(NO₂)₂—Ph | 151.5-153.0 |
| 426 | Ph | — | Et | 2,4-(NO₂)₂—Ph | 129.5-131.0 |
| 427 | Ph | — | n-Pr | 2,4-(NO₂)₂—Ph | |
| 428 | Ph | — | i-Pr | 2,4-(NO₂)₂—Ph | |
| 429 | Ph | — | c-Pr | 2,4-(NO₂)₂—Ph | 166.0-168.0 |
| 430 | Ph | — | n-Bu | 2,4-(NO₂)₂—Ph | |
| 431 | Ph | — | CH₂CH═CH₂ | 2,4-(NO₂)₂—Ph | |
| 432 | Ph | — | Ph | 2,4-(NO₂)₂—Ph | |
| 433 | Ph | — | NMe₂ | 2,4-(NO₂)₂—Ph | |
| 434 | 4-Me—Ph | — | Me | 2,4-(NO₂)₂—Ph | 130.5-133.0 |
| 435 | 4-Me—Ph | — | Et | 2,4-(NO₂)₂—Ph | 135.0-136.5 |
| 436 | 4-Me—Ph | — | n-Pr | 2,4-(NO₂)₂—Ph | |
| 437 | 4-Me—Ph | — | i-Pr | 2,4-(NO₂)₂—Ph | 141.5-142.5 |
| 438 | 4-Me—Ph | — | c-Pr | 2,4-(NO₂)₂—Ph | 113.0-114.5 |
| 439 | 4-Me—Ph | — | n-Bu | 2,4-(NO₂)₂—Ph | |
| 440 | 4-Me—Ph | — | s-Bu | 2,4-(NO₂)₂—Ph | |

TABLE 23

| Compound | | | | | Melting point |
|---|---|---|---|---|---|
| No. | A | X | Z | B | (° C.) |
| 441 | 4-Me—Ph | — | i-Bu | 2,4-(NO₂)₂—Ph | |
| 442 | 4-Me—Ph | — | t-Bu | 2,4-(NO₂)₂—Ph | |
| 443 | 4-Me—Ph | — | CH₂CH═CH₂ | 2,4-(NO₂)₂—Ph | |
| 444 | 4-Me—Ph | — | CH₂C≡CH | 2,4-(NO₂)₂—Ph | |
| 445 | 4-Me—Ph | — | CH₂C≡C—I | 2,4-(NO₂)₂—Ph | |
| 446 | 4-Me—Ph | — | NMe₂ | 2,4-(NO₂)₂—Ph | |
| 447 | 4-Me—Ph | — | N═CMe₂ | 2,4-(NO₂)₂—Ph | >175 |
| | | | | | (Decomposed) |
| 448 | 4-F—Ph | — | Me | 2,4-(NO₂)₂—Ph | 172.0-173.5 |
| 449 | 4-Cl—Ph | — | Me | 2,4-(NO₂)₂—Ph | 135.0-137.0 |
| 450 | 4-Cl—Ph | — | Et | 2,4-(NO₂)₂—Ph | |
| 451 | 4-Cl—Ph | — | n-Pr | 2,4-(NO₂)₂—Ph | |
| 452 | 4-Cl—Ph | — | i-Pr | 2,4-(NO₂)₂—Ph | |
| 453 | 4-Cl—Ph | — | c-Pr | 2,4-(NO₂)₂—Ph | |
| 454 | 4-Cl—Ph | — | n-Bu | 2,4-(NO₂)₂—Ph | |
| 455 | 4-CN—Ph | — | Et | 2,4-(NO₂)₂—Ph | 150.5-152.0 |
| 456 | 5-Cl-2-Thienyl | — | Me | 2,4-(NO₂)₂—Ph | 156.0-157.5 |
| 457 | 5-Cl-2-Thienyl | — | Et | 2,4-(NO₂)₂—Ph | 109.0-111.0 |
| 458 | 5-Cl-2-Thienyl | — | n-Pr | 2,4-(NO₂)₂—Ph | |
| 459 | 5-Cl-2-Thienyl | — | i-Pr | 2,4-(NO₂)₂—Ph | |
| 460 | 5-Cl-2-Thienyl | — | n-Bu | 2,4-(NO₂)₂—Ph | |

TABLE 24

| Compound | | | | | |
|---|---|---|---|---|---|
| No. | A | X | Z | B | Melting point (° C.) |
| 461 | 4-Me—Ph | — | Me | 4,5-(OMe)₂-2-NO₂—Ph | 179.0-181.0 |
| 462 | 4-Me—Ph | — | Me | 4,5-(OCH₂O)-2-NO₂—Ph | 181.0-182.0 |
| 463 | 4-Me—Ph | — | Me | 4,5-(OCF₂O)-2-NO₂—Ph | |
| 464 | 4-Me—Ph | — | Me | 4,5-Cl₂-2-NO₂—Ph | 185.0-187.0 |
| 465 | 4-Me—Ph | — | Me | 4-Cl-2,6-(NO₂)₂—Ph | 168.5-169.5 |
| 466 | 4-Me—Ph | — | Et | 4-Cl-2,6-(NO₂)₂—Ph | |
| 467 | 4-Me—Ph | — | n-Pr | 4-Cl-2,6-(NO₂)₂—Ph | |
| 468 | 4-Me—Ph | — | i-Pr | 4-Cl-2,6-(NO₂)₂—Ph | |
| 469 | 4-Me—Ph | — | c-Pr | 4-Cl-2,6-(NO₂)₂—Ph | |
| 470 | 4-Me—Ph | — | Me | 2,6-(NO₂)₂-4-CF₃—Ph | 176.5-177.5 |
| 471 | 4-Me—Ph | — | Me | 2-NO₂-1-Naphthyl | |
| 472 | 4-Me—Ph | — | Me | 1-NO₂-2-Naphthyl | |
| 473 | 4-Me—Ph | — | Me | 3,5-Cl₂-2-Thienyl | |
| 474 | 4-Me—Ph | — | Et | 3,5-Cl₂-2-Thienyl | |
| 475 | 4-Me—Ph | — | i-Pr | 3,5-Cl₂-2-Thienyl | |
| 476 | 4-Me—Ph | — | Me | 5-Cl-3-NO₂-2-Thienyl | |
| 477 | 4-Me—Ph | — | Et | 5-Cl-3-NO₂-2-Thienyl | |
| 478 | 4-Me—Ph | — | i-Pr | 5-Cl-3-NO₂-2-Thienyl | |
| 479 | 4-Me—Ph | — | Me | 1-Me-4-CN-5-Pyrazolyl | |
| 480 | 4-Me—Ph | — | Me | 1,3-Me₂-4-NO₂-5-Pyrazolyl | |

TABLE 25

| Compound | | | | | |
|---|---|---|---|---|---|
| No. | A | X | Z | B | Melting point (° C.) |
| 481 | 4-Me—Ph | — | Me | 1-Me-5-NO₂-4-Imidazolyl | |
| 482 | 4-Me—Ph | — | Me | 2-Me-5-CN-4-Thiazolyl | |
| 483 | 4-Me—Ph | — | Me | 2-SMe-5-CN-4-Thiazolyl | |
| 484 | 4-Me—Ph | — | Me | 2-Cl-5-CN-4-Thiazolyl | |
| 485 | 4-Me—Ph | — | Me | 2-Me-5-CF₃-4-Thiazolyl | |
| 486 | 4-Me—Ph | — | Me | 2-Me-5-NO₂-4-Thiazolyl | |
| 487 | 4-Me—Ph | — | Me | 2-Cl-5-NO₂-4-Thiazolyl | |
| 488 | 4-Me—Ph | — | Me | 3-OMe-4-CF₃-5-Isothiazolyl | |
| 489 | 4-Me—Ph | — | Me | 3-Me-4-CN-5-Isothiazolyl | |
| 490 | 4-Me—Ph | — | Me | 3-Me-4-NO₂-5-Isothiazolyl | |
| 491 | 4-Me—Ph | — | Me | 5-Cl-2-Pyridyl | 74.0-75.0 |
| 492 | 4-Me—Ph | — | Me | 6-Cl-3-Pyridyl | |
| 493 | 4-Me—Ph | — | Me | 3-NO₂-2-Pyridyl | 118.5-119.5 |
| 494 | 4-Me—Ph | — | Me | 5-Cl-3-NO₂-2-Pyridyl | 141.0-143.0 |
| 495 | 4-Me—Ph | — | Et | 5-Cl-3-NO₂-2-Pyridyl | |
| 496 | 4-Me—Ph | — | n-Pr | 5-Cl-3-NO₂-2-Pyridyl | |
| 497 | 4-Me—Ph | — | i-Pr | 5-Cl-3-NO₂-2-Pyridyl | |
| 498 | 4-Me—Ph | — | c-Pr | 5-Cl-3-NO₂-2-Pyridyl | |
| 499 | 4-Me—Ph | — | n-Bu | 5-Cl-3-NO₂-2-Pyridyl | |
| 500 | 4-Me—Ph | — | Me | 6-Me-4-NO₂-2-Pyridyl | |

TABLE 26

| Compound | | | | | Melting point |
|---|---|---|---|---|---|
| No. | A | X | Z | B | (° C.) |
| 501 | 4-Me—Ph | — | Me | 6-OMe—4-NO₂-2-Pyridyl | |
| 502 | 4-Me—Ph | — | Me | 6-Cl-4-NO₂-2-Pyridyl | |
| 503 | 4-Me—Ph | — | Me | 3,5-(NO₂)₂-2-Pyridyl | Amorphous⁷⁾ |
| 504 | 4-Me—Ph | — | Me | 6-Cl-3-Pyridaznyl | 80.0-81.0 |
| 505 | 4-Me—Ph | — | Et | 6-Cl-3-Pyridazinyl | |
| 506 | 4-Me—Ph | — | n-Pr | 6-Cl-3-Pyridazinyl | |
| 507 | 4-Me—Ph | — | i-Pr | 6-Cl-3-Pyridazinyl | |
| 508 | 4-Me—Ph | — | c-Pr | 6-Cl-3-Pyridazinyl | |
| 509 | 4-Me—Ph | — | n-Bu | 6-Cl-3-Pyridazinyl | |
| 510 | 1-Me—4- | — | Me | 6-Cl-3-Pyridazinyl | 183.5-184.5 |
| | Imidazolyl | | | | |
| 511 | 4-Me—Ph | — | Me | 5-Cl-2-Pyrimidinyl | 136.0-139.0 |
| 512 | 4-Me—Ph | — | Et | 5-Cl-2-Pyrimidinyl | |
| 513 | 4-Me—Ph | — | n-Pr | 5-Cl-2-Pyrimidinyl | |
| 514 | 4-Me—Ph | — | i-Pr | 5-Cl-2-Pyrimidinyl | |
| 515 | 4-Me—Ph | — | c-Pr | 5-Cl-2-Pyrimidinyl | |
| 516 | 4-Me—Ph | — | n-Bu | 5-Cl-2-Pyrimidinyl | |
| 517 | 4-Me—Ph | — | Me | 6-Cl-4-Pyrimidinyl | 99.5-100.5 |
| 518 | 4-Me—Ph | — | Me | 5-Cl-6-Me-4-Pyrimidinyl | 162.0-164.0 |
| 519 | 4-Me—Ph | — | Me | 3-NO₂-2-Imidazo[1,2-a]pyridyl | 169.5-171.0 |
| 520 | 4-Me—Ph | — | Et | 3-NO₂-2-Imidazo[1,2-a]pyridyl | |

⁷⁾NMR(CDCl₃) δ: 2.45(3H, s), 3.28(3H, s), 7.32(2H, d, J = 8.3Hz), 7.48(2H, d, J = 8.3Hz), 9.06(1H, d, J = 2.5Hz), 9.33(1H, d, J = 2.5Hz).

TABLE 27

| Compound | | | | | |
|---|---|---|---|---|---|
| No. | A | X | Z | B | Melting point (° C.) |
| 521 | 4-Me—Ph | — | OMe | 4-NO₂—Ph | 142.5-144.5 |
| 522 | 4-Me—Ph | — | OMe | 2-Me-4-NO₂—Ph | 118.0-119.0 |
| 523 | 4-Me—Ph | — | OMe | 2-F-4-NO₂—Ph | 154.0-155.5 |
| 524 | 4-Cl-3-CF₃—Ph | — | OMe | 2-F-4-NO₂—Ph | 104.5-105.5 |
| 525 | 4-Me—Ph | — | OMe | 2-Cl-4-NO₂—Ph | 126.0-127.5 |
| 526 | 4-Cl—Ph | — | OMe | 2-Cl-4-NO₂—Ph | 150.0-151.0 |
| 527 | 3,4-Cl₂—Ph | — | OMe | 2-Cl-4-NO₂—Ph | 132.0-133.0 |
| 528 | 2,5-Cl₂—Ph | — | OMe | 2-Cl-4-NO₂—Ph | 136.0-138.0 |
| 529 | 3-CF₃—Ph | — | OMe | 2-Cl-4-NO₂—Ph | 95.5-96.5 |
| 530 | 3-NO₂—Ph | — | OMe | 2-Cl-4-NO₂—Ph | 167.5-169.0 |
| 531 | 4-Cl-3-NO₂—Ph | — | OMe | 2-Cl-4-NO₂—Ph | 138.0-139.0 |
| 532 | 4-Cl-3-CF₃—Ph | — | OMe | 2-Cl-4-NO₂—Ph | 111.5-113.0 |
| 533 | 4-Me—Ph | — | OEt | 2-Cl-4-NO₂—Ph | 133.5-135.0 |
| 534 | 4-Me—Ph | — | O(i-Pr) | 2-Cl-4-NO₂—Ph | 160.5-162.0 |
| 535 | 4-Me—Ph | — | OMe | 2-CN-4-NO₂—Ph | 148.0-149.5 |
| 536 | 4-Cl-3-CF₃—Ph | — | OMe | 2-CN-4-NO₂—Ph | 140.5-142.0 |
| 537 | 5-Cl-2-Thienyl | — | OMe | 2-CN-4-NO₂—Ph | 144.0-146.0 |
| 538 | 4-Me—Ph | — | OMe | 2-CF₃-4-NO₂—Ph | 123.0-124.5 |
| 539 | 4-Me—Ph | — | OMe | 2-NO₂—Ph | 104.5-105.5 |
| 540 | 4-Me—Ph | — | OMe | 4-Cl-2-NO₂—Ph | 114.0-115.0 |

TABLE 28

| Compound | | | | | |
|---|---|---|---|---|---|
| No. | A | X | Z | B | Melting point (° C.) |
| 541 | 2,5-Cl₂—Ph | — | OMe | 4-Cl-2-NO₂—Ph | >180 |
| | | | | | (Decomposed) |
| 542 | 3-CF₃—Ph | — | OMe | 4-Cl-2-NO₂—Ph | 84.5-85.5 |
| 543 | 4-Cl-3-CF₃—Ph | — | OMe | 4-Cl-2-NO₂—Ph | 108.0-109.0 |
| 544 | 4-Me—Ph | — | OMe | 2-Cl-4-CF₃—Ph | 131.0-132.5 |
| 545 | 4-Me—Ph | — | OMe | 2,4-(NO₂)₂—Ph | 146.0-148.0 |
| 546 | 4-Me—Ph | — | OEt | 2,4-(NO₂)₂—Ph | |
| 547 | 4-Me—Ph | — | OAc | 2,4-(NO₂)₂—Ph | |
| 548 | 4-Cl—Ph | — | OMe | 2,4-(NO₂)₂—Ph | |
| 549 | 2,5-Cl₂—Ph | — | OMe | 2,4-(NO₂)₂—Ph | 153.0-155.0 |
| 550 | 3-CF₃—Ph | — | OMe | 2,4-(NO₂)₂—Ph | 130.5-132.0 |
| 551 | 4-Cl-3-CF₃—Ph | — | OMe | 2,4-(NO₂)₂—Ph | 108.0-109.5 |
| 552 | 5-Cl-1,3-Me₂-4- | — | OMe | 2,4-(NO₂)₂—Ph | 189.0-191.0 |
| | Pyrazolyl | | | | |
| 553 | 4-Me—Ph | — | OMe | 3-Cl-5-CF₃-2- | 99.0-100.0 |
| | | | | Pyridyl | |
| 554 | 4-Me—Ph | — | OMe | 5-NO₂-2-Pyridyl | 96.0-97.0 |
| 555 | 4-Me—Ph | — | OMe | 6-Cl-3-Pyridazinyl | 91.5-92.5 |
| 556 | 4-Me—Ph | — | OMe | 6-CN-3-Pyridazinyl | 112.0-113.0 |
| 557 | 4-Me—Ph | — | OMe | 5-NO₂-2-Thiazoyl | 135.0-138.5 |
| 558 | 4-Me—Ph | — | OMe | 4-CF₃-2-Thiazoyl | 107.0-108.5 |
| 559 | 4-Me—Ph | — | OMe | 5-CF₃- | 84.0-85.5 |
| | | | | 1,3,Thiadiazole-2-yl | |
| 560 | 4-Me—Ph | — | OMe | 4-CN-3-OMe-5- | 115.5-118.0 |
| | | | | Isothiazolyl | |

TABLE 29

| Com- | | | | | |
|---|---|---|---|---|---|
| pound | | | | | Melting point |
| No. | A | X | Z | B | (° C.) |
| 561 | Ph | — | OMe | 2,4-(NO₂)₂—Ph | 161.0-163.5 |
| 562 | 3-Me—Ph | — | OMe | 2,4-(NO₂)₂—Ph | 147.5-149.5 |
| 563 | 2-Cl—Ph | — | OMe | 2,4-(NO₂)₂—Ph | 112.5-114.0 |
| 564 | 3-Cl—Ph | — | OMe | 2.4-(NO₂)₂—Ph | 157.0-159.0 |
| 565 | 4-CF₃—Ph | — | OMe | 2-CN-4-NO₂—Ph | 133.5-135.0 |
| 566 | 4-Me—Ph | — | OMe | 2-Cl-4-CN—Ph | 145.0-147.0 |
| 567 | 4-F—Ph | — | OMe | 2,4-(NO₂)₂—Ph | 118.0-119.5 |
| 568 | 4-Et—Ph | — | OMe | 2,4-(NO₂)₂—Ph | 90.0-92.0 |
| 569 | 4-Me—Ph | — | OMe | 4-CN-2-NO₂—Ph | 126.0-128.0 |
| 570 | 4-NO₂—Ph | — | OMe | 2,4-(NO₂)₂—Ph | 117.0-119.0 |
| 571 | 4-Me—Ph | — | OMe | 2-CN-4-SMe—Ph | 146.8-147.6 |
| 572 | 4-Me—Ph | — | OMe | 4-SMe-2-NO₂—Ph | 110.3-110.8 |

### Formation Example 1

The following were mixed, and the mixture was pulverized in a wet manner with Dynomill KDL so as to produce a homogeneous suspension (flowable agent): a compound No. 490 (11% by weight), picoxystrobin (5% by weight), ethylene glycol (12% by weight), Antifoam E20 (0.2% by weight), butylparaben (0.1% by weight), Noygen EA-177 (2% by weight), New Calgen FS-7(2% by weight), Kunipia F (1% by weight), Celogen 7A (1.5% by weight), and water (65.2% by weight).

### Formulation Example 2

The following were mixed, and the mixture was pulverized in a wet manner with Dynomill KDL so as to produce a homogeneous suspension (flowable agent): a compound No. 258 (11 parts), picoxystrobin (5 parts), ethylene glycol (12 parts), Antifoam E20 (0.2 part), butylparaben (0.1 part), Noygen EA-177 (2 parts), New Calgen FS-7(2 parts), Kunipia F (1 part), polyvinyl alcohol (1 part), and water (65.7 parts).

### Formulation Example 3

The following were mixed, and the mixture was pulverized in a wet manner with Dynomill KDL so as to produce a homogeneous suspension (flowable agent): a compound No. 289 (11 parts), trifloxystrobin (5 parts), ethylene glycol (12 parts), Antifoam E20 (0.2 part), butylparaben (0.1 part), Noygen EA-177 (2 parts), New Calgen FS-7(2 parts), Kunipia F (1 part), polyvinyl alcohol (1 part), and water (65.7 parts).

### Formulation Example 4

The following were mixed, and the mixture was pulverized in a wet manner with Dynomill KDL so as to produce a homogeneous suspension (flowable agent): a compound No. 289 (11 parts), pyraclostrobin (5 parts), ethylene glycol (12 parts), Antifoam E20 (0.2 part), butylparaben (0.1 part), Noygen EA-177 (2 parts), New Calgen FS-7(2 parts), Kunipia F (1 part), polyvinyl alcohol (1 part), and water (65.7 parts).

### Formulation Example 5

The following were mixed, and the mixture was pulverized in a wet manner with Dynomill KDL so as to produce a homogeneous suspension (flowable agent): a compound No. 289 (11 parts), epoxiconazole (10 parts), ethylene glycol (12 parts), Antifoam E20 (0.2 part), butylparaben (0.1 part), Noygen EA-177 (2 parts), New Calgen FS-7(2 parts), Kunipia F (1 part), polyvinyl alcohol (1 part), and water (60.7 parts).

### Formulation Example 6

The following were mixed, and the mixture was pulverized in a wet manner with Dynomill KDL so as to produce a homogeneous suspension (flowable agent): a compound No. 289 (11 parts), epoxiconazole (10 parts), pyraclostrobin (5 parts), ethylene glycol (12 parts), Antifoam E20 (0.2 part), butylparaben (0.1 part), Noygen EA-177 (2 parts), New Calgen FS-7(2 parts), Kunipia F (1 part), polyvinyl alcohol (1 part), and water (55.7 parts).

### Formulation Example 7

The following were mixed, and the mixture was pulverized in a wet manner with Dynomill KDL so as to produce a homogeneous suspension (flowable agent): a compound No. 289 (11 parts), flusilazole (10 parts), ethylene glycol (12 parts), Antifoam E20 (0.2 part), butylparaben (0.1 part), Noygen EA-177 (2 parts), New Calgen FS-7(2 parts), Kunipia F (1 part), polyvinyl alcohol (1 part), and water (60.7 parts).

### Formulation Example 8

The following were mixed, and the mixture was pulverized in a wet manner with Dynomill KDL so as to produce a homogeneous suspension (flowable agent): a compound No. 289 (11 parts), iprovlicarb (10 parts), ethylene glycol (12 parts), Antifoam E20 (0.2 part), butylparaben (0.1 part), Noygen EA-177 (2 parts), New Calgen FS-7(2 parts), Kunipia F (1 part), polyvinyl alcohol (1 part), and water (60.7 parts).

### Formulation Example 9

The following were mixed, and the mixture was pulverized in a wet manner with Dynomill KDL so as to produce a homogeneous suspension (flowable agent): a compound No. 258 (11 parts), tebuconasole (10 parts), ethylene glycol (12 parts), Antifoam E20 (0.2 part), butylparaben (0.1 part), Noygen EA-177 (2 parts), New Calgen FS-7(2 parts), Kunipia F (1 part), polyvinyl alcohol (1 part), and water (60.7 parts).

### Formulation Example 10

The following were mixed, and the mixture was pulverized in a wet manner with Dynomill KDL so as to produce a homogeneous suspension (flowable agent): a compound No. 289 (11 parts), cresoxime methyl (10 parts), ethylene glycol (12 parts), Antifoam E20 (0.2 part), butylparaben (0.1 part), Noygen EA-177 (2 parts), New Calgen FS-7 (2 parts), Kunipia F (1 part), polyvinyl alcohol (1 part), and water (60.7 parts).

### Test Example 1

### Prevention Effect of Alternaria mali

Hereunder, the evaluation of each fungicide was carried out by converting the ratio into a protection value after measuring the lesion area ratio (in percentage). The protectin value was calculated by means of the equation as follows.

protection value=(1−(lesion area in the division treated with fungicide)/lesion area in the division not treated with fungicide))×100

An estimated protection value of a mixture of active ingredients was calculated according to the Colby's equation [R. S. Colby, Weeds 15, 20-22 (1967)] and compared with the experimental protection value.

Colby's Equation:

E=x+y−xy/100

wherein E is the estimated protection value (additive effect) which will be obtained when the active ingredients A and B are used in a mixture in concentrations a and b, respectively, x is the protection value obtained when the active ingredient A is used in a concentration a, and y is the protection value obtained when the active ingredient B is used in a concentration b. When an experimental protection value is greater than the expected value E, it shows the presence of synergism (potentiation). A protection value 0 means that the lesion area ratio of the plants in the test group is as large as that of the plants in the untreated control group. A protective value 100 means that the plants in the test group are free from the disease.

The supplied compound (that is, the compound to which number (No.) was attached in Table 1-29), and A (picoxystrobin), B (trifloxystrobin), and C (pyraclostrobin) shown in Table 30 were, alone or in a mixture form, dissolved into dimethylformamide (final concentration: 1% by weight). Thereto were added xylene (final concentration: 0.02% by weight) and Tween 20 (trade name) (final concentration: 0.02% by weight), and then the solution was diluted with water to have a desired effective component concentration (ppm). To this solution was added a spreading agent SINDAIN (trade name, made by Takeda Chemical Industries, Ltd.) containing 20% by weight of polyoxyethylene nonylphenyl ether and 12% by weight of calcium ligninsulfonate so as to have a final concentration of 0.05% by weight. Thus, a spray solution was prepared. The solution was sprayed, at a rate of 10 ml/pot, onto the apple seedlings (cultural variety: Star King Delicous) grown for 3 or 4 weeks in a greenhouse. After one day from the treatment, a suspension containing a 1% yeast extract, a 1% sucrose, and spores (5×10⁵/ml) of Alternaria mali was sprayed and inoculated thereto at a rate of 1 ml/pot. After the inoculation, the trees were kept inside a high-humidity box having a temperature of 28° C. for 4 days. Thereafter, the lesion area ratio on the treated leaves was examined. The results are represented by the abovementioned protection value, and shown in Table 30.

In the case that the compound was mixed with A, B and C and the mixture was used, a higher protection effect was exhibited than in the case that each of them was used alone. Thus, synergistic effect based on the mixing was observed.

TABLE 30

| | Concentration | | | |
|---|---|---|---|---|
| | of the active | | Protec- | |
| | ingredient | Lesion area | tion | |
| Chemical agent | (ppm) | ratio (%) | value | E |
| Compound No. 289 | 0.4 | 19.8 | 58 | — |
| | 1.6 | 19.5 | 59 | — |
| | 6.3 | 3.5 | 93 | — |
| A | 6.3 | 11.5 | 76 | — |
| | 25.0 | 9.5 | 80 | — |
| | 100.0 | 6.2 | 87 | — |
| B | 6.3 | 61.7 | 0 | — |
| | 25.0 | 4.7 | 90 | — |
| | 100.0 | 2.2 | 95 | — |
| C | 6.3 | 11.0 | 77 | — |
| | 25.0 | 11.0 | 77 | — |
| | 100.0 | 3.7 | 92 | — |
| Compound No. 289 + A | 0.4 + 6.3 | 3.0 | 94 | 90 |
| | 1.6 + 6.3 | 0.5 | 99 | 90 |
| Compound No. 289 + B | 0.4 + 6.3 | 7.2 | 85 | 58 |
| | 1.6 + 6.3 | 11.5 | 76 | 59 |
| Compound No. 289 + C | 0.4 + 6.3 | 4.0 | 92 | 90 |
| | 1.6 + 6.3 | 3.2 | 93 | 91 |
| | 0.4 + 25.0 | 3.2 | 93 | 90 |
| | 1.6 + 25.0 | 3.0 | 94 | 91 |
| Untreated plot | | 47.2 | | |

### Test Example 2

### Protective Effect of Pyrenophora teres

The supplied compound (that is, the compound to which number (No.) was attached in Table 1), and A (picoxystrobin), B (trifloxystrobin), C (pyraclostrobin), D (cresoxime methyl), E (epoxiconazole), F (flusilazole) and G (tebuconasole) shown in Table 31 were, alone or in a mixture form, dissolved into dimethylformamide (final concentration: 1% by weight). Thereto were added xylene (final concentration: 0.02% by weight) and Tween 20 (trade name) (final concentration: 0.02% by weight), and then the solution was diluted with water to have a desired effective component concentration (ppm). To this solution was added a spreading agent SINDAIN (trade name, made by Takeda Chemical Industries, Ltd.) containing 20% by weight of polyoxyethylene nonylphenyl ether and 12% by weight of calcium ligninsulfonate so as to have a final concentration of 0.05% by weight. Thus, a spray solution was prepared. The solution was sprayed, at a rate of 40 ml/pot, onto barley seedlings (cultural variety: Shiaga Hasseki No. 5) grown for 1 week in a greenhouse. After air drying, a suspension containing spores (5×10⁵/ml) of Pyrenophora teres was sprayed and inoculated thereto at a rate of 2 ml/pot. After the inoculation, the seedlings were kept inside a high-humidity box having a temperature of 24° C. for 18 hours and then put into a room. After 9 days, the lesion area ratio on the treated leaves was investigated. The results are represented by the above-mentioned extermination value, and shown in Table 31.

In the case that the compound was mixed with A, B, C, D, E, F and G and the mixture was used, a higher protection effect was exhibited than in the case that each of them was used alone. Thus, synergistic effect based on the mixing was observed.

TABLE 31

| | Concentration | | | |
|---|---|---|---|---|
| | of the active | | Protec- | |
| | ingredient | Lesion area | tion | |
| Chemical agent | (ppm) | ratio (%) | value | E |
| Compound No. 289 | 0.5 | 17.5 | 65 | — |
| A | 0.2 | 17.5 | 65 | — |
| B | 0.2 | 27.5 | 45 | — |
| C | 0.2 | 12.5 | 75 | |
| D | 5.0 | 27.5 | 45 | — |
| E | 5.0 | 15.0 | 70 | — |
| F | 5.0 | 25.0 | 50 | — |
| G | 5.0 | 22.5 | 55 | |
| Compound No. 289 + A | 0.5 + 0.2 | 0.8 | 98 | 88 |
| Compound No. 289 + B | 0.5 + 0.2 | 3.5 | 93 | 81 |
| Compound No. 289 + C | 0.5 + 0.2 | 0.8 | 98 | 91 |
| Compound No. 289 + D | 0.5 + 5.0 | 2.5 | 95 | 81 |
| Compound No. 289 + E | 0.5 + 5.0 | 2.0 | 96 | 90 |
| Compound No. 289 + F | 0.5 + 5.0 | 2.0 | 96 | 83 |
| Compound No. 289 + G | 0.5 + 5.0 | 2.5 | 95 | 84 |
| Untreated plot | | 50.0 | | |

A combination of the compound (I⁰) or a salt thereof (particularly, the compound (I) to (VI)) with a different agricultural chemical active ingredient has a superior microbiocidal effect, produces only a small effect on men and beasts, natural enemies and environment so as to be safe, and exhibits a good extermination effect on drug-resistance microorganisms. The combination is useful as superior microbiocidal agent for agriculture and horticulture. The combination produces an excellent effect as an agent for exterminating Pyricularia oryzae, Helminthosporium oryzae and Monogranaphella albescens which rice plant suffers from; Cochliobolus satibvus, Helminthosporium gramineum (Pyrenophora gramineum), and Pyrenophra teres which barley suffers from; Cephalosporinm stripe and Cochliobolus satibvus which wheat suffers from; Cochliobus heterostrophus which corn suffers from; Phytophthora infestans which potato suffers from; Alternaria brassicicola which komatsuna suffers from; Alternaria solani and Alternaria tomato which tomato suffers from; Alternaria japonica which Japanese cabbage suffers from; Alternaria kikuchina which pear suffers from; Alternaria mali which apple suffers from; or the like.

1. An agricultural and horticultural composition which is used for applying compound represented by the formula (I): 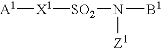
wherein A¹ represents (1) an aryl group which may be substituted or (2) a heterocyclic group which may be substituted,
X¹ represents (1) a chemical bond, (2) a methylene group which may be substituted, or (3) a vinylene group which may be substituted,
B¹ represents a 5-membered heterocyclic group other than isoxazolyl group which may be substituted, or a condensed heterocyclic group which may be substituted, and
Z¹ represents (1) a hydrocarbon group which may be substituted, (2) an acyl group which may be substituted, (3) a formyl group, (4) an amino group which may be substituted, (5) a group represented by —N═CR¹R² wherein each of R¹ and R² independently represents a hydrogen atom or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group, or an alkylsulfonyl group which may be substituted, or (8) a group represented by —S(O)ₙR⁴ wherein n is an integer of 0 to 2, and R⁴ represents a hydrogen atom or a hydrocarbon group which may be substituted, or a salt thereof in combination with a different agricultural chemical active ingredient.

2. The agricultural and horticultural composition according to claim 1 which comprises the compound represented by the formula (I) or the salt thereof, and the different agricultural chemical active ingredient.

3. The agricultural and horticultural composition according to claim 1 which is a combination of a composition comprising the compound represented by the formula (I) or the salt thereof, and a composition comprising the different agricultural chemical active ingredient.

4. The agricultural and horticultural composition according to any one of claims 1 to 3, wherein B¹ is a 5-membered heterocyclic group, which may be substituted, whose ring-constituting atom other than carbon atoms is selected from nitrogen and sulfur atoms, or a condensed heterocyclic group which may be substituted.

5. The agricultural and horticultural composition according to any one of claims 1 to 3, wherein A¹ represents (1) a C₆₋₁₄ aryl group which may be substituted with 1-5 substituents selected from the substituent group (T) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkylcarbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxycarbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula: 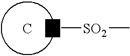
wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthiothiocarbonyl group, (xxviii) a carbamoyl group, (xxix) a mono- or di-C₁₋₄ alkylcarbamoyl group, (xxx) a group represented by the formula: 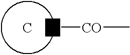
wherein the ring C represents a 3- to 6-membered nitrogen-containing heterocyclic group, (xxxi) a thiocarbamoyl group, (xxxii) mono- or di-C₁₋₄ alkylthiocarbamoyl group, (xxxiii) a group represented by the formula: 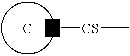
wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group, and (xlv) a sulfo group, or (2) a heterocyclic group which may be substituted with 1-5 substituents selected from the above-mentioned substituent group (T),
X¹ represents (1) a chemical bond, (2) a methylene group which may be substituted with 1 or 2 substituents selected from C₁₋₄ alkyl, C₁₋₄ alkoxy, C₁₋₄ alkylthio, halogen and cyano, or (3) a vinylene group which may be substituted with 1 or 2 substituents selected from C₁₋₄ alkyl, C₁₋₄ alkoxy, C₁₋₄ alkylthio, halogen and cyano,
B¹ represents (1) a 5-memebred heterocyclic group, which may be substituted with 1-5 substituents selected from the above-mentioned substituent group (T), whose ring constituting atom other than carbon atoms is a heteroatom selected from nitrogen and sulfur atoms, or (2) a condensed heterocyclic group which may be substituted with 1-5 substituents selected from the above-mentioned substituent group (T) and is composed of a 5- or 6-membered heterocyclic ring and a benzene ring, or a 5- or 6-membered heterocyclic ring and a 5- or 6-membered heterocyclic ring, and
Z¹ represents (1) a hydrocarbon group selected from (i) a C₁₋₆ alkyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (ii) a C₂₋₆ alkenyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (iii) a C₂₋₆ alkynyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (iv) a C₃₋₆ cycloalkyl group which may be substituted with 1-5 substituents selected from(a) C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkylsulfonyl, (k) cyano, (l) C₁₋₄ alkoxy-carbonyl, (m) carbamoyl and (n) mono- or di-C₁₋₄ alkyl-carbamoyl, (v) a C₃₋₆ alkadienyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (vi) a C₆₋₁₄ aryl group which may be substituted with 1-5 substituents selected from (a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkylsulfonyl, (k) cyano, (l) C₁₋₄ alkoxy-carbonyl, (m) carbamoyl and (n) mono- or di-C₁₋₄ alkyl-carbamoyl, (2) an acyl group selected from (i) C₁₋₄ alkyl-carbonyl, (ii) C₁₋₄ alkoxy-carbonyl, (iii) C₁₋₄ alkylthio-carbonyl, (iv) C₁₋₄ alkoxy-thiocarbonyl, (v) C₁₋₄ alkylthio-thiocarbonyl, (vi) mono- or di-C₁₋₄ alkyl-carbamoyl and (vii) mono- or di-C₁₋₄ alkyl-thiocarbamoyl, each of which may be substituted with 1-5 halogens, (3) a formyl group, (4) an amino group which may be substituted with 1 or 2 substituents selected from (a) C₁₋₄ alkyl, (b) C₁₋₄ alkyl-carbonyl which may be substituted with 1-5 halogens, (c) C₁₋₄ alkoxy-carbonyl, (d) mono- or di-C₁₋₄ alkyl-carbamoyl and (e) mono- or di-C₁₋₄ alkyl-thiocarbamoyl, (5) a group represented by —N═CR¹R² wherein each of R¹ and R² independently represents a hydrogen atom or a C₁₋₄ alkyl group, (6) a 3- to 6-memebred cyclic amino group, (7) a group represented by —OR³ wherein R³ represents a hydrogen atom, a C₁₋₄ alkyl group which may be substituted with 1-5 halogens, a C₁₋₄ alkyl-carbonyl group which may be substituted with 1-5 halogens, a C₁₋₄ alkoxy-carbonyl group which may be substituted with 1-5 halogens, a formyl group, or a C₁₋₄ alkylsulofnyl group which may be substituted with 1-5 halogens, or (8) a group represented by —S(O)ₙR⁴ wherein n is an integer of 0 to 2, and R⁴ represents (a) a hydrogen atom, (b) a C₁₋₄ alkyl group which may be substituted with 1-5 halogens, or (c) a C₆₋₁₄ aryl group which may be substituted with 1-5 C₁₋₄ alkyls.

6. The agricultural and horticultural composition according to any one of claims 1 to 3, wherein A¹ represents a C₆₋₁₄ aryl group which may be substituted with 1-3 C₁₋₄ alkyls, X¹ represents a chemical bond, B¹ represents a thienyl, pyrazolyl, isothiazolyl, imidazolyl, thiazolyl, thiadiazolyl, dioxaindanyl or imidazopyridyl group which may be substituted with 1-5 substituents selected from C₁₋₄ alkyl which may be substituted with 1-5 halogens, C₁₋₄ alkoxy, C₁₋₄ alkylthio, cyano, halogen and nitro, and Z¹ represents a C₁₋₆ alkyl group or a C₁₋₄ alkoxy group.

7. An agricultural and horticultural composition which is used for applying a compound represented by the formula (II): 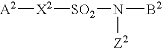
wherein A² represents (1) (i) an aryl group which may be substituted with 1-5 substituents selected from the substituent group (T′) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkylcarbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxycarbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula: 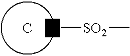
wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthiothiocarbonyl group, (xxviii) a carbamoyl group, (xxix) a mono- or di-C₁₋₄ alkylcarbamoyl group, (xxx) a group represented by the formula: 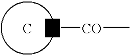
wherein the ring C represents a 3- to 6-membered nitrogen-containing heterocyclic group, (xxxi) a thiocarbamoyl group, (xxxii) a mono- or di-C₁₋₄ alkylthiocarbamoyl group, (xxxiii) a group represented by the formula: 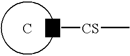
wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group, and (xlv) a sulfo group, or (2) a heterocyclic group which may be substituted,
X² represents (1) a chemical bond, (2) a methylene group which may be substituted, or (3) a vinylene group which may be substituted,
B² represents an aryl group which may be substituted, and
Z² represents (1) an alkyl group which may be substituted with a substituent selected from mono- or di-C₁₋₄ alkylamino, hydroxy, halogen, C₁₋₆ alkoxy, C₁₋₆ alkoxycarbonyl, C₁₋₆ alkylthio and cyano, (2) a vinyl group, (3) an allyl group, (4) a propadienyl group, (5) an alkynyl group which may be substituted, (6) a cycloalkyl group which may be substituted, (7) an aryl group which may be substituted, (8) an acyl group which may be substituted, (9) a formyl group, (10) an amino group which may be substituted, (11) a group represented by —N═CR¹R² wherein each of R¹ and R² independently represents a hydrogen atom, or a hydrocarbon group which may be substituted, (12) a cyclic amino group, (13) a group represented by —OR³ wherein R³ represents a hydrogen atom, a hydrocarbon group which may be substituted, an acyl group which may be substituted, a. formyl group, or an alkyl sulfonyl group which may be substituted, or (14) a group represented by —S(O)ₙR⁴ wherein n is an integer of 0 to 2, and R⁴ represents a hydrogen atom, or a hydrocarbon group which may be substituted, or a salt thereof in combination with a different agricultural chemical active ingredient.

8. The agricultural and horticultural composition according to claim 7 which comprises the compound represented by the formula (II) or the salt thereof, and the different agricultural chemical active ingredient.

9. The agricultural and horticultural composition according to claim 7 which is a combination of a composition comprising the compound represented by the formula (II) or the salt thereof, and a composition comprising the different agricultural chemical active ingredient.

10. The agricultural and horticultural composition according to any one of claims 7 to 9, wherein A² represents (1) a C₆₋₁₄ aryl group which may be substituted with 1-5 substituents selected from the substituent group (T′) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkyl-carbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxy-carbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula: 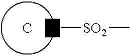
wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthiothiocarbonyl group, (xxviii) a carbamoyl group, (xxix) a mono- or di-C₁₋₄ alkylcarbamoyl group, (xxx) a group represented by the formula: 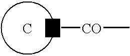
wherein the ring C represents a 3- to 6-membered nitrogen-containing heterocyclic group, (xxxi) a thiocarbamoyl group, (xxxii) a mono- or di-C₁₋₄ alkylthiocarbamoyl group, (xxxiii) a group represented by the formula: 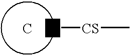
wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group and (xliv) a sulfo group, or (2) a heterocyclic group which may be substituted with 1-5 substituents selected from the substituent group (T) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkylcarbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxycarbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula: 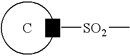
wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthiothiocarbonyl group, (xxviii) a carbamoyl group, (xxix) a mono- or di-C₁₋₄ alkylcarbamoyl group, (xxx) a group represented by the formula: 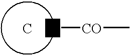
wherein the ring C represents a 3- to 6-membered nitrogen-containing heterocyclic group, (xxxi) a thiocarbamoyl group, (xxxii) a mono- or di-C₁₋₄ alkylthiocarbamoyl group, (xxxiii) a group represented by the formula: 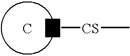
wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group and (xlv) a sulfo group,
X² represents (1) a chemical bond, (2) a methylene group which may be substituted with 1 or 2 substituents selected from C₁₋₄ alkyl, C₁₋₄ alkoxy, C₁₋₄ alkylthio, halogen and cyano, or (3) a vinylene group which may be substituted with 1 or 2 substituents selected from C₁₋₄ alkyl, C₁₋₄ alkoxy, C₁₋₄ alkylthio, halogen and cyano,
B² represents a C₆₋₁₄ aryl group which may be substituted with 1-5 substituents selected from the abovementioned substituent group (T), and
Z² represents (1) a C₁₋₆ alkyl group which may be substituted with 1-5 substituents selected from mono- or di-C₁₋₄ alkylamino, hydroxy, halogen, C₁₋₄ alkoxy, C₁₋₄ alkoxy-carbonyl, C₁₋₄ alkylthio and cyano, (2) a vinyl group, (3) an allyl group, (4) a propadienyl group, (5) a C₂₋₆ alkynyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (6) a C₃₋₆ cycloalkyl group which may be substituted with 1-5 substituents selected from (a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkyl sulfonyl, (k) cyano, (l) C₁₋₄ alkoxy-carbonyl, (m) carbamoyl, and (n) mono- or di-C₁₋₄ alkyl-carbamoyl, (7) a C₆₋₁₄ aryl group which may be substituted with 1-5 substituents selected from (a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkyl sulfonyl, (k) cyano, (l) C₁₋₄ alkoxy-carbonyl, (m) carbamoyl, and (n) mono- or di-C₁₋₄ alkyl-carbamoyl, (8) an acyl group which may be substituted with 1-5 halogens and is selected from (i) C₁₋₄ alkyl-carbonyl, (ii) C₁₋₄ alkoxy-carbonyl, (iii) C₁₋₄ alkylthio-carbonyl, (iv) C₁₋₄ alkoxy-thiocarbonyl, (v) C₁₋₄ alkylthio-thiocarbonyl, (vi) mono- or di-C₁₋₄ alkylcarbamoyl,; and (vii) mono- or di-C₁₋₄ alkyl-thiocarbamoyl, (9) a formyl group, (10) an amino group which may be substituted with 1 or 2 substituents selected from (a) C₁₋₄ alkyl, (b) C₁₋₄ alkyl-carbonyl which may be substituted with 1-5 halogens, (c) C₁₋₄ alkoxy-carbonyl, (d) mono- or di-C₁₋₄ alkyl-carbamoyl and (e) mono- or di-C₁₋₄ alkyl-thiocarbamoyl, (11) a group represented by —N═CR¹R² wherein each of R¹ and R² independently represents a hydrogen atom or a C₁₋₄ alkyl group, (12) a 3- to 6-memebred cyclic amino group, (13) a group represented by —OR³ wherein R³ represents a hydrogen atom, a C₁₋₄ alkyl group which may be substituted with 1-5 halogens, a C₁₋₄ alkyl-carbonyl group which may be substituted with 1-5 halogens, a C₁₋₄ alkoxy-carbonyl group which may be substituted with 1-5 halogens, a formyl group, .or a C₁₋₄ alkylsulfonyl group which may be substituted with 1-5 halogens, or (14) a group represented by —S(O)ₙR⁴ wherein n is an integer of 0 to 2, and R⁴ represents (a) a hydrogen atom, (b) a C₁₋₄ alkyl group which may be substituted with 1-5 halogens, or (c) a C₆₋₁₄ aryl group which may be substituted with 1-5 C₁₋₄ alkyls.

11. The agricultural and horticultural composition according to any one of claims 7 to 9, wherein A² represents (1) a C₆₋₁₄ aryl group which may be substituted with 1-5 substituents selected from (i) a C₁₋₄ alkyl group which may be substituted with 1-5 halogens, (ii) a C₁₋₄ alkoxy group which may be substituted with 1-5 halogens, (iii) an amino group which may be substituted with 1 or 2 C₁₋₄ alkyl-carbonyls, (iv) a C₁₋₄ alkoxy-carbonyl group, (v) a halogen atom, (vi) a cyano group, and (vii) a nitro group, or (2) a thienyl, triazolyl, imidazolyl, isoxazolyl, pyrazolyl, pyridyl, quinolyl, benzothiadiazolyl, imidazothiazolyl or imidazopyridyl group, each of which may be substituted with 1-5 substituents selected from (i) a C₁₋₄ alkyl group, (ii) a C₁₋₄ alkoxy-carbonyl group, (iii) a carbamoyl group, (iv) a mono- or di-C₁₋₄ alkylcarbamoyl group, (v) a C₁₋₄ alkylsulfonyl group, (vi) a halogen atom, (vii) a carboxyl group, and (viii) a cyano group,
X² represents (1) a chemical bond, (2) a methylene group which may be substituted with 1 or 2 C₁₋₄ alkyls, or (3) a vinylene group which may be substituted with 1 or 2 C₁₋₄ alkyls,
B² represents a C₆₋₁₄ aryl group which may be substituted with 1-5 substituents selected from (1) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrazono and C₁₋₄ alkylthio, (2) a C₂₋₄ alkynyl group, (3) a hydroxyl group, (4) a C₁₋₄ alkoxy group which may be substituted with 1-5 substituents selected from halogen and C₁₋₄ alkoxy, (5) a C₁₋₄ alkyl-carbonyloxy group, (6) a C₁₋₄ alkylthio group, (7) a C₁₋₄ alkylsulfinyl group, (8) a C₁₋₄ alkylsulfonyl group, (9) a mono- or di-C₁₋₄ alkylsulfamoyl group, (10) an amino group, (11) a formyl group, (12) a C₁₋₄ alkoxycarbonyl group, (13) a carbamoyl group, (14) a mono- or di-C₁₋₄ alkylcarbamoyl group, (15) a thiocarbamoyl group, (16) a halogen atom, (17) a carboxyl group, (18) a thiocyanato group, (19) a cyano group, (20) a nitroso group, and (21) a nitro group, and
Z² represents (1) a C₁₋₆ alkyl group which may be substituted with 1-5 substituents selected from mono- or di-C₁₋₄ alkylamino, hydroxy, halogen, C₁₋₄ alkoxy, C₁₋₄ alkoxy-carbonyl, C₁₋₄ alkylthio and cyano, (2) a vinyl group, (3) an allyl group, (4) a propadienyl group, (5) a C₂₋₆ alkynyl group which may be substituted with 1-5 halogens, (6) a C₃₋₆ cycloalkyl group, (7) a C₆₋₁₄ aryl group, (8)a C₁₋₄ alkyl-carbonyl group which may be substituted with 1-5 halogens, (9) an amino group which may be substituted with 1 or 2 substituents selected from C₁₋₄ alkyl, C₁₋₄ alkylcarbonyl and C₁₋₄ alkoxy-carbonyl, (10) a group represented by —N═CR¹R² wherein each of R¹ and R² independently represents a C₁₋₄ alkyl group, (11) a group represented by —OR³ wherein R³ represents a C₁₋₄ alkyl group or a C₁₋₄ alkylcarbonyl group, or (12) a group represented by —S(O)ₙR⁴ wherein n is an integer of 0 to 2, and R⁴ represents (a) a C₁₋₄ alkyl group which may be substituted with 1-5 halogens or (b) a C₆₋₁₄ aryl group which may be substituted with 1-5 C₁₋₄ alkyls.

12. The agricultural and horticultural composition according to any one of claims 7 to 9, wherein A² represents a phenyl group which may be substituted with 1-3 substituents selected from C₁₋₄ alkyl, halogen, and cyano, X² represents a chemical bond, B² represents a phenyl group which may be substituted with 1-5 substituents selected from (1) a C₁₋₄ alkyl group which may be substituted with 1-3 halogens, (2) a C₁₋₄ alkoxy group, (3) a C₁₋₄ alkylthio group, (4) a thiocarbamoyl group, (5) a halogen atom, (6) a cyano group and (7) a nitro group, and Z² represents (1)a C₁₋₆ alkyl group which may be substituted with 1-3 C₁₋₄ alkoxys, (2) a C₃₋₆ cycloalkyl group, (3) an ally group or (4) a C₁₋₄ alkoxy group.

13. The agricultural and horticultural composition according to any one of claims 7 to 9, wherein the compound or the salt thereof is 4′-chloro-N-ethyl-2′-nitro-p-toluenesulfonanilide, 2′,4′-dinitro-N-ethyl-p-toluenesulfonanilide, 2′,4′-dicyano-N-ethyl-p-toluenesulfonanilide, 4′-chloro-N-isopropyl-2′-nitro-p-toluenesulfonanilide, 4′-fluoro-N-isopropyl-2′-nitro-p-toluenesulfonanilide, 4′-cyano-N-isopropyl-2′-nitro-p-toluenesulfonanilide, 4′-chloro-N-isopropyl-2′-nitro-p-toluenesulfonanilide, 2′,4′-dinitro-N-isopropyl-p-toluenesulfonanilide, 4′-nitro-N-isopropyl-2′-cyano-p-toluenesulfonanilide, 2′-cyano-N-methoxy-4′-nitro-p-toluenesulfonanilide or 2′,4′-dinitro-N-methoxy-p-toluenesulfonanilide, or a salt thereof.

14. An agricultural and horticultural composition which is used for applying a compound represented by the formula (III): 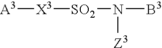
wherein A³ represents (1) an aryl group which may be substituted or (2) a heterocyclic group which may be substituted,
X³ represents (1) a chemical bond, (2) a methylene group which may be substituted, or (3) a vinylene group which may be substituted,
B³ represents a 6-memebred heterocyclic group having a substituent selected from the substituent group (T) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkylcarbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxycarbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula: 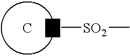
wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthiothiocarbonyl group, (xxviii) a carbamoyl group, (xxix) a mono- or di-C₁₋₄ alkylcarbamoyl group, (xxx) a group represented by the formula: 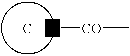
wherein the ring C represents a 3- to 6-membered nitrogen-containing heterocyclic group, (xxxi) a thiocarbamoyl group, (xxxii) a mono- or di-C₁₋₄ alkylthiocarbamoyl group, (xxxiii) a group represented by the formula: 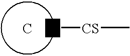
wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group and (xlv) a sulfo group, and
Z³ represents (1) a hydrocarbon group which may be substituted, (2) an acyl group which may be substituted, (3) a formyl group, (4) an amino group which may be substituted, (5) —N═NCR¹R² wherein each of R¹ and R² independently represents a hydrogen atom or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group or a sulfonyl group which may be substituted or (8) a group represented by —S(O)ₙR⁴ wherein n is an integer of 0 to 2, and R⁴ represents a hydrogen atom or a hydrocarbon group which may be substituted, or a salt thereof in combination with a different agricultural chemical active ingredient.

15. The agricultural and horticultural composition according to claim 14 which comprises the compound represented by the formula (III) or the salt thereof, and the different agricultural chemical active ingredient.

16. The agricultural and horticultural composition according to claim 14 which is a combination of a composition comprising the compound represented by the formula (III) or the salt thereof, and a composition comprising the different agricultural chemical active ingredient.

17. The agricultural and horticultural composition according to any one of claims 14 to 16, wherein A³ represents (1) a C₆₋₁₄ aryl group which may be substituted with 1-5 substituents selected from the substituent group (T) consisting of (i) a C₁₋₄ alkyl group which may be substituted with 1-5 substituents selected from halogen, hydroxy, imino, hydroxyimino, C₁₋₄ alkoxyimino, hydrazono, mono- or di-C₁₋₄ alkylhydrozono and C₁₋₄ alkylthio, (ii) a C₃₋₆ cycloalkyl group which may be substituted with 1-5 halogens, (iii) a C₂₋₄ alkenyl group which may be substituted with 1-5 substituents selected from halogen, cyano and nitro, (iv) a C₃₋₆ cycloalkenyl group which may be substituted with 1-5 halogens, (v) a C₂₋₄ alkynyl group which may be substituted with 1-5 halogens, (vi) a hydroxyl group, (vii) a C₁₋₄ alkoxy group which may be substituted with 1-5 substituents selected from halogen and C₁₋₄ alkoxy, (viii) a formyloxy group, (ix) a C₁₋₄ alkyl-carbonyloxy group which may be substituted with 1-5 halogens, (x) a C₁₋₄ alkoxy-carbonyloxy group which may be substituted with 1-5 halogens, (xi) a mercapto group, (xii) a C₁₋₄ alkylthio group which may be substituted with 1-5 halogens, (xiii) a C₁₋₄ alkyl-carbonylthio group which may be substituted with 1-5 halogens, (xiv) a C₁₋₄ alkoxy-carbonylthio group which may be substituted with 1-5 halogens, (xv) a C₁₋₄ alkylsulfinyl group which may be substituted with 1-5 halogens, (xvi) a C₁₋₄ alkylsulfonyl group which may be substituted with 1-5 halogens, (xvii) a sulfamoyl group, (xviii) a mono- or di-C₁₋₄ alkylsulfamoyl group, (xix) a group represented by the formula: 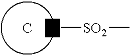
wherein the ring C represents a 3- to 6-membered nitrogen-containing heterocyclic group, (xx) an amino group which may be substituted with one or two substituents selected from C₁₋₄ alkyl, C₂₋₄ alkenyl, C₂₋₄ alkynyl, hydroxy, C₁₋₄ alkoxy, formyloxy, C₁₋₄ alkyl-carbonyloxy, formyl and C₁₋₄ alkyl-carbonyl, (xxi) a 3- to 6-membered cyclic amino group, (xxii) a formyl group, (xxiii) a C₁₋₄ alkyl-carbonyl group which may be substituted with 1-5 halogens, (xxiv) a C₁₋₄ alkoxy-carbonyl group which may be substituted with 1-5 halogens, (xxv) a C₁₋₄ alkylthio-carbonyl group, (xxvi) a C₁₋₄ alkoxy-thiocarbonyl group, (xxvii) a C₁₋₄ alkylthiothiocarbonyl group, (xxviii) a carbamoyl group, (xxix) a mono- or di-C₁₋₄ alkylcarbamoyl group, (xxx) a group represented by the formula: 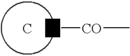
wherein the ring C represents a 3- to 6-membered nitrogen-containing heterocyclic group, (xxxi) a thiocarbamoyl group, (xxxii) a mono- or di-C₁₋₄ alkylthiocarbamoyl group, (xxxiii) a group represented by the formula: 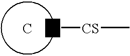
wherein the ring C represents a 3- to 6-membered nitrogen-containing heterocyclic group, (xxxiv) a halogen atom, (xxxv) a carboxyl group, (xxxvi) a thiocyanate group, (xxxvii) an isothiocyanate group, (xxxviii) a cyano group, (xxxix) an isocyano group, (xl) an azide group, (xli) a nitroso group, (xlii) a nitro group, (xliii) an azocyano group, (xliv) an azoxycyano group and (xlv) a sulfo group, or (2) a heterocyclic group which may be substituted with 1-5 substituents selected from the above-mentioned substituent group (T),
X³ represents (1) a chemical bond, (2) a methylene group which may be substituted with 1 or 2 substituents selected from C₁₋₄ alkyl, C₁₋₄ alkoxy, C₁₋₄ alkylthio, halogen and cyano, (3) a vinylene group which may be substituted with 1 or 2 substituents selected from C₁₋₄ alkyl, C₁₋₄ alkoxy, C₁₋₄ alkylthio, halogen and cyano,
B³ represents a 6-membered heteroring substituted with 1-5 substituents selected from the above-mentioned substituent group (T), and
Z³ represents (1) a hydrocarbon group selected from (i) a C₁₋₆ alkyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (ii) a C₂₋₆ alkenyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (iii) a C₂₋₆ alkynyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (iv) a C₃₋₆ cycloalkyl group which may be substituted with 1-5 substituents selected from(a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkyl sulfonyl, (k) cyano, (l) C₁₋₄ alkoxy-carbonyl, (m) carbamoyl, and (n) mono- or di-C₁₋₄ alkyl-carbamoyl, (v) a C₃₋₆ alkadienyl group which may be substituted with 1-5 substituents selected from (a) halogen, (b) amino, (c) mono- or di-C₁₋₄ alkylamino, (d) hydroxy, (e) C₁₋₄ alkoxy which may be substituted with 1-5 halogens, (f) mercapto, (g) C₁₋₄ alkylthio, (h) C₁₋₄ alkylsulfinyl, (i) C₁₋₄ alkylsulfonyl, (j) cyano, (k) C₁₋₄ alkoxy-carbonyl, (l) carbamoyl and (m) mono- or di-C₁₋₄ alkyl-carbamoyl, (vi) a C₆₋₁₄ aryl group which may be substituted with 1-5 substituents selected from (a) a C₁₋₄ alkyl which may be substituted with 1-5 halogens, (b) halogen, (c) amino, (d) mono- or di-C₁₋₄ alkylamino, (e) hydroxy, (f) C₁₋₄ alkoxy which may be substituted with 1-5 halogens, (g) mercapto, (h) C₁₋₄ alkylthio, (i) C₁₋₄ alkylsulfinyl, (j) C₁₋₄ alkyl sulfonyl, (k) cyano, (l) C₁₋₄ alkoxy-carbonyl, (m) carbamoyl and (n) mono- or di-C₁₋₄ alkyl-carbamoyl, (2) an acyl group selected from (i) C₁₋₄ alkyl-carbonyl, (ii) C₁₋₄ alkoxycarbonyl, (iii) C₁₋₄ alkylthio-carbonyl, (iv) C₁₋₄ alkoxythiocarbonyl, (v) C₁₋₄ alkylthio-thiocarbonyl, (vi) mono- or di-C₁₋₄ alkyl-carbamoyl, and (vii) mono- or di-C₁₋₄ alkylthiocarbamoyl, each of which may be substituted with 1-5 halogens, (3) a formyl group, (4) an amino group which may be substituted with 1 or 2 substituents selected from (a) C₁₋₄ alkyl, (b) C₁₋₄ alkyl-carbonyl which may be substituted with 1-5 halogens, (c) C₁₋₄ alkoxy-carbonyl, (d) mono- or di-C₁₋₄ alkyl-carbamoyl and (e) mono- or di-C₁₋₄ alkylthiocarbamoyl, (5) a group represented by —N═CR¹R² wherein each of R¹ and R² independently represents a hydrogen atom or a C₁₋₄ alkyl group, (6) a 3- to 6-memebred cyclic amino group, (7) a group represented by —OR³ wherein R³ represents a hydrogen atom, a C₁₋₄ alkyl group which may be substituted with 1-5 halogens, a C₁₋₄ alkyl-carbonyl group which may be substituted with 1-5 halogens, a C₁₋₄ alkoxycarbonyl group which may be substituted with 1-5 halogens, a formyl group, or a C₁₋₄ alkylsulfonyl group which may be substituted with 1-5 halogens or (8) a group represented by —S(O)ₙR⁴ wherein n is an integer of 0 to 2, and R⁴ represents (a) a hydrogen atom, (b) a C₁₋₄ alkyl group which may be substituted with 1-5 halogens, or (c) a C₆₋₁₄ aryl group which may be substituted with 1-5 C₁₋₄ alkyls.

18. The agricultural and horticultural composition according to any one of claims 14 to 16, wherein A³ represents a phenyl group which may be substituted with 1-5 C₁₋₄ alkyls or an imidazolyl group which may be substituted with 1 or 2 C₁₋₄ alkyls, X³ represents a chemical bond, B³ represents a pyridyl, pyridazinyl or pyrimidinyl group which may be substituted with 1-5 substituents selected from C₁₋₄ alkyl which may be substituted with 1-5 halogens, C₁₋₄ alkoxy, halogen, nitro and cyano, and Z³ represents a C₁₋₆ alkyl group, a C₃₋₆ cycloalkyl group or a C₁₋₄ alkoxy group.

19. An agricultural and horticultural composition which is used for applying a compound represented by the formula (IV): 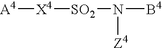
wherein A⁴ represents (1) an aryl group which may be substituted or (2) a heterocyclic group which may be substituted,
X⁴ represents (1) a chemical bond, (2) a methylene group which may be substituted or (3) a vinylene group which may be substituted,
B⁴ represents a pyridazinyl group or a pyrazinyl group, and
Z⁴ represents (1) a hydrocarbon which may be substituted, (2) an acyl group which may be substituted, (3) a formyl group, (4) an amino group which may be substituted, (5) —N═CR¹R² wherein each of R¹ and R² independently represents a hydrogen atom or a hydrocarbon group which may be substituted, (6) a cyclic amino group, (7) a group represented by —OR³ wherein R³ represents a hydrogen atom, a hydrocarbon group which may be substituted, an acyl group which may be substituted, a formyl group or a sulfonyl group which may be substituted or (8) a group represented by —S(O)ₙR⁴ wherein n is an integer of 0 to 2 and R⁴ represents a hydrogen atom or a hydrocarbon group which may be substituted, or a salt thereof in combination with a different agricultural chemical active ingredient.

20. The agricultural and horticultural composition according to claim 19 which comprises the compound represented by the formula (IV) or the salt thereof, and the different agricultural chemical active ingredient.

21. The agricultural and horticultural composition according to claim 19 which is a combination of a composition comprising the compound represented by the formula (IV) or the salt thereof, and a composition comprising the different agricultural chemical active ingredient.

22. An agricultural and horticultural composition which is used for applying a compound represented by the formula (V): 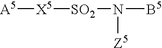
wherein A⁵ represents a 4-methylphenyl group, X⁵ represents a chemical bond, B⁵ represents a pyridyl group or a pyrimidinyl group, and Z⁵ represents a C₁₋₄ alkyl group, or a salt thereof in combination with a different agricultural chemical active ingredient.

23. The agricultural and horticultural composition according to claim 22 which comprises the compound represented by the formula (V) or the salt thereof, and the different agricultural chemical active ingredient.

24. The agricultural and horticultural composition according to claim 22 which is a combination of a composition comprising the compound represented by the formula (V) or the salt thereof, and a composition comprising the different agricultural chemical active ingredient.

25. An agricultural and horticultural composition which is used for applying a compound represented by the formula (VI): 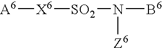
wherein A⁶ represents a phenyl group which may be substituted with a substituent selected from C₁₋₄ alkyl, halogen and cyano, X⁶ represents a chemical bond, B⁶ represents a 2-nitrophenyl group or a 2-cyanophenyl group substituted with a substituent selected from halogen, nitro and cyano, and Z⁶ represents an ethyl group, an isopropyl group, a cyclopropyl group, a methoxy group, an ethoxy group or an isopropoxy group, or a salt thereof in combination with a different agricultural chemical active ingredient.

26. The agricultural and horticultural composition according to claim 25 which comprises the compound represented by the formula (VI) or the salt thereof, and the different agricultural chemical active ingredient.

27. The agricultural and horticultural composition according to claim 25 which is a combination of a composition comprising the compound represented by the formula (VI) or the salt thereof, and a composition comprising the different agricultural chemical active ingredient.

28. The agricultural and horticultural composition according to any one of claims 1 to 27, wherein the different agricultural chemical active ingredient is an insecticidal component.

29. The agricultural and horticultural composition according to any one of claims 1 to 27, wherein the different agricultural chemical component agent is a microbiocidal component.

30. The agricultural and horticultural composition according to any one of claims 1 to 27, wherein the different agricultural chemical active ingredient is an insecticidal and an microbiocidal components.

31. The agricultural and horticultural composition according to claims 29 or 30, wherein the microbiocidal component is at least one component selected from epoxiconazole, flusilazole, picoxystrobin, pyraclostrobin, trifloxystrobin, and iprovalicarb.

32. A microbiocidal composition for agriculture and horticulture which comprises 4′-chloro-N-ethyl-2′-nitro-p-toluenesulfonanilide or a salt thereof, and epoxiconazole.

33. A microbiocidal composition for agriculture and horticulture which comprises 4′-chloro-N-ethyl-2′-nitro-p-toluenesulfonanilide or a salt thereof, and flusilazole.

34. A microbiocidal composition for agriculture and horticulture which comprises 4′-chloro-N-ethyl-2′-nitro-p-toluenesulfonanilide or a salt thereof, and picoxystrobin.

35. A microbiocidal composition for agriculture and horticulture which comprises 4′-chloro-N-ethyl-2′-nitro-p-toluenesulfonanilide or a salt thereof, and pyraclostrobin.

36. A microbiocidal composition for agriculture and horticulture which comprises 4′-chloro-N-ethyl-2′-nitro-p-toluenesulfonanilide or a salt thereof, and trifloxystrobin.

37. A microbiocidal composition for agriculture and horticulture which comprises 4′-chlorb-N-ethyl-2′-nitro-p-toluenesulfonanilide or a salt thereof, and iprovalicarb.

38. A method for reinforcing microbiocidal effect of at least one of the compounds represented by the formulas (I) to (VI), and salts thereof which comprises at least one of the compounds represented by the formulas (I) to (VI) or a salt thereof is used in combination with a different agricultural chemical active ingredient.

39. A method for reinforcing microbiocidal effect or insecticidal effect of an agricultural chemical active ingredient other than those represented by the formulas (I) to (VI) or salts thereof which comprises at least one of the compounds represented by the formulas (I) to (VI) or a salt thereof is used in combination with the other agricultural chemical active ingredient.
